(19) United States
(12) Patent Application Publication
(10) Pub. No.: US 2024/0180380 A1
(43) Pub. Date: Jun. 6, 2024

(54) CLEANER HAVING DETACHABLE OR SEPARABLE CONTROL MODULE

(71) Applicant: SAMSUNG ELECTRONICS CO., LTD., Suwon-si (KR)

(72) Inventors: Seongu LEE, Suwon-si (KR); Hyunwoo KIM, Suwon-si (KR); Kunwoo BAEK, Suwon-si (KR); Ahyoung LEE, Suwon-si (KR); Byunghun JUNG, Suwon-si (KR); Yunwon JUNG, Suwon-si (KR); Jaeshik JEONG, Suwon-si (KR)

(21) Appl. No.: 18/530,934

(22) Filed: Dec. 6, 2023

Related U.S. Application Data
(63) Continuation of application No. PCT/KR2023/019859, filed on Dec. 5, 2023.

(30) Foreign Application Priority Data
Dec. 6, 2022 (KR) 10-2022-0169108
Apr. 26, 2023 (KR) 10-2023-0054996

(51) Int. Cl. A47L 9/28; A47L 9/14

(52) U.S. Cl. CPC A47L 9/2857; A47L 9/1427; A47L 9/2842; A47L 9/2884

(57) ABSTRACT

A cleaner is provided and includes a cleaner main body including a suction motor, a battery module and a control module configured to control an operation of the cleaner. The control module is mountable on and separable from the cleaner main body. The control module includes a main processor configured to communicate with the battery module at a preset interval in a state in which the control module is mounted on the cleaner main body. The battery module is configured to identify that the control module is separated from the cleaner main body and to stop a supply of power to the cleaner main body based on not receiving a communication signal from the control module for the preset first time period or longer.

### CROSS-REFERENCE TO RELATED APPLICATIONS

This application is a continuation application, claiming priority under § 365(c), of International Application No. PCT/KR2023/019859, filed on Dec. 5, 2023, which is based on and claims the benefit of Korean patent application number 10-2023-0054996 filed on Apr. 26, 2023, in the Korean Intellectual Property Office and of Korean patent application number 10-2022-0169108 filed on Dec. 6, 2022, in the Korean Intellectual Property Office, the disclosures of which are incorporated by reference herein in their entireties.

### TECHNICAL FIELD

The disclosure relates to a cleaner having a detachable or separable control module.

### BACKGROUND ART

A cleaner, for example, a vacuum cleaner, sucks in air containing foreign substances such as dust by using negative pressure, separates the foreign substances from the sucked-in air, and collects the foreign substances in a dust collection container. A cordless cleaner may include a battery. The cordless cleaner may receive power from the battery to perform a cleaning operation. A cleaner includes a control module for controlling an operation of the cleaner. A user may control the operation of the cleaner, such as powering on/off, by using the control module.

### DISCLOSURE

### Technical Solution

A cleaner according to an embodiment of the disclosure may include a cleaner main body including a suction motor, a battery module and a control module that is configured to control an operation of the cleaner. The control module is mountable on and separable from the cleaner main body and includes a main processor configured to communicate with the battery module at a preset interval in a state in which the control module is mounted on the cleaner main body. The battery module is configured to identify that the control module is separated from the cleaner main body and stop a supply of power to the cleaner main body based on not receiving a communication signal from the control module for the preset first time period or longer.

### DESCRIPTION OF DRAWINGS

FIG. 1 is a schematic partial cross-sectional perspective view of a cleaner according to an embodiment of the disclosure.

FIG. 2 is a partially exploded perspective view illustrating a structure in which a controller is attached to or separated from a cleaner in an upward or downward direction according to an embodiment of the disclosure.

FIG. 3 is a schematic side view illustrating an electrical connection structure between a main body and a controller according to an embodiment of the disclosure.

FIG. 4 illustrates a snap-fit fixing structure according to an embodiment of the disclosure.

FIG. 5 illustrates a magnetic fixing structure according to an embodiment of the disclosure.

FIG. 6 illustrates a screw fastening structure according to an embodiment of the disclosure.

FIGS. 7A to 7E illustrate various examples of controllers.

FIG. 7F is a diagram illustrating a state in which a user terminal is installed instead of a controller.

FIG. 8 is a schematic side view illustrating a state in which a filter housing is separated from a main body.

FIG. 9 illustrates a structure in which a controller is attached to or separated from a main body by being slid in a forward or backward direction according to an embodiment of the disclosure.

FIG. 10 is a side view in a lateral direction illustrating a structure in which a controller is attached to or separated from a main body by being slid in the lateral direction according to an embodiment of the disclosure.

FIG. 11 is a schematic side view of a cleaner according to an embodiment of the disclosure.

FIG. 12 is a schematic side view of a cleaner according to an embodiment of the disclosure.

FIG. 13 is a schematic side view of a cleaner according to an embodiment of the disclosure.

FIG. 14A is a schematic side view of a cleaner according to an embodiment of the disclosure.

FIG. 14B is a diagram for describing a wire connecting a controller to a main body according to an embodiment of the disclosure.

FIG. 15 is a schematic perspective view of a cleaner according to an embodiment of the disclosure.

FIG. 16 is a schematic side view of a cleaner according to an embodiment of the disclosure.

FIG. 17 is a schematic side view of a cleaner according to an embodiment of the disclosure.

FIG. 18 is a schematic side view of a cleaner according to an embodiment of the disclosure.

FIG. 19 is a schematic side view of a cleaner according to an embodiment of the disclosure.

FIG. 20 is a schematic side view of a cleaner according to an embodiment of the disclosure.

FIG. 21 is a block diagram for describing a function of a cleaner main body according to an embodiment of the disclosure.

FIG. 22 is a diagram for describing a brush device according to an embodiment of the disclosure.

FIG. 23 is a diagram for describing operations of processors of a cleaner according to an embodiment of the disclosure.

FIG. 24 is a diagram for describing a communication operation between a battery module and a control module according to an embodiment of the disclosure.

FIG. 25 is a flowchart for describing a method, performed by each of a battery module and a control module, of operating in a safe mode according to an embodiment of the disclosure.

FIG. 26 is a diagram for describing a communication operation between a motor assembly and a control module according to an embodiment of the disclosure.

FIG. 27 is a flowchart for describing a method, performed by each of a motor assembly and a control module, of operating in a safe mode according to an embodiment of the disclosure.

FIG. 28 is a flowchart for describing a method of determining whether a control module is separated from a cleaner main body based on a battery supply voltage according to an embodiment of the disclosure.

FIG. 29 is a diagram for describing changes in a battery supply voltage and an internal supply voltage of a control module according to an embodiment of the disclosure.

FIG. 30 is a flowchart for describing a method, performed by a control module, of performing a preliminary operation based on a difference between a battery supply voltage included in data received from a battery module and a battery supply voltage measured by the control module according to an embodiment of the disclosure.

FIG. 31 is a diagram for describing an operation of detecting separation of a control module from a cleaner main body by using a tunnel magnetoresistance (TMR) sensor or a microswitch according to an embodiment of the disclosure.

FIG. 32 is a flowchart for describing an operation method performed by a control module when detecting separation of a screw from a locking hole according to an embodiment of the disclosure.

FIG. 33 is a diagram illustrating an operation, performed by a control module, of outputting information through an output interface when detecting separation of a screw from a locking hole according to an embodiment of the disclosure.

FIG. 34 is a diagram for describing a notification message output through a user terminal when separation of a screw from a locking hole is detected according to an embodiment of the disclosure.

FIG. 35 is a flowchart for describing a method, performed by a control module, of determining whether to maintain or release locking of a locking unit according to an embodiment of the disclosure.

FIG. 36 is a diagram for describing a blocking device according to an embodiment of the disclosure.

FIG. 37 is a diagram for describing an operation of detecting that a control module switches from a use position to a retreat position according to an embodiment of the disclosure.

FIG. 38 is a flowchart for describing a method, performed by each of a battery module, a control module and a motor assembly, of operating in a safe mode as the control module switches from a use position to a retreat position according to an embodiment of the disclosure.

FIG. 39 is a flowchart for describing a method of outputting a message related to replacement of a filter according to an embodiment of the disclosure.

FIG. 40 is a diagram for describing an operation of outputting a message related to replacement of a filter according to an embodiment of the disclosure.

### MODE FOR INVENTION

Terms used herein will be briefly described, and then an embodiment of the disclosure will be described in detail.

Although the terms used herein are selected from among common terms that are currently widely used in consideration of their functions in an embodiment of the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding description of an embodiment of the disclosure. Therefore, the terms used herein are not merely designations of the terms, but the terms are defined based on the meaning of the terms and content throughout the disclosure.

As used herein, the expression “at least one of a, b, or c” may indicate only a, only b, only c, both a and b, both a and c, both b and c, all of a, b, and c, or variations thereof.

Throughout the disclosure, when a part “includes” an element, it is to be understood that the part may additionally include other elements rather than excluding other elements as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

In the disclosure, a cleaner sucks in air with foreign substances such as dust through a suction force generated by a suction motor, filters the foreign substances out of the air, and accommodates the foreign substances in a dust collection container. A cordless cleaner receives power from a battery to perform a cleaning operation. The battery is separable from the cordless cleaner. A controller is provided in the cleaner. Hereinafter, the controller may also be referred to as a control module. Control of an operation of the cleaner, such as powering on/off, may be performed by using the controller. As the conditions of use of the cleaner vary, the shape and function of the controller may also vary. The disclosure provides a cleaner having a structure in which a controller is separable from the cleaner. The aesthetic elements of the cleaner may be improved by separating the controller from the top of the cleaner and replacing the controller with another controller having a different design, according to a user's preferences. In addition, the convenience of use and manipulability of the cleaner may be improved by mounting, on the cleaner, a controller having a manipulation unit and an indication unit suitable for the conditions of use of the cleaner. In addition, according to an embodiment of the disclosure, when the controller is separated from a main body of the cleaner, the operation of the cleaner may be restricted or stopped for the safety of the user.

The cleaner includes a filter that finally filters fine dust out of air that has passed through a dust collector. The filter is installed in a filter housing. In order to replace the filter, the filter housing may be separated from the main body of the cleaner. In the cleaner of the disclosure, the filter housing is separated from the cleaner in the backward direction. The cleaner includes a handle to be held by the user. The controller is arranged at the rear of the filter housing to allow the user holding the handle to easily manipulate the controller. The structure in which the controller is separable from the cleaner enables the use of various controllers and the separation of the filter housing from the rear of the cleaner.

The performance of the cleaner is affected by the resistance of an air flow path (i.e., flow path resistance). For a cordless cleaner using a rechargeable battery, suction efficiency and battery efficiency may be improved by reducing the flow path resistance. The cleaner of the disclosure has a reverse motor structure in which an impeller is located downstream of a suction motor. As the flow resistance against air sucked in by a suction fan (hereinafter, also referred to as a motor assembly) and discharged through the filter is improved, the battery efficiency relative to output may increase, and with the improvement of the battery efficiency, the use time of the vacuum cleaner that requires to be recharged before use may increase.

Hereinafter, an embodiment of the disclosure will be described in detail with reference to the accompanying drawings. Like reference numerals in the drawings indicate parts or components that perform substantially the same functions.

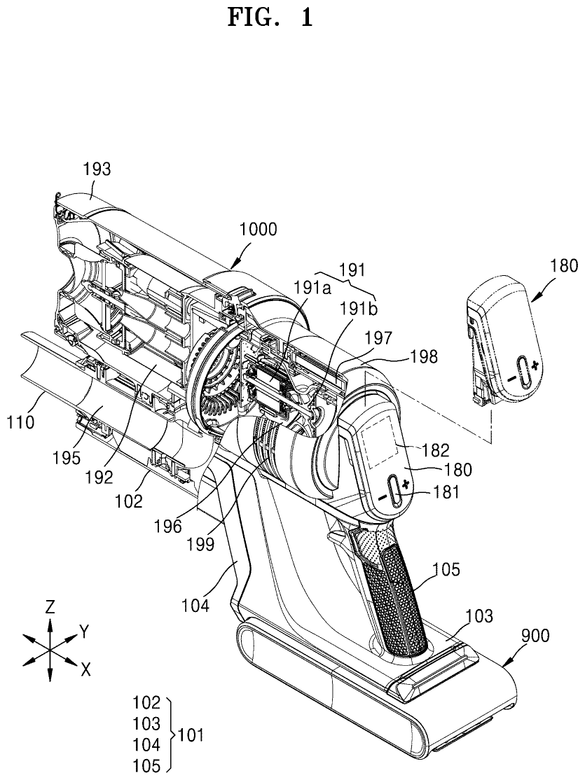

FIG. 1 is a schematic partial cross-sectional perspective view of a cleaner according to an embodiment of the disclosure. The exemplary cleaner illustrated in FIG. 1 is a stick-type cordless cleaner. Referring to FIG. 1, the cleaner may include a main body 1000 (hereinafter, also referred to as a cleaner main body) and a controller 180 (hereinafter, also referred to as a control module) for controlling the operation of the cleaner. The main body 1000 may include a suction fan 191 (hereinafter, also referred to as a motor assembly) to generate a suction force for sucking in air, a dust collector 192 to separate foreign substances from the sucked-in air, and a filter 197 to filter foreign substances out of the air that has passed through the dust collector 192. The filter 197 is accommodated in a filter housing 198. The controller 180 is located at the rear of the filter housing 198. The controller 180 is separable from the main body 1000.

The main body 1000 may include an extension pipe coupling unit 110 to which an extension pipe (not shown) is coupled. A suction nozzle (not shown) (e.g., a brush device) is separably coupled to one end of the extension pipe. The other end of the extension pipe may be separably coupled to the extension pipe coupling unit 110 of the main body 1000. The extension pipe connects the main body 1000 to the suction nozzle to form a passage through which air and foreign substances sucked in through the suction nozzle move to the main body 1000. The suction fan 191 is configured to generate a suction force required to suck in air with foreign substances on a surface to be cleaned and the dust collector 192 is configured to separate the foreign substances from the sucked-in air. The dust collection container 193 in which the separated foreign substances are accommodated and the filter housing 198 accommodating the filter 197 are provided in the main body 1000.

The suction fan 191 may include a suction motor 191a and an impeller 191b mounted on a rotating shaft of the suction motor 191a. When the suction motor 191a is driven to rotate the impeller 191b, suction pressure is generated for sucking in air and foreign substances on the surface to be cleaned through an air intake path 195. The air is adiabatically compressed by the impeller 191b and thus rises in temperature. In a structure in which the impeller 191b is located upstream of the suction motor 191a, and the suction motor 191a is exposed to the high-temperature compressed air. The motor coil of the suction motor 191a is cooled by the sucked-in air, and the motor coil may not be effectively cooled when the high-temperature compressed air flows around the suction motor 191a. The high-temperature compressed air may rather cause the temperature of the motor coil to rise, and the power and efficiency of the suction motor 191a may deteriorate. The suction fan 191 according to the present embodiment of the disclosure has a reverse motor structure in which the impeller 191b is arranged downstream of the suction motor 191a with respect to the direction of air flow. According to the present embodiment of the disclosure, in the suction fan 191 having the reverse motor structure, low-temperature uncompressed air passes through the surroundings of the suction motor 191a. The low-temperature air may effectively cool the motor coil. The motor coil may be maintained at a stable operating temperature, and thus, the power and efficiency of the suction motor 191a may be improved.

The air intake path 195 connecting the extension pipe coupling unit 110 to the dust collector 192 is provided in the main body 1000. The foreign substances and air sucked in through the suction nozzle by the suction force generated by the suction fan 191 are moved to the dust collector 192 via the extension pipe, the extension pipe coupling unit 110, and the air intake path 195. The dust collector 192 may have, for example, a cyclone dust collection structure. The dust collector 192 may be located between the dust collection container 193 and the suction fan 191, with respect to the flow path of the sucked-in air. The foreign substances are separated from the sucked-in air by the dust collector 192 and then accommodated in the dust collection container 193. The dust collection container 193 is separable from the main body 1000. For example, the dust collection container 193 may be separated from the main body 1000 by pulling a front portion of the dust collection container 193. After separating the dust collection container 193 from the main body 1000, foreign substances collected in the dust collection container 193 may be removed.

An exhaust path 196 for discharging the air from which the foreign substances are removed is provided in the main body 1000. The exhaust path 196 is provided downstream of the suction fan 191. The filter 197 may be provided at the inlet of the exhaust path 196, in the exhaust path 196, or at the outlet of the exhaust path 196. In the present embodiment of the disclosure, the filter 197 is provided at the outlet of the exhaust path 196. There is no particular limitation on the type of the filter 197. The filter 197 may include, for example, a high-efficiency particulate air (HEPA) filter. The filter 197 may filter out ultra-fine dust or the like that is not filtered out by the dust collector 192. The filter 197 may be accommodated in the filter housing 198. The air from which the foreign substances are removed may be discharged to the outside after passing through the exhaust path 196 and the filter 197. An exhaust port 199 through which the air that has passed through the exhaust path 196 and the filter 197 is discharged may be provided in the filter housing 198.

The filter housing 198 may be mountable on the main body 1000 and separable from the main body 1000 for maintenance of the filter 197, such as cleaning or replacement. The filter housing 198 may have a front separation structure in which the filter housing 198 is moved forward to be separated from the main body 1000. The front separation structure is disadvantageous in terms of user convenience in that the dust collection container 193 needs to be separated from the main body 1000 first in order to separate the filter housing 198 from the main body 1000. In addition, because the filter 197 needs to be located relatively far forward from the outlet of the suction fan 191, the curvature of the exhaust path 196 may be high, resulting in an increase in the flow path resistance. This may cause a deterioration in the suction efficiency of the suction fan 191. Meanwhile, when the suction fan 191 has the reverse motor structure, a connection wire fastening portion between a battery 900 and the suction motor 191a is located at the front end (downstream of the direction of air flow) of the suction motor 191a. Accordingly, in order to separate the filter 197 in the forward direction, the outer diameter of the filter 197 becomes relatively large to pass through the connection wire fastening portion, resulting in lower product competitiveness. In the cleaner of the present embodiment of the disclosure, the filter housing 198 has a backward separation structure in which the filter housing 198 is moved backward to be separated from the main body 1000. That is, the filter housing 198 is separable from the main body 1000 in the backward direction. The backward separation structure is advantageous in terms of user convenience in that the filter housing 198 may be separated from the main body 1000 without separating the dust collection container 193 from the main body 1000. In addition, because the filter 197 may be located close to the outlet of the suction fan 191, the curvature of the exhaust path 196 may be low, and thus, the flow path resistance may be less than that of the front separation structure. Accordingly, the suction efficiency of the suction fan 191 may be improved. Meanwhile, when the suction fan 191 has the reverse motor structure, the outer diameter of the filter 197 may be designed to be less than that of the front separation structure, and thus, product competitiveness is improved. The user may separate the filter housing 198 from the main body 1000, and then replace the filter 197 accommodated in the filter housing 198 with a new filter 197. Alternatively, the user may clean the filter 197 accommodated in the filter housing 198.

The main body 1000 includes a frame 101 to support or accommodate the above-described components of the cleaner. For example, the frame 101 may include a prop 102 extending in the forward or backward direction (X), a battery mount 103 extending in the forward or backward direction (X) parallel to the prop 102, and a support 104 connecting the prop 102 to the battery mount 103. The prop 102 may extend in the backward direction beyond the support 104. The dust collection container 193, the dust collector 192, the suction fan 191, and the filter housing 198 may be arranged in the forward or backward direction (X) above the prop 102. The extension pipe coupling unit 110 may be provided at the front of the prop 102. The air intake path 195 is provided inside the prop 102 and extends from the extension pipe coupling unit 110 to the dust collector 192. The exhaust path 196 may be provided downstream of the suction fan 191 and above the prop 102. The battery 900 may be mounted on or separated from the battery mount 103. The support 104 may connect the front end of the battery mount 103 to the prop 102. For example, the support 104 may be inclined toward the front from the lower end to the upper end.

The main body 1000 may include a handle 105 that may be gripped by a user. The user holding the handle 105 may move and manipulate the cleaner. The handle 105 may be located at the rear of the support 104. For example, the handle 105 may connect the rear end of the battery mount 103 to the rear end of the prop 102. The handle 105 may be inclined toward the front from the lower end to the upper end, considering convenience of use. For example, the upper end of the handle 105 may form an obtuse angle with the prop 102, and the lower end of the handle 105 may form an acute angle with the battery mount 103. The handle 105 may have a size suitable for the user to comfortably grip the handle 105.

The controller 180 is located at the rear of the filter housing 198. The controller 180 may be located near the rear end of the prop 102 and above the handle 105. The user holding the handle 105 may use the cleaner. Here, the controller 180 may naturally come into the user's field of view and thus the convenience of use may be improved. In addition, the user may easily manipulate the controller 180 with the thumb of the hand holding the handle 105 or with the other hand.

The controller 180 may include a control circuit unit and a manipulation unit 181 for making a manipulation input such as powering on/off, adjusting the suction strength, or changing the operation mode. The controller 180 may further include an indication unit 182 configured to indicate information about the operation state of the cleaner. The manipulation unit 181 may include a physical button, a resistive or capacitive touch panel, and the like. The manipulation unit 181 may have a structure enabling manipulation input through speech recognition and manipulation input through communication with an external control device. The indication unit 182 may audibly and visually indicate the operation state of the cleaner and the like. For example, the indication unit 182 may include a beeper, a display, one or more light-emitting units, and the like. When employing a touch panel display, the manipulation unit 181 and the indication unit 182 may be integrated into one unit. The control circuit unit may control the cleaner according to a manipulation input through the manipulation unit 181, and may control the indication unit 182 to indicate information about the operation state of the cleaner, and the like.

As described above, the controller 180 is separable from the main body 1000. For example, the controller 180 may be attached to or separated from the main body 1000 by being moved, for example, by being slid, in the forward or backward direction (X), a lateral direction (Y), or the upward or downward direction (Z).

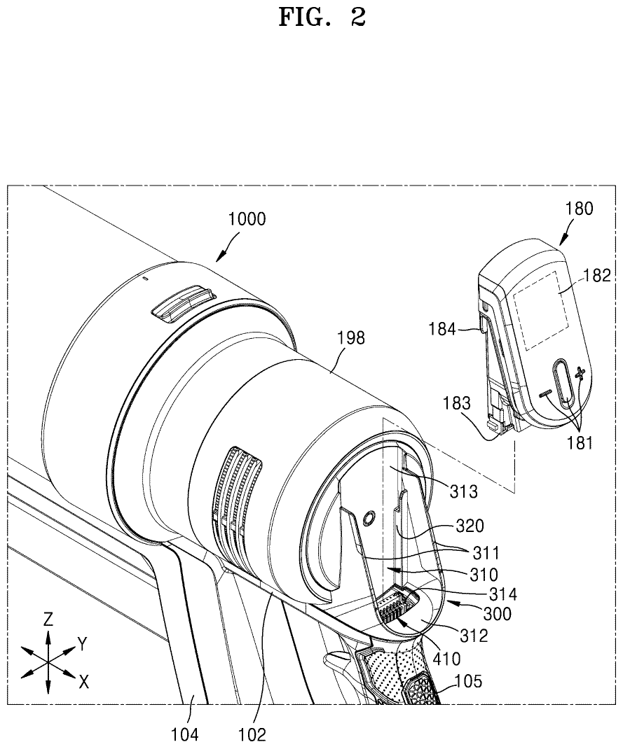

FIG. 2 is a partially exploded perspective view illustrating a structure in which the controller 180 is attached to or separated from a cleaner in the upward or downward direction (Z), according to an embodiment of the disclosure. Referring to FIG. 2, a socket 300 by which the controller 180 is separably supported may be provided in the main body 1000. For example, the socket 300 may be provided in the filter housing 198. For example, the socket 300 may be integrally formed with or coupled to the filter housing 198. The socket 300 includes an accommodation unit 310 in which the controller 180 is separably accommodated. The accommodation unit 310 may extend in the upward or downward direction (Z) and may have an open top. For example, the accommodation unit 310 may be defined by a pair of side walls 311 spaced apart from each other in the lateral direction (Y), a lower wall 312 connecting the lower ends of the pair of side walls 311 to each other, and a front wall 313 connecting the front ends of the pair of side walls 311 to each other.

A first guide 320 is provided to guide the controller 180 being attached to or separated from the socket 300. The first guide 320 extends in the directions of attachment and separation of the controller 180, i.e., in the upward and downward directions (Z). For example, the first guide 320 may be provided on each of the pair of side walls 311. A second guide 184 to be guided by the first guide 320 is provided in the controller 180. The first guide 320 and the second guide 184 may have complementary shapes for relative movements in the directions of attachment and separation. For example, the first guide 320 may have a slot shape extending in the upward or downward direction (Z), and the second guide 184 may have a shape protruding from both sidewalls of the controller 180 in the lateral direction (Y) to be inserted into the first guide 320. Although not illustrated in the drawings, the first guide 320 may have a protruding shape, and the second guide 184 may have a slot shape. In addition to above examples, the first guide 320 and the second guide 184 may have various complementary shapes for relative movements in the directions of attachment and separation.

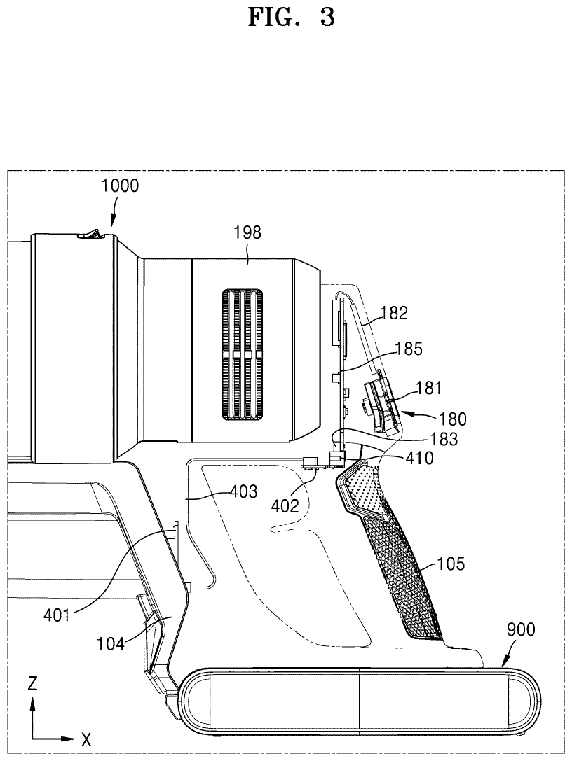

FIG. 3 is a schematic side view illustrating an electrical connection structure between the main body 1000 and the controller 180, according to an embodiment of the disclosure. Referring to FIGS. 2 and 3, in order to electrically connect the main body 1000 to the controller 180, a first connector 183 is provided in the controller 180. The controller 180 may include a printed circuit board 185 having a control circuit unit. The controller 180 may include one or more printed circuit boards 185. The manipulation unit 181 and the indication unit 182 may be electrically connected to the printed circuit board 185 (e.g., a control circuit board) by a connecting unit (not shown), for example, a wire, a cable, a connector, or a flexible circuit board. The first connector 183 is provided on the printed circuit board 185. For example, the first connector 183 may be provided at the lower end of the printed circuit board 185. The first connector 183 may be of various types depending on its shape and connection method. For example, the first connector 183 may include, but is not limited to, a board-to-board (B-to-B) connector, a C-type connector, and a separable connector for repetitive attachment and separation.

A second connector 410 to engage the first connector 183 may be provided in the main body 1000. A printed circuit board (first printed circuit board) 401 is provided in the main body 1000. The printed circuit board 401 is electrically connected to the battery 900 and control elements of the main body 1000 including the suction motor 191a and sensors. For example, the printed circuit board 401 may be accommodated in the support 104. A printed circuit board (second printed circuit board) 402 may be provided in the prop 102. The printed circuit board 402 may be located near the rear end of the prop 102. The second connector 410 is provided on the printed circuit board 402. The printed circuit board 401 and the printed circuit board 402 are electrically connected to each other by wires 403 although the printed circuit board 401 and the printed circuit board 402 can also be connected wirelessly.

The second connector 410 is exposed to the inside of the accommodation unit 310 through an opening 314 provided in the lower wall 312 forming the accommodation unit 310. The controller 180 is inserted into the accommodation unit 310 by aligning the second guide 184 with the first guide 320 and moving the controller 180 downward. When the controller 180 is completely inserted into the accommodation unit 310, the first connector 183 engages the second connector 410. Accordingly, the controller 180 may communicate with the battery 900 and the control elements of the main body 1000.

The second connector 410 may be formed to be complementary to the first connector 183. For example, the first connector 183 may include protruding pins, and the second connector 410 may include slots that may accommodate the pins. Alternatively, the second connector 410 may include a protrusion, and the first connector 183 may include a groove that may accommodate the protrusion. According to an embodiment of the disclosure, the first connector 183 and the second connector 410 may include a wafer connector. The controller 180 may be fixed to the main body 1000 by various fixing structures. For example, the controller 180 may be fixed to the main body 1000 by a snap-fit fixing structure, a magnetic fixing structure, a screw fastening structure, or the like.

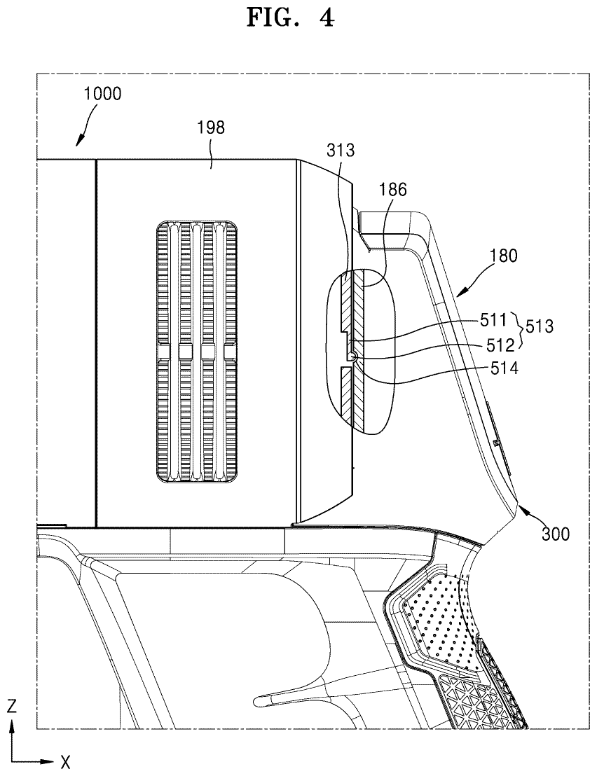

FIG. 4 illustrates a snap-fit fixing structure according to an embodiment of the disclosure. Referring to FIG. 4, according to an embodiment of the disclosure, the snap-fit fixing structure may include a catching unit 514 provided in any one of the controller 180 and the socket 300, and an elastic locker 513 provided in the other one of the controller 180 and the socket 300 to be elastically caught by the catching unit 514. In the present embodiment of the disclosure, the catching unit 514 is provided in the controller 180, and the elastic locker 513 is provided in the socket 300. For example, the elastic locker 513 may include an elastic arm 511 provided on the front wall 313 of the socket 300 to be elastically bent in the forward or backward direction (X), and an engagement protrusion 512 provided at an end of the elastic arm 511. The catching unit 514 has a shape by which the engagement protrusion 512 may be caught. For example, the catching unit 514 may be concavely formed on a front wall 186 of the controller 180.

When the controller 180 is inserted into the accommodation unit 310 of the socket 300 and then slid downward, the front wall 186 of the controller 180 pushes the engagement protrusion 512 forward such that the elastic arm 511 is bent forward. When the mounting of the controller 180 is completed, the elastic arm 511 elastically returns to its original position and the engagement protrusion 512 is thus caught by the catching unit 514, such that the controller 180 may be fixed to the socket 300. The controller 180 may remain fixed to the socket 300 unless a force greater than or equal to the elastic force of the elastic arm 511 is applied. By sliding the controller 180 upward with a force greater than the elastic force of the elastic arm 511 in order to separate the controller 180 from the socket 300, the engagement protrusion 512 is pushed forward by the catching unit 514 and the elastic arm 511 is bent forward such that the engagement protrusion 512 is separated from the catching unit 514. By continuously sliding the controller 180 upward, the controller 180 may be separated from the accommodation unit 310 of the socket 300. When the controller 180 is separated from the socket 300, the elastic arm 511 elastically returns to its original position.

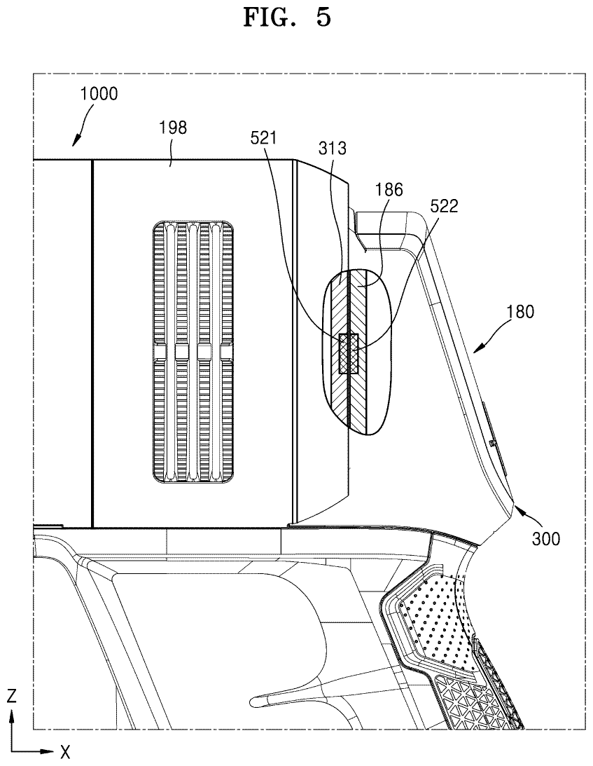

FIG. 5 illustrates a magnetic fixing structure according to an embodiment of the disclosure. Referring to FIG. 5, according to an embodiment of the disclosure, the magnetic fixing structure may include a magnet 521 provided in any one of the controller 180 and the socket 300, and a magnetic member 522 provided in the other one of the controller 180 and the socket 300. The magnetic member 522 is a member that is able to stick to the magnet 521, such as iron. In the present embodiment of the disclosure, the magnetic member 522 is provided in the controller 180, and the magnet 521 is provided in the socket 300. For example, the magnet 521 may be provided on the front wall 313 of the socket 300, and the magnetic member 522 may be provided on the front wall 186 of the controller 180 facing the front wall 313. When the controller 180 is inserted into the accommodation unit 310 of the socket 300, the magnetic member 522 may be attached to the magnet 521 by the magnetic force of the magnet 521, and the controller 180 may be fixed to the socket 300. By sliding the controller 180 upward with a force greater than the magnetic force of the magnet 521 in order to separate the controller 180 from the socket 300, the magnetic member 522 may be separated from the magnet 521, and the controller 180 may be separated from the accommodation unit 310 of the socket 300.

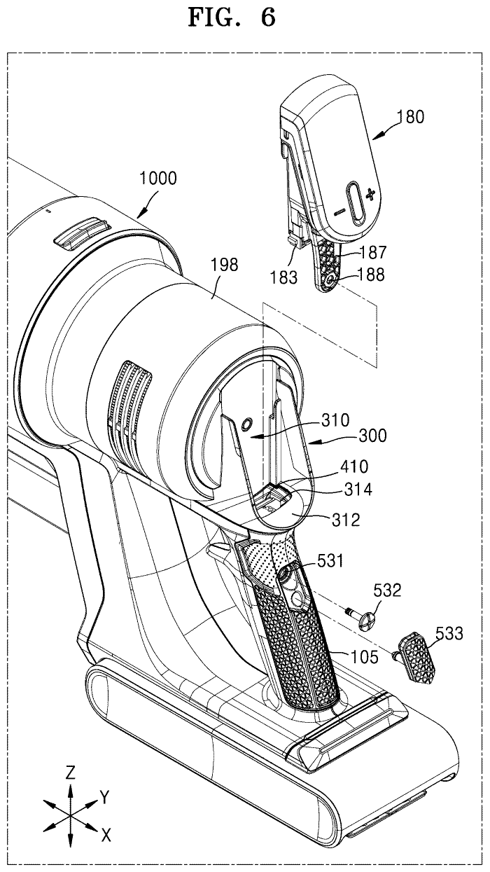

FIG. 6 illustrates a screw fastening structure according to an embodiment of the disclosure. Referring to FIG. 6, a locking unit 187 to be inserted into the handle 105 is provided in the controller 180. For example, the locking unit 187 extends downward from the lower end of the controller 180. The locking unit 187 may be located at the rear of the first connector 183. A locking hole 188 is provided in the locking unit 187. The opening 314 is provided in a lower portion of the socket 300, for example, in the lower wall 312. The second connector 410 described above is exposed upward through the opening 314. The opening 314 provides a passage through which the locking unit 187 is inserted into the handle 105.

When the controller 180 is mounted on the socket 300, the locking unit 187 is inserted into the handle 105 through the opening 314. A screw fastening hole 531 to be aligned with the locking hole 188 is provided in the handle 105. The controller 180 may be fixed to the main body 1000 by a tightening of a screw 532 into the locking hole 188 through the screw fastening hole 531. A cover 533 may cover the screw fastening hole 531. The cover 533 may be separably coupled to the handle 105. In order to maintain the appearance quality of the cleaner, the cover 533 may have a shape matching the appearance of the handle 105. The cover 533 may be formed of, for example, rubber or the like. The controller 180 may be separated from the main body 1000 by separating the cover 533 from the handle 105, loosening the screw 532, and then sliding the controller 180 upward to separate it from the socket 300.

As the conditions of use of the cleaner vary, the shape and function of the controller 180 may also vary. According to the disclosure, the controller 180 is separable from the main body 1000. The user may improve aesthetic elements of the cleaner by separating the controller 180 from the main body 1000 and replacing the controller 180 with another controller 180 having a different design, according to the user's preferences. In addition, the user may improve the convenience of use and manipulability of the cleaner by mounting, on the cleaner, the controller 180 having the manipulation unit 181 and the indication unit 182 suitable for the conditions of use of the cleaner.

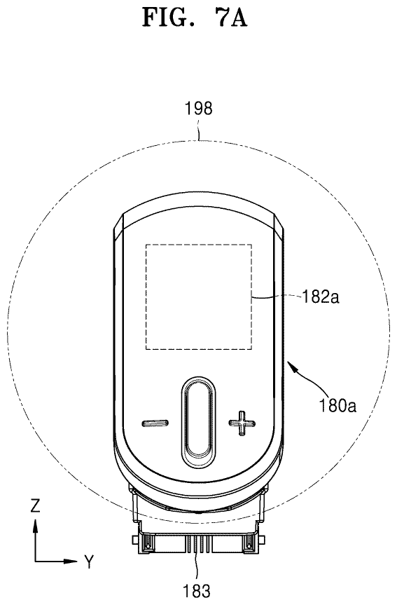

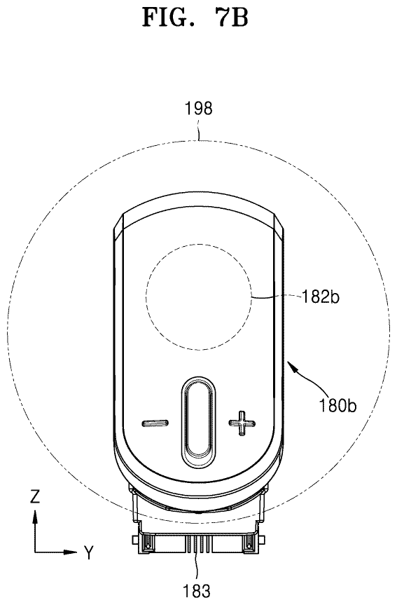

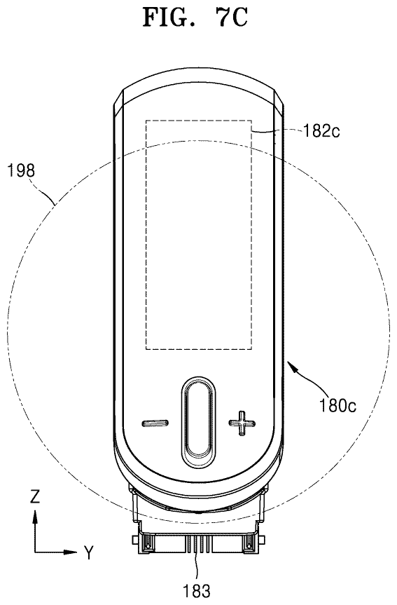

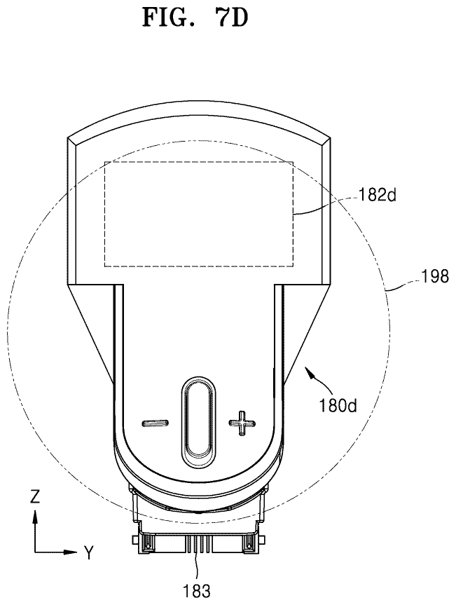

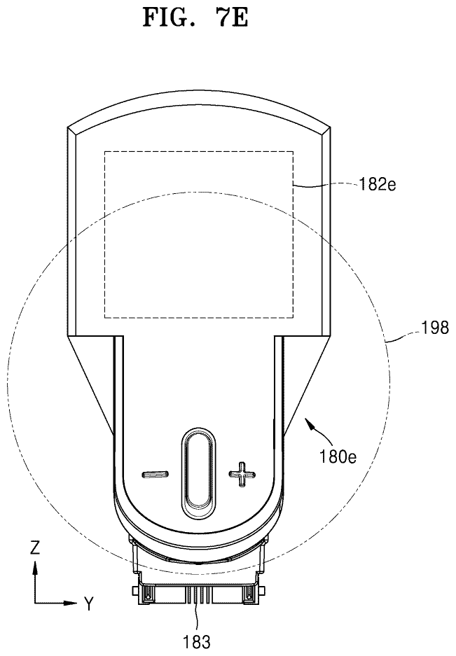

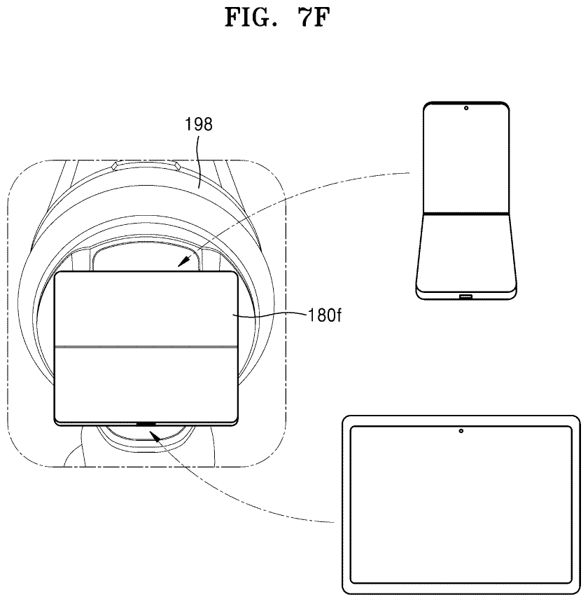

FIGS. 7A to 7E illustrate various examples of the controller 180. Referring to FIG. 7A, a controller 180a according to an embodiment of the disclosure is a general or standard controller having an indication unit 182a having a quadrangular shape and a standard size. The controller 180a may have form factors, for example, a length in the lateral direction (horizontal direction) (Y) and a length in the upward or downward direction (vertical direction) (Z), that are less than form factors of the filter housing 198, respectively. In other words, the projected area of the controller 180a in the forward or backward direction (X) on the Y-Z plane is within the projected area of the filter housing 198 in the forward or backward direction (X) on the Y-Z plane. Referring to FIG. 7B, a controller 180b according to an embodiment of the disclosure is different from the controller 180a illustrated in FIG. 7A in that an indication unit 182b has a circular shape.

At least one of the form factors of the controller 180 may be greater than that of the filter housing 198. The form factors of the filter housing 198 refer to parameters that determine the shape and size of the projected area of the filter housing 198 in the direction of attachment or separation thereof. Similarly, the form factors of the controller 180 refer to parameters that determine the shape and size of the projected area of the controller 180 in the direction of attachment or separation of the filter housing 198. For example, in a case in which the appearance of the filter housing 198 has a cylindrical shape, the diameter of the largest cross-section of the filter housing 198 on the Y-Z plane is the form factor of the filter housing 198. The controller 180 may include the longest lengths of the controller 180 in the lateral direction (Y) and the upward or downward direction (Z).

Referring to FIG. 7C, a controller 180c according to an embodiment of the disclosure includes an indication unit 182c that is longer in the upward or downward direction (Z) than the indication unit 182a of the controller 180a illustrated in FIG. 7A. The length of the controller 180c in the upward or downward direction (Z) is greater than the diameter of the filter housing 198. The controller 180c extends upward beyond the periphery of the filter housing 198. That is, the projected area of the controller 180c on the Y-Z plane exceeds, in the upward or downward direction (Z), the projected area of the filter housing 198 on the Y-Z plane.

Referring to FIG. 7D, a controller 180d according to an embodiment of the disclosure includes an indication unit 182d that is longer in the lateral direction (Y) than the indication unit 182a of the controller 180a illustrated in FIG. 7A. The length of the controller 180d in the lateral direction (Y) is greater than the diameter of the filter housing 198. The controller 180d extends in the lateral direction (Y) beyond the periphery of the filter housing 198. That is, the projected area of the controller 180d on the Y-Z plane exceeds, in the lateral direction (Y), the projected area of the filter housing 198 on the Y-Z plane.

Referring to FIG. 7E, a controller 180e according to an embodiment of the disclosure includes an indication unit 182e that is longer in both the upward or downward direction (Z) and the lateral direction (Y) than the indication unit 182a of the controller 180a illustrated in FIG. 7A. The controller 180e extends in the upward or downward direction (Z) beyond the periphery of the filter housing 198. The lengths of the controller 180e in the upward or downward direction (Z) and the lateral direction (Y) are both greater than the diameter of the filter housing 198. That is, the projected area of the controller 180e on the Y-Z plane exceeds, in the upward or downward direction (Z) and the lateral direction (Y), the projected area of the filter housing 198 on the Y-Z plane.

As such, the controller 180 including the indication unit 182 having various sizes and shapes may be mounted on the main body 1000 to reflect the user's demand. Although not illustrated in FIGS. 7A to 7E, various controllers 180 having various exterior colors and including manipulation units 181 having different colors and shapes may be provided, and an appropriate controller 180 may be mounted on the main body 1000 according to the user's preferences.

In some embodiments, the various controllers 180 have the various sizes and shapes as well as the various exterior colors, etc., can be modular and interchangeable with one another such that a user can change between the various controllers 180 at any time.

Another controller 180 having various functions reflecting the user's usage patterns may be mounted on the main body 1000 to replace the existing controller 180. For example, a standard controller capable of selecting a normal mode, a strong-suction mode, and a super-strong-suction mode, a professional controller capable of selecting the normal mode, an eco mode, the strong-suction mode, the super-strong-suction mode, and a jet mode, or a senior-type controller capable of selecting the normal mode and the super-strong-suction mode, and displaying information in a large size may be mounted on the main body 1000 according to the user's usage pattern. For example, the standard controller and the professional controller may have the shapes illustrated in FIGS. 7A to 7E. For example, the senior-type controller may have a shape for displaying large letters, as illustrated in FIGS. 7D and 7E.

FIG. 7F is a diagram illustrating a state in which a user terminal is installed instead of a controller.

Referring to FIG. 7F, a mobile terminal 180f (e.g., a smart phone or a tablet device) of a user may be mounted on the main body 1000 to replace the controller 180. Here, the mobile terminal 180f may be a device in which a particular application for managing home appliances is installed. The user may control the operation of the cleaner by executing the application installed in the mobile terminal 180f. During a cleaning operation, the user may control operations of other home appliances or monitor states of the other home appliances through the particular application of the mobile terminal 180f. For example, during a cleaning operation, the user may manage the state of a refrigerator, remotely control a washing machine, set the temperature of an air conditioner, change a channel of a television (TV), or turn on/off a lamp, through the mobile terminal 180f mounted on the cleaner.

The cleaner may be connected to the mobile terminal 180f through a wireless network (e.g. Wi-Fi, Bluetooth Low Energy (BLE), 5G communication, or Long-Term Evolution (LTE)). For example, when the mobile terminal 180f is mounted on the cleaner, the mobile terminal 180f may establish a wireless communication channel with the cleaner and automatically execute a particular application for managing home appliances.

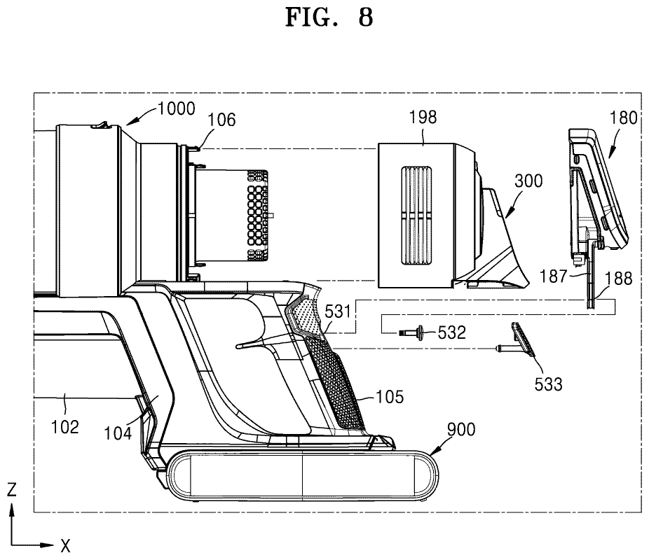

As described above, the cleaner of the disclosure includes the filter housing 198 that may be separated from the cleaner in the backward direction. The separable controller 180 enables the separation of the filter housing 198 from the cleaner in the backward direction. FIG. 8 is a schematic side view illustrating a state in which the filter housing 198 is separated from the main body 1000. Referring to FIG. 8, because the controller 180 is arranged at the rear of the filter housing 198, the user separates the controller 180 from the main body 1000 first before separating the filter housing 198 from the main body 1000. For example, the cover 533 is removed from the handle 105 to expose the screw fastening hole 531. The fixation of the controller 180 is released by loosening the screw 532. Then, the controller 180 is separated from the socket 300 by sliding the controller 180 upward. Then, the filter housing 198 may be separated from the main body 1000 by sliding the filter housing 198 backward. The socket 300 is separated from the main body 1000 integrally with the filter housing 198.

The user may replace or clean the filter 197 and then mount the filter housing 198 back on the main body 1000. The filter housing 198 may be fixed to the main body 1000, for example, by being hooked on a hook 106 provided on the main body 1000. Then, the user inserts the controller 180 into the socket 300 by aligning the controller 180 with the accommodation unit 310 of the socket 300 and then sliding the controller 180 downward. When the controller 180 is completely inserted into the socket 300, the first connector 183 is coupled to the second connector 410 of the main body 1000. The locking unit 187 is inserted into the handle 105, and the locking hole 188 is aligned with the screw fastening hole 531. The controller 180 may be fixed to the main body 1000 by fastening the screw 532 into the locking hole 188 through the screw fastening hole 531. The screw fastening hole 531 may be covered by coupling the cover 533 to the handle 105.

According to a general cleaner, a filter housing having the shape of a hollow cylinder is employed. In order to allow the filter housing to be separated from the main body when it is slid backward, the size of the controller needs to be smaller than the inner diameter of the hollow part of the filter housing. Thus, the size of the indication unit is limited and it becomes difficult to adopt or incorporate controllers having various sizes and shapes.

According to the cleaner of the disclosure, the controller 180 may be separated from the main body 1000. The filter housing 198 may be separated from the main body 1000 by separating the controller 180 from the main body 1000 first, and then sliding the filter housing 198 backward from the main body 1000. Thus, the backward separation of the filter housing 198 is not limited by the size or shape of the controller 180. According to the cleaner including the filter housing 198 that may be separated from the cleaner in the backward direction according to an embodiment of the disclosure, the filter 197 may be easily replaced such that the cleaner may be easily kept clean and may perform a high-performance cleaning operation. In addition, because the filter 197 may be located relatively close to the outlet of the suction fan 191, the curvature of the exhaust path 196 is relatively low, thus, the flow path resistance is relatively low, and the suction efficiency of the suction fan 191 may be improved. In addition, the efficiency of the battery 900 compared to the power of the suction fan 191 increases, and thus, the use time of the cordless cleaner that requires to be recharged before use may increase. In addition, because controllers 180 having various sizes, shapes, and functions may be used, the user convenience may be improved.

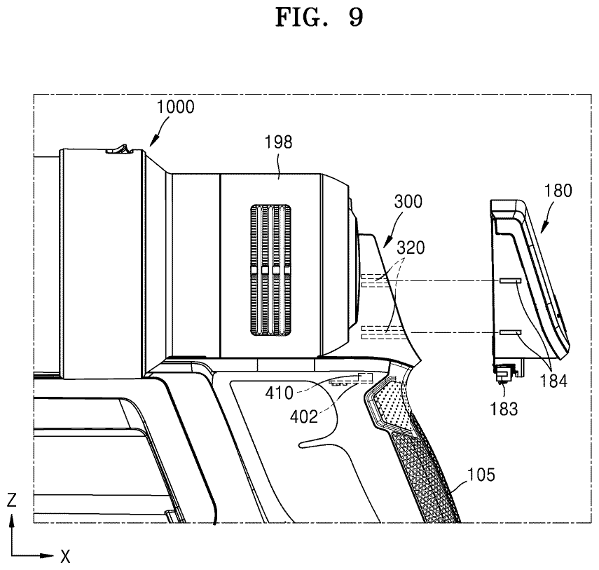

In the above-described embodiment of the disclosure, the controller 180 is slid in the upward or downward direction (Z) to be attached to and separated from the main body 1000, for example, the socket 300, but the sliding direction of the controller 180 may vary. FIG. 9 illustrates a structure in which the controller 180 is attached to or separated from the main body 1000 by being slid in the forward or backward direction (X), according to an embodiment of the disclosure. Referring to FIG. 9, the socket 300 is provided on the rear surface of the filter housing 198. The first guide 320 having a slot shape extending in the forward or backward direction (X) is provided inside the socket 300. The second guide 184 having a protrusion shape extending in the forward or backward direction (X) is provided on the side wall of the controller 180. In order to electrically connect the main body 1000 to the controller 180, the first connector 183 is provided in the controller 180. The first connector 183 is provided on the printed circuit board 185 (see FIG. 3) including a control circuit unit. The second connector 410 to engage the first connector 183 is provided in the main body 1000. The second connector 410 is provided on the printed circuit board 402 connected to the printed circuit board 401 (see FIG. 3) by the wires 403 (see FIG. 3). The first connector 183 and the second connector 410 may be coupled to each other in the forward or backward direction (X).

The controller 180 is inserted into the accommodation unit 310 of the socket 300 by aligning the second guide 184 with the first guide 320 and moving the controller 180 forward. When the controller 180 is completely inserted into the accommodation unit 310, the first connector 183 engages the second connector 410. Accordingly, the controller 180 may communicate with the battery 900 and the control elements of the main body 1000. The controller 180 may be fixed to the main body 1000 by various fixing structures. For example, the controller 180 may be fixed to the main body 1000 by the above-described snap-fit fixing structure or magnetic fixing structure, or the like. Although not illustrated in the drawings, in the snap-fit fixing structure, the elastic locker 513 (see FIG. 4) may be provided on the side walls 311 forming the accommodation unit 310, and the catching unit 514 (see FIG. 4) may be provided on the sidewalls of the controller 180 opposite to the sidewalls 311. Although not illustrated in the drawings, the magnetic fixing structure may be the same as illustrated in FIG. 5. Although not illustrated in the drawings, the controller 180 may be fixed to the main body 1000 by a screw fastening structure or the like.

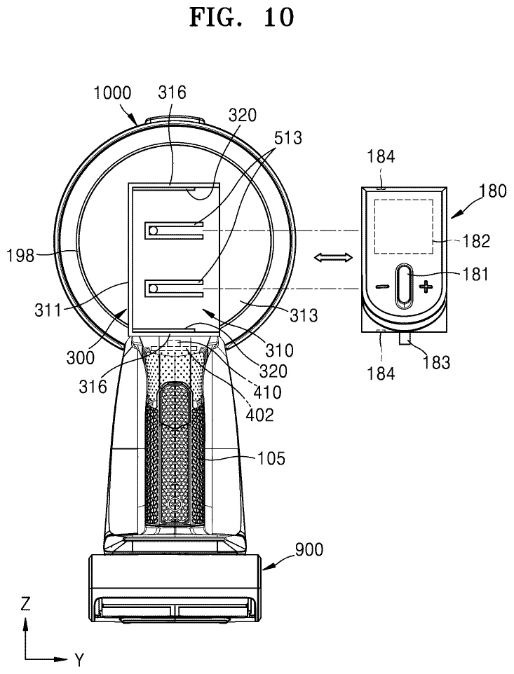

FIG. 10 is a side view in the lateral direction (Y) illustrating a structure in which the controller 180 is attached to or separated from the main body 1000 by being slid in the lateral direction (Y), according to an embodiment of the disclosure. Referring to FIG. 10, the socket 300 is provided on the rear surface of the filter housing 198. The socket 300 includes the accommodation unit 310 opened in the lateral direction (Y). For example, the accommodation unit 310 may be defined by a pair of walls 316 arranged in the upward or downward direction (Z), the side walls 311 connecting one ends of the pair of walls 316 in the lateral direction (Y) to each other, and the front wall 313. The first guide 320 having a slot shape extending in the lateral direction (Y) may be provided inside the pair of walls 316. The second guide 184 having a protrusion shape may be provided on the upper wall and the lower wall of the controller 180. In order to electrically connect the main body 1000 to the controller 180, the first connector 183 is provided in the controller 180. The first connector 183 is provided on the printed circuit board 185 (see FIG. 3) including a control circuit unit. The second connector 410 to engage the first connector 183 is provided in the main body 1000. The second connector 410 is provided on the printed circuit board 402 connected to the printed circuit board 401 (see FIG. 3) by the wires 403 (see FIG. 3). The first connector 183 and the second connector 410 may be coupled to each other in the lateral direction (Y).

The controller 180 is inserted into the accommodation unit 310 of the socket 300 by aligning the second guide 184 with the first guide 320 and moving the controller 180 in the lateral direction (Y). When the controller 180 is completely inserted into the accommodation unit 310, the first connector 183 engages the second connector 410. Accordingly, the controller 180 may communicate with the battery 900 and the control elements of the main body 1000. The controller 180 may be fixed to the main body 1000 by various fixing structures. For example, the controller 180 may be fixed to the main body 1000 by the above-described snap-fit fixing structure or magnetic fixing structure, or the like. In the snap-fit fixing structure, the elastic locker 513 may be provided on the front wall 313 forming the accommodation unit 310, and the catching unit 514 (see FIG. 4) may be provided on the front wall 186 (see FIG. 4) of the controller 180 opposite to the front wall 313. Although not illustrated in the drawings, the magnetic fixing structure may be the same as illustrated in FIG. 5. Although not illustrated in the drawings, the controller 180 may be fixed to the main body 1000 by a screw fastening structure or the like.

FIG. 10 illustrates a structure according to an embodiment of the disclosure in which the controller 180 is mounted on the main body 1000 by being slid in the left direction (−Y), but the disclosure is not limited thereto. For example, the cleaner may be designed in a structure in which the controller 180 is mounted on the main body 1000 by being slid in the right direction (+Y), in a structure in which the controller 180 is mounted on the main body 1000 by being slid in the downward direction (−Z), or in a structure in which the controller 180 is mounted on the main body 1000 by being slid in the upward direction (+Z).

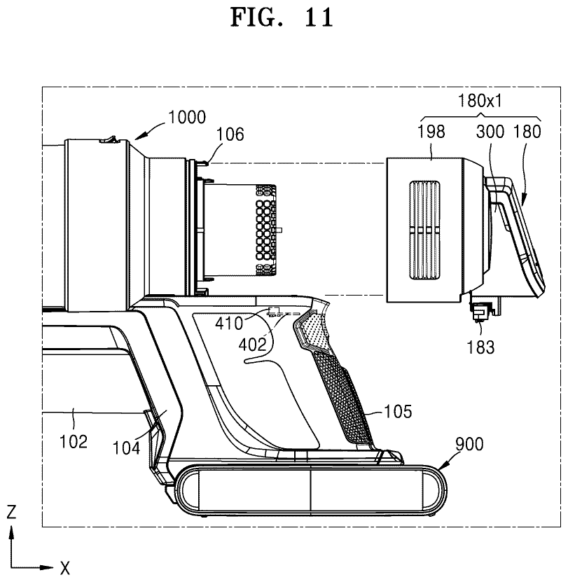

The controller 180 may be coupled to the filter housing 198, and thus may be attached to or separated from the main body 1000 integrally with the filter housing 198. FIG. 11 is a schematic side view of a cleaner according to an embodiment of the disclosure. Referring to FIG. 11, the socket 300 is provided on the rear surface of the filter housing 198, and the controller 180 is supported by the socket 300. The printed circuit board 402 including the second connector 410 is located in the main body 1000, for example, at the rear of the prop 102. The filter housing 198 and the controller 180 integrally form a controller assembly 180X1. The controller assembly 180X1 may be attached to or separated from the main body 1000 by being slid in the forward or backward direction (X). The controller 180 may be fixedly supported by the socket 300 and may be attached to and separated from the socket 300 as described above.

When the controller assembly 180X1 is slid forward, the first connector 183 and the second connector 410 are coupled to each other, and the front end of the filter housing 198 is caught on the hook 106 provided in the main body 1000. Accordingly, the controller assembly 180X1 may be fixed to the main body 1000. The controller assembly 180X1 may be fixed to the main body 1000 by a fixing unit not illustrated in the drawings. When the controller assembly 180X1 is slid backward, the front end of the filter housing 198 is separated from the hook 106 and the first connector 183 is separated from the second connector 410. Accordingly, the controller assembly 180X1 may be separated from the main body 1000. In this state, maintenance of the filter 197, such as replacement or cleaning, may be performed. In a case in which the controller 180 is separable from the socket 300, another controller 180 may be mounted on the socket 300 to replace the existing controller 180. In a case in which the controller 180 is fixedly supported by the socket 300, another controller assembly 180X1 to which another controller 180 is applied may be mounted on the main body 1000 to replace the existing controller assembly 180X1.

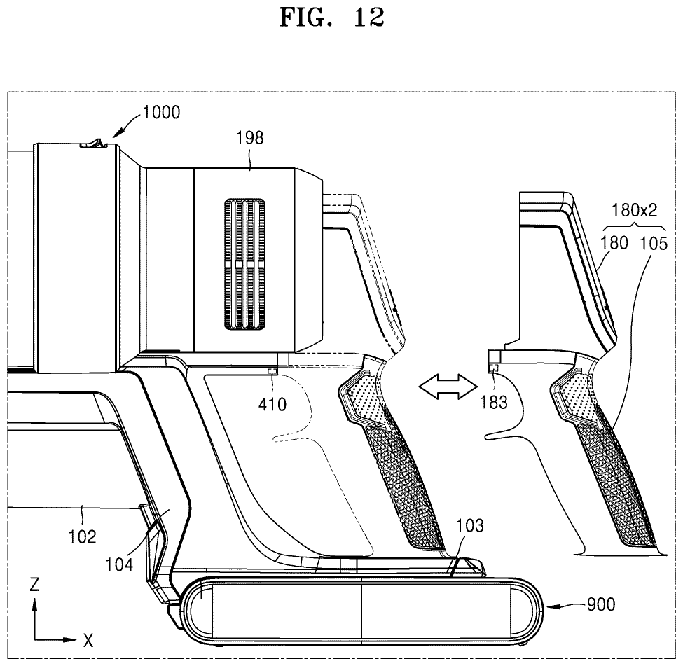

The controller 180 may be coupled to the handle 105 and thus may be attached to and separated from the main body 1000 integrally with the handle 105. FIG. 12 is a schematic side view of a cleaner according to an embodiment of the disclosure. Referring to FIG. 12, the controller 180 is supported by the upper end of the handle 105. Although not illustrated in the drawings, the socket 300 may be provided at the upper end of the handle 105 and the controller 180 may be separably supported by the socket 300. The second connector 410 is provided in the main body 1000, for example, at the rear of the prop 102. Although not illustrated in the drawings, the second connector 410 is provided on the printed circuit board 402 (see FIG. 3). The handle 105 and the controller 180 integrally form a controller assembly 180X2. The controller assembly 180X2 may be attached to or separated from the main body 1000 by being slid in the forward or backward direction (X).

When the controller assembly 180X2 is slid forward, the first connector 183 and the second connector 410 are coupled to each other, and the handle 105 is supported by the main body 1000. For example, the upper and lower ends of the handle 105 are supported by the prop 102 and the battery mount 103, respectively. The controller assembly 180X2 may be fastened to the prop 102 and/or the battery mount 103 by a screw (not shown) or the like. Accordingly, the controller assembly 180X2 may be fixed to the main body 1000.

By loosening the screw (not shown) and sliding the controller assembly 180X2 backward, the upper and lower ends of the handle 105 can be separated from the prop 102 and the battery mount 103, respectively, and the first connector 183 can be separated from the second connector 410. Accordingly, the controller assembly 180X2 may be separated from the main body 1000. In a case in which the controller 180 is separable from the socket 300, another controller 180 may be mounted on the socket 300 to replace the existing controller 180. In a case in which the controller 180 is fixedly supported by the socket 300, another controller assembly 180X2 to which another controller 180 is applied may be mounted on the main body 1000 to replace the existing controller assembly 180X2. When the filter 197 requires maintenance such as replacement or cleaning, the filter housing 198 may be separated from the main body 1000 after the controller assembly 180X2 is separated from the main body 1000.

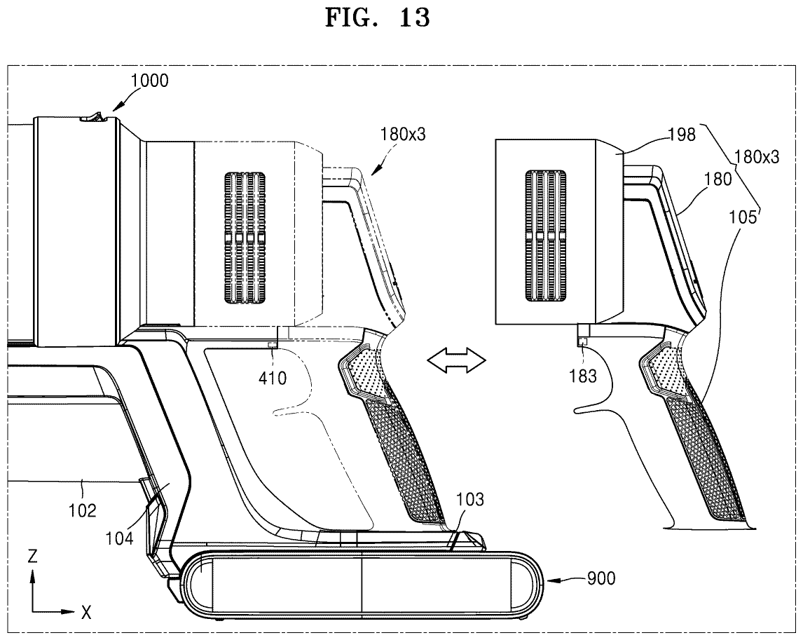

The controller 180 may be attached to or separated from the main body 1000 integrally with the filter housing 198 and the handle 105. FIG. 13 is a schematic side view of a cleaner according to an embodiment of the disclosure. Referring to FIG. 13, the filter housing 198 and the controller 180 are supported by the upper end of the handle 105. The controller 180 is located at the rear of the filter housing 198. Although not illustrated in the drawings, the socket 300 may be provided at the upper end of the handle 105, i.e., at the rear of the filter housing 198, and the controller 180 may be separably supported by the socket 300. The second connector 410 is provided in the main body 1000, for example, at the rear of the prop 102. Although not illustrated in the drawings, the second connector 410 is located on the printed circuit board 402 (see FIG. 3). The handle 105, the filter housing 198, and the controller 180 integrally form a controller assembly 180X3. The controller assembly 180X3 may be attached to or separated from the main body 1000 by being slid in the forward or backward direction (X).

When the controller assembly 180X3 is slid forward, the first connector 183 and the second connector 410 are coupled to each other, and the upper and lower ends of the handle 105 are supported by the prop 102 and the battery mount 103, respectively. The front end of the filter housing 198 may be caught on the hook 106 (see FIG. 8). The controller assembly 180X3 may be fastened to the prop 102 or the battery mount 103 by a screw (not shown) or the like. Accordingly, the controller assembly 180X3 may be fixed to the main body 1000.

By loosening the screw (not shown) and sliding the controller assembly 180X3 backward, the front end of the filter housing 198 is released from the hook 106 (see FIG. 8), and the upper and lower ends of the handle 105 are separated from the prop 102 and the battery mount 103, respectively. The first connector 183 is separated from the second connector 410. Accordingly, the controller assembly 180X3 may be separated from the main body 1000. In a case in which the controller 180 is separable from the socket 300, another controller 180 may be mounted on the socket 300 to replace the existing controller 180. In a case in which the controller 180 is fixedly supported by the socket 300, another controller assembly 180X3 to which another controller 180 is applied may be mounted on the main body 1000 to replace the existing controller assembly 180X3. When necessary, maintenance of the filter 197, such as replacement or cleaning, may be performed.

To enable the backward separation of the filter housing 198, the controller 180 may be switched to a retreat position not to interfere with the filter housing 198 when the filter housing 198 is separated from the cleaner in the backward direction. In other words, the controller 180 may be switched between a use position at the rear of the filter housing 198, and the retreat position described above.

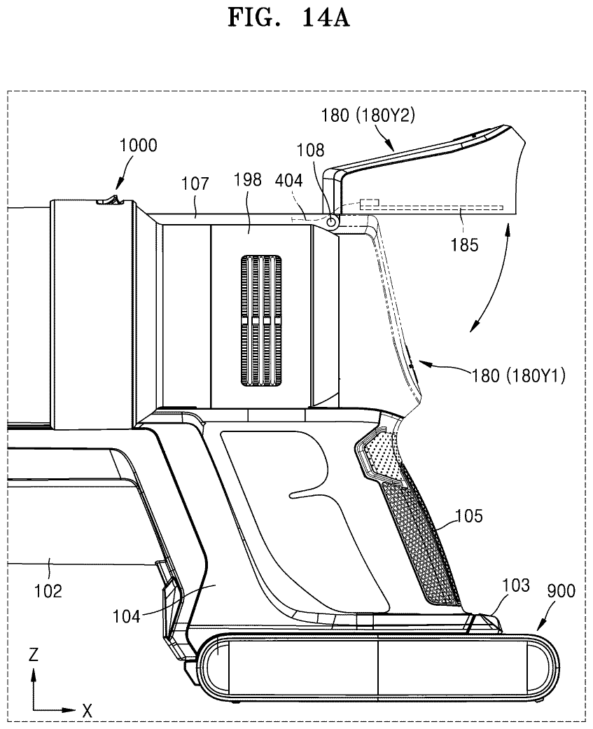

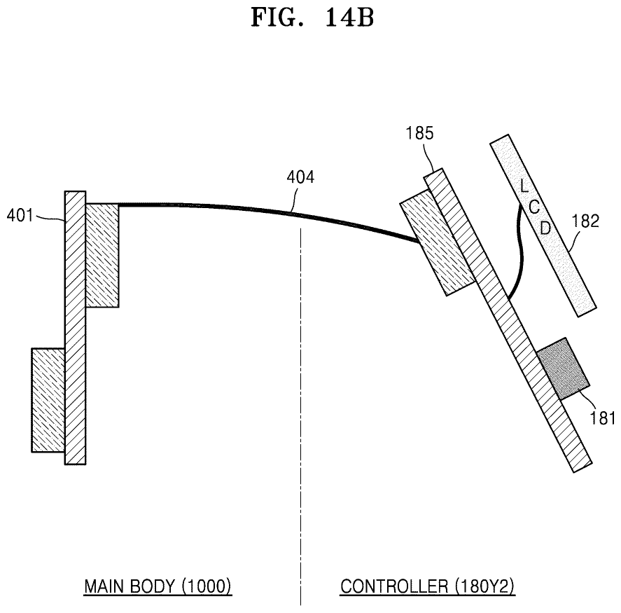

FIG. 14A is a schematic side view of a cleaner according to an embodiment of the disclosure. Referring to FIG. 14A, the controller 180 may be rotated to a use position 180Y1 at the rear of the filter housing 198, and a retreat position 180Y2 in which the controller 180 does not interfere with the filter housing 198 being separated from the cleaner in the backward direction. The main body 1000 may include an upper support 107. The upper support 107 may be located above the filter housing 198 and may extend rearward while surrounding the perimeter of the dust collector 192. The upper support 107 may extend from the prop 102. The upper support 107 may partially surround the filter housing 198. The upper support 107 may entirely surround the filter housing 198. In this case, the rear end of the upper support 107 may be open. The controller 180 is rotatably supported by a hinge 108 at the rear end of the upper support 107. The hinge 108 includes a shaft in the lateral direction (Y). The printed circuit board 185 of the controller 180 may be electrically connected to the above-described printed circuit board 401 (see FIG. 3) by, for example, a flexible wire 404. Although not illustrated in the drawings, the cleaner may have a fixing structure for fixing the controller 180 to the use position 180Y1. The fixing structure may include, for example, a snap-fit fixing structure, a magnetic fixing structure, a screw fastening structure, and the like.

When the cleaner is in use, the controller 180 is at the use position 180Y1 as illustrated by dotted lines in FIG. 14A. At the use position 180Y1, the controller 180 is located at the rear of the filter housing 198 and above the handle 105. Before separating the filter housing 198 from the main body 1000, the controller 180 is rotated upward about the hinge 108 to be at the retreat position 180Y2. At the retreat position 180Y2, the controller 180 does not interfere with the filter housing 198 being slid backward from the main body 1000. The filter housing 198 may be separated from the main body 1000 while the controller 180 is at the retreat position 180Y2.

FIG. 14B is a diagram for describing the wire 404 connecting the controller 180 to the main body 1000, according to an embodiment of the disclosure.

Referring to FIG. 14B, the controller 180 may be electrically connected to the main body 1000 through the wire 404 in a state in which the controller 180 is at the retreat position 180Y2. That is, when the controller 180 is at the retreat position 180Y2, the controller 180 may be physically separated from the main body 1000 (an incompletely coupled state), but electrically connected to the main body 1000. Accordingly, the controller 180 may receive power from the battery 900 even at the retreat position 180Y2, and may perform communication (e.g., Universal Asynchronous Receiver/Transmitter (UART) communication or Inter-Integrated Circuit (I2C) communication) with parts in the main body 1000 (e.g., the battery 900, the suction fan 191, or a pressure sensor).

According to an embodiment of the disclosure, the wire 404 may be a flexible printed circuit (FPC), a flexible flat cable (FFC), a curl wire, or the like, but is not limited thereto.

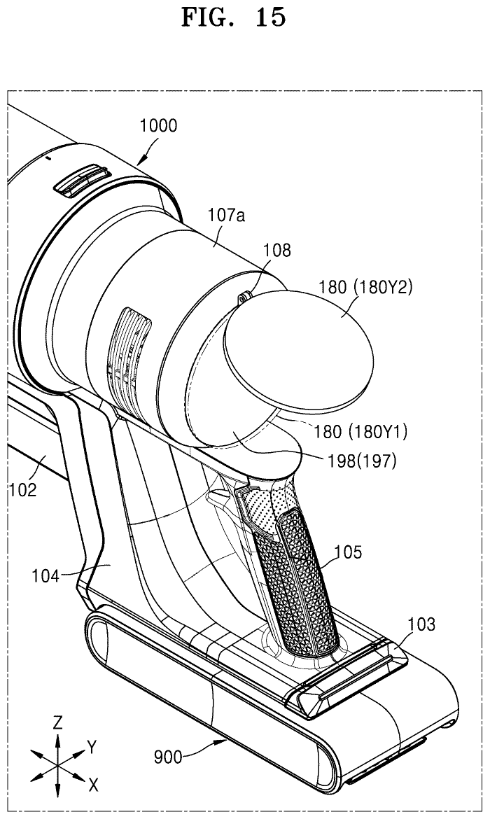

FIG. 15 is a schematic perspective view of a cleaner according to an embodiment of the disclosure. The cleaner according to the present embodiment of the disclosure is different from the cleaner according to the embodiment of the disclosure illustrated in FIG. 14A in that an upper support 107a entirely surrounds the filter housing 198. Hereinafter, differences from the embodiment of the disclosure illustrated in FIG. 14A will be mainly described, and redundant descriptions will be omitted. Referring to FIG. 15, the upper support 107a entirely surrounds the filter housing 198. The upper support 107a may have a cylindrical shape with an open rear end. The filter housing 198 is located inside the upper support 107a. The controller 180 is supported by the hinge 108 at the rear end of the upper support 107a such that the controller 180 may be rotated to the use position 180Y1 at the rear of the filter housing 198, and the retreat position 180Y2 in which the controller 180 does not interfere with the filter housing 198 being separated from the cleaner in the backward direction. The printed circuit board 185 (see FIGS. 14A and 14B) of the controller 180 may be electrically connected to the above-described printed circuit board 401 (see FIG. 3) by, for example, the flexible wire 404. The wire 404 may be an FPC, an FFC, a curl wire, or the like, but is not limited thereto.

When the cleaner is in use, the controller 180 is at the use position 180Y1 as illustrated by dotted lines in FIG. 15. At the use position 180Y1, the controller 180 blocks the open end of the upper support 107. The controller 180 is located at the rear of the filter housing 198 and above the handle 105. Before separating the filter housing 198 from the main body 1000, the controller 180 is rotated upward about the hinge 108 to be at the retreat position 180Y2. In this state, the filter housing 198 may be separated from the main body 1000.

The upper support 107a may be the filter housing 198. In this case, the filter housing 198 has a cylindrical shape with an open rear end. The controller 180 is supported by the hinge 108 at the rear end of the filter housing 198 to be able to be rotated to the use position 180Y1 and the retreat position 180Y2. When the controller 180 is at the use position 180Y1, the rear end of the filter housing 198 is blocked by the controller 180. When the controller 180 is at the retreat position 180Y2, the rear end of the filter housing 198 is opened, and in this state, the filter 197 may be separated from the filter housing 198 and a new filter 197 may be mounted in the filter housing 198. Of course, after washing the filter 197, the filter 197 may be mounted again in the filter housing 198.

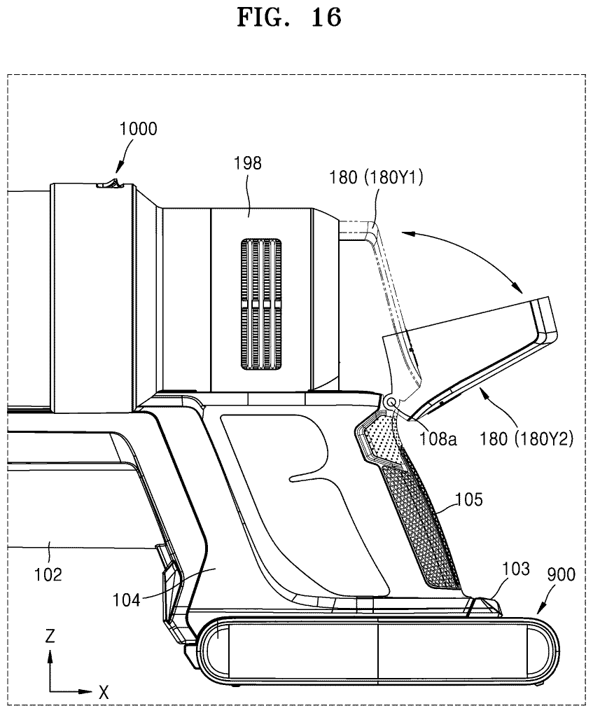

FIG. 16 is a schematic side view of a cleaner according to an embodiment of the disclosure. The cleaner according to the present embodiment of the disclosure is different from the above-described cleaner according to the embodiment of the disclosure illustrated in FIG. 14A in that the controller 180 is rotatably supported at the upper end of the handle 105. Referring to FIG. 16, the controller 180 is supported by the main body 1000, for example, by the handle 105, such that the controller 180 may be rotated to the use position 180Y1 at the rear of the filter housing 198, and the retreat position 180Y2 in which the controller 180 does not interfere with the filter housing 198 being separated from the cleaner in the backward direction. The controller 180 is rotatably supported by a hinge 108a at the upper end of the handle 105. The hinge 108a includes a shaft in the lateral direction (Y). The printed circuit board 185 (see FIGS. 14A and 14B) of the controller 180 may be electrically connected to the above-described printed circuit board 401 (see FIG. 3) by, for example, the flexible wire 404 (see FIGS. 14A and 14B).

When the cleaner is in use, the controller 180 is at the use position 180Y1 as illustrated by dotted lines in FIG. 16. At the use position 180Y1, the controller 180 is located at the rear of the filter housing 198 and above the handle 105. Before separating the filter housing 198 from the main body 1000, the controller 180 is rotated upward about the hinge 108a to be at the retreat position 180Y2. At the retreat position 180Y2, the controller 180 does not interfere with the filter housing 198 being slid backward from the main body 1000. The filter housing 198 may be separated from the main body 1000 while the controller 180 is at the retreat position 180Y2.

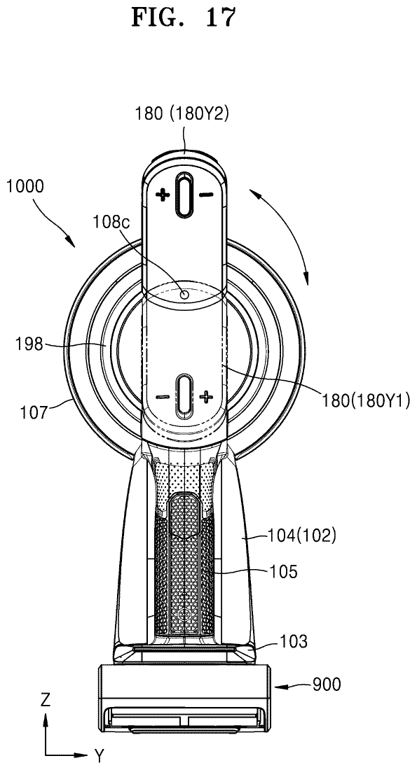

FIG. 17 is a schematic side view of a cleaner according to an embodiment of the disclosure. The cleaner according to the present embodiment of the disclosure is different from the cleaner according to the embodiment of the disclosure illustrated in FIG. 14A in that a hinge 108c including a shaft in the forward or backward direction (X) is employed. Hereinafter, differences between the two cleaners will be mainly described. Referring to FIG. 17, the controller 180 may be rotated to the use position 180Y1 at the rear of the filter housing 198, and the retreat position 180Y2 in which the controller 180 does not interfere with the filter housing 198 being separated from the cleaner in the backward direction. The controller 180 is rotatably supported by the hinge 108c at the rear end of the upper support 107. The hinge 108c includes the shaft in the forward or backward direction (X). The printed circuit board 185 of the controller 180 may be electrically connected to the above-described printed circuit board 401 (see FIG. 14B) by, for example, the flexible wire 404. Although not illustrated in the drawings, the cleaner may have a fixing structure for fixing the controller 180 to the use position 180Y1. The fixing structure may include, for example, a snap-fit fixing structure, a magnetic fixing structure, a screw fastening structure, and the like.

When the cleaner is in use, the controller 180 is at the use position 180Y1 as illustrated by dotted lines in FIG. 17. At the use position 180Y1, the controller 180 is located at the rear of the filter housing 198 and above the handle 105. Before separating the filter housing 198 from the main body 1000, the controller 180 is rotated upward about the hinge 108c to be at the retreat position 180Y2. At the retreat position 180Y2, the controller 180 does not interfere with the filter housing 198 being slid backward from the main body 1000. The filter housing 198 may be separated from the main body 1000 while the controller 180 is at the retreat position 180Y2.

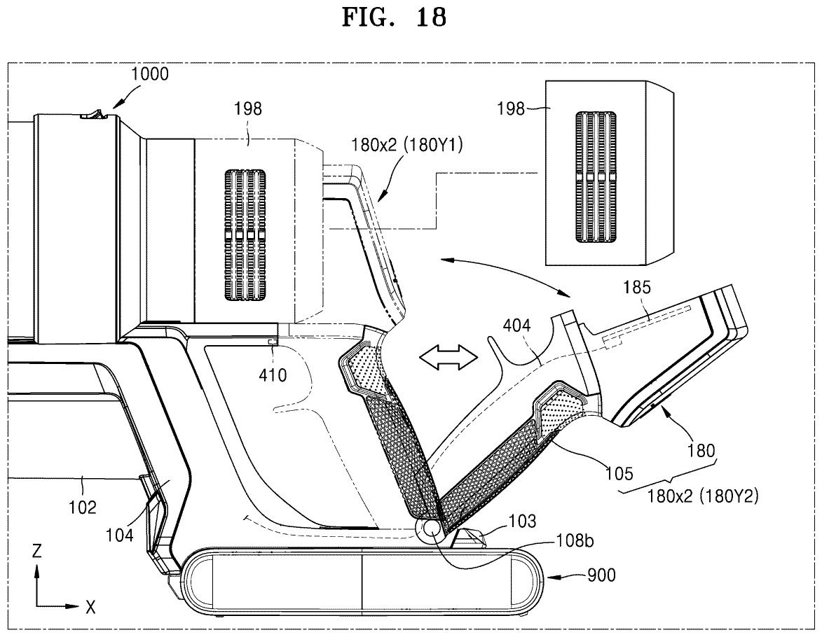

The controller 180 may be switched to the use position 180Y1 and the retreat position 180Y2 integrally with the handle 105. FIG. 18 is a schematic side view of a cleaner according to an embodiment of the disclosure. Referring to FIG. 18, the handle 105 and the controller 180 integrally form the controller assembly 180X2. The controller assembly 180X2 is supported by the main body 1000 such that the controller 180 may be rotated to the use position 180Y1 at the rear of the filter housing 198, and the retreat position 180Y2 in which the controller 180 does not interfere with the filter housing 198 being separated from the cleaner in the backward direction. For example, the lower end of the handle 105 is rotatably supported by a hinge 108b at the battery mount 103. The hinge 108b includes a shaft in the lateral direction (Y). The printed circuit board 185 of the controller 180 may be electrically connected to the above-described printed circuit board 401 (see FIG. 3) by, for example, the flexible wire 404, via the hinge 108b. According to an embodiment of the disclosure, the wire 404 may be an FPC, an FFC, a curl wire, or the like, but is not limited thereto.

When the cleaner is in use, the controller assembly 180X2 is at the use position 180Y1 as illustrated by dotted lines in FIG. 18. At the use position 180Y1, the controller 180 is located at the rear of the filter housing 198 and above the handle 105. Before separating the filter housing 198 from the main body 1000, the controller assembly 180X2 is rotated about the hinge 108b to be at the retreat position 180Y2. At the retreat position 180Y2, the controller 180 does not interfere with the filter housing 198 being slid backward from the main body 1000. The filter housing 198 may be separated from the main body 1000 while the controller 180 is at the retreat position 180Y2.

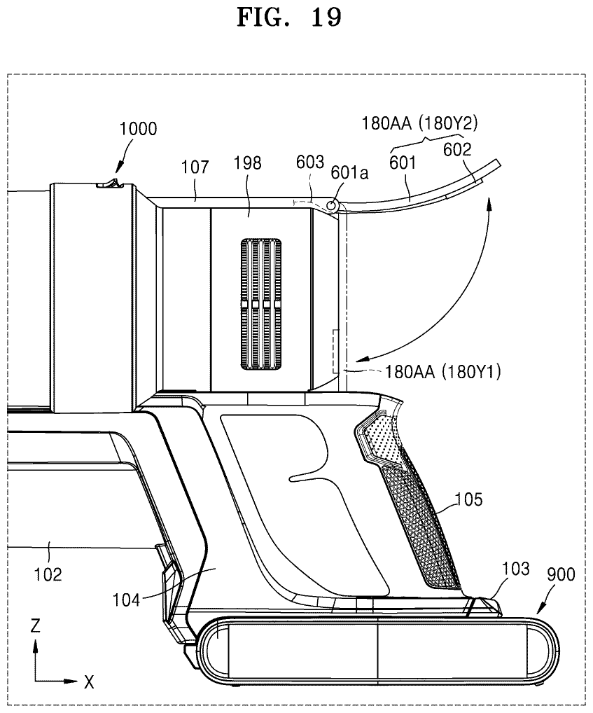

To enable the backward separation of the filter housing 198, the controller 180 may have a flexible structure to be able to be bent from the use position to the retreat position. FIG. 19 is a schematic side view of a cleaner according to an embodiment of the disclosure. The cleaner according to the present embodiment of the disclosure is different from the cleaner according to the embodiment of the disclosure illustrated in FIG. 14A in that a flexible controller 180AA is employed. Hereinafter, differences between the two cleaners will be mainly described. Referring to FIG. 19, the controller 180AA may include a flexible window 601 and a flexible display 602 supported by the window 601. The flexible display 602 may be, for example, a touch panel display in which the manipulation unit 181 (see FIG. 1) and the indication unit 182 (see FIG. 1) are integrated. The window 601 may be formed of a light-transmitting material. A flexible circuit board 603 may be provided along an inner surface of the window 601. The display 602 may be arranged on the inner surface of the window 601. The flexible circuit board 603 may be connected to the display 602. One end 601a of the window 601 is fixed to the rear end of the upper support 107. The flexible circuit board 603 extends into the main body 1000 through the upper support 107, and may be connected to the above-described printed circuit board 401.

When the cleaner is in use, the controller 180AA is at the use position 180Y1 as illustrated by dotted lines in FIG. 19. At the use position 180Y1, the controller 180AA is located at the rear of the filter housing 198 and above the handle 105. Before separating the filter housing 198 from the main body 1000, the controller 180AA is rotated to the retreat position 180Y2. Because the window 601 is flexible, the window 601 may be bent by using the vicinity of the end 601a as a hinge. Accordingly, the controller 180AA may be at the retreat position 180Y2 as illustrated by solid lines in FIG. 19. The filter housing 198 may be separated from the main body 1000 in a state in which the controller 180AA is at the retreat position 180Y2.

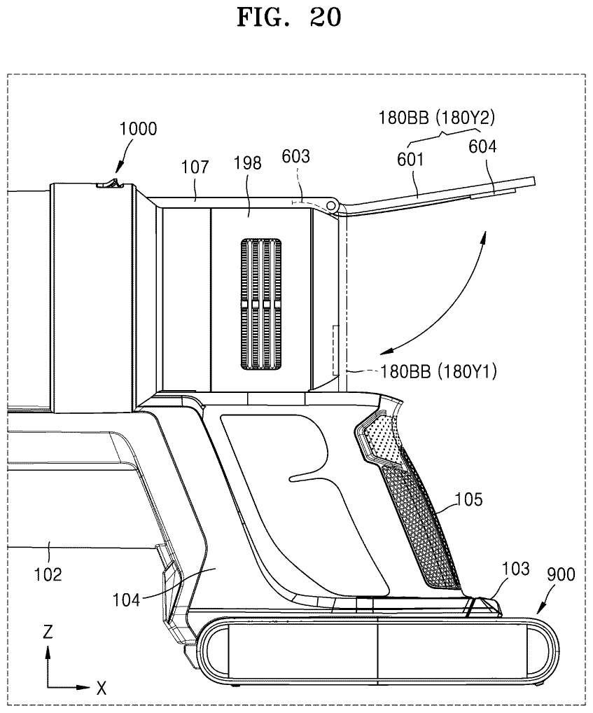

FIG. 20 is a schematic side view of a cleaner according to an embodiment of the disclosure. The cleaner according to the present embodiment of the disclosure is different from the cleaner according to the embodiment of the disclosure illustrated in FIG. 19 in that an inflexible display 604 is employed. Hereinafter, differences between the two cleaners will be mainly described. Referring to FIG. 20, a controller 180BB may include the flexible window 601 having light-transmissive properties and the display 604 supported by the window 601. The display 604 is inflexible due to its rigidity. The display 604 may be, for example, a touch panel display in which the manipulation unit 181 (see FIG. 1) and the indication unit 182 (see FIG. 1) are integrated. The flexible circuit board 603 may be provided along an inner surface of the window 601. The display 604 may be arranged on the inner surface of the window 601. The flexible circuit board 603 may be connected to the display 604. One end 601a of the window 601 is fixed to the rear end of the upper support 107. The flexible circuit board 603 extends into the main body 1000 through the upper support 107, and may be connected to the above-described printed circuit board 401.

When the cleaner is in use, the controller 180BB is at the use position 180Y1 as illustrated by dotted lines in FIG. 20. At the use position 180Y1, the controller 180BB is located at the rear of the filter housing 198 and above the handle 105. Before separating the filter housing 198 from the main body 1000, the controller 180BB is rotated to the retreat position 180Y2. Because the window 601 is flexible, the window 601 may be bent by using the vicinity of the end 601a as a hinge. Accordingly, the controller 180BB may be at the retreat position 180Y2 as illustrated by solid lines in FIG. 20. The filter housing 198 may be separated from the main body 1000 in a state in which the controller 180BB is at the retreat position 180Y2.

In the above-described embodiment of the disclosure, the controller 180 and the main body 1000 are communicatively connected to each other by a wired connection structure. The controller 180 and the main body 1000 may be communicatively connected to each other through a wireless connection structure. For example, the controller 180 and the main body 1000 may be connected to each other through a short-range wireless network. The short-range wireless network may include, for example, Bluetooth™ (Institute of Electrical and Electronics Engineers (IEEE) 802.15.1), Zigbee (IEEE 802.15.4), Wi-Fi Direct, near-field communication (NFC), Z-Wave), and the like, but is not limited thereto. Each of the controller 180 and the main body 1000 may include a communication module capable of wireless communication.

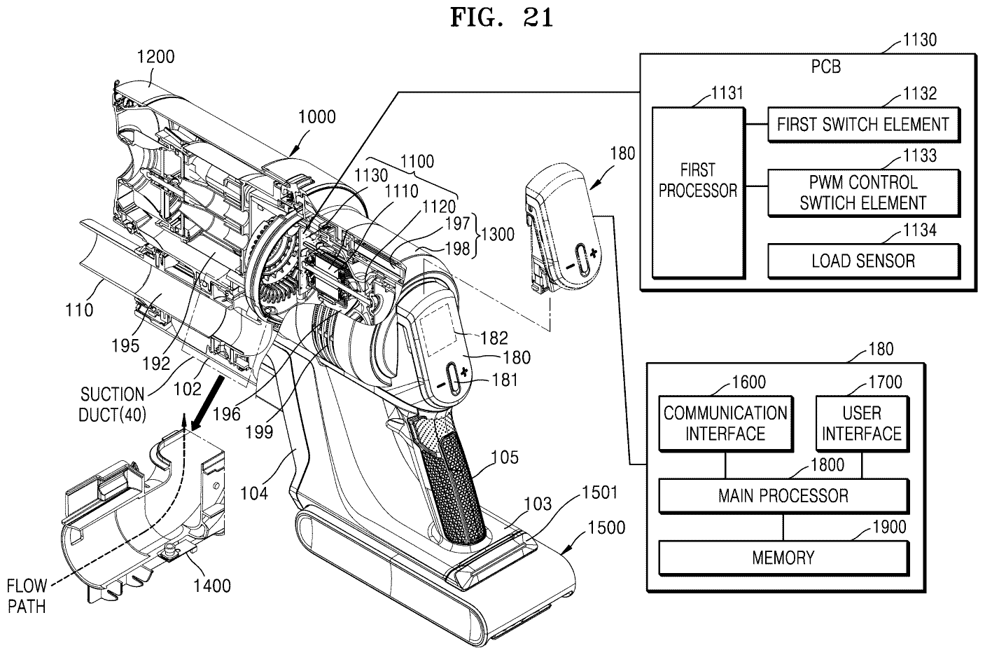

FIG. 21 is a block diagram for describing a function of the cleaner main body 1000 according to an embodiment of the disclosure.

Referring to FIG. 21, the cleaner main body 1000 may include a suction force generating device (hereinafter, referred to as a motor assembly 1100) configured to generate a suction force necessary to suck in foreign substances on a surface to be cleaned, a dust collection container 1200 (also referred to as a dust container) for accommodating foreign substances sucked in from the surface to be cleaned, a filter unit 1300, a pressure sensor 1400, a battery module 1500 capable of supplying power to the motor assembly 1100, a communication interface 1600, a user interface 1700, at least one processor (e.g., a main processor 1800), and a memory 1900. However, all of the components illustrated in FIG. 21 are not essential components. The cleaner main body 1000 may be implemented by more or fewer components than those illustrated in FIG. 21. For example, the cleaner main body 1000 may further include a motion sensor (not shown).

The motor assembly 1100 of FIG. 21 may correspond to the suction fan 191 of FIG. 1, a suction motor 1110 of FIG. 21 may correspond to the suction motor 191a of FIG. 1, and an impeller 1120 of FIG. 21 may correspond to the impeller 191b of FIG. 1. In addition, the dust collection container 1200 of FIG. 21 may correspond to the dust collection container 193 of FIG. 1, the filter unit 1300 of FIG. 21 may correspond to the filter 197 and the filter housing 198 of FIG. 1, the battery module 1500 of FIG. 21 may correspond to the battery 900 of FIG. 1, and the control module 180 of FIG. 21 may correspond to the controller 180 of FIG. 1.

Hereinafter, each component will be described.

The motor assembly 1100 may include the suction motor 1110 configured to convert an electric force into a mechanical rotational force, the impeller 1120 that is connected to and rotates with the suction motor 1110, and a printed circuit board (PCB) 1130 connected to the suction motor 1110. The suction motor 1110 and the impeller 1120 that is connected to and rotates with the suction motor 1110 may generate a vacuum inside the cleaner. Here, the vacuum refers to a state in which the pressure is lower than the atmospheric pressure. The suction motor 1110 may include a brushless motor (hereinafter, referred to as a brushless direct current (BLDC) motor), but is not limited thereto.

The PCB 1130 may include, but is not limited to, a processor (hereinafter, referred to as a first processor 1131) configured to control the suction motor 1110 and control communication with a brush device (not shown), a first switch element 1132 connected to a signal line, a switch element 1133 (hereinafter, referred to as a pulse-width modulation (PWM) control switch element) used to supply power to the brush device, and a load sensor 1134 configured to detect a load on the brush device. The PWM control switch element 1133 may include a field-effect transistor (FET), a bipolar junction transistor (BJT), an insulated-gate bipolar transistor (IGBT), and the like. The load sensor 1134 may include a shunt resistor, a shunt resistor and an amplification circuit (OP-AMP), a current sensor, a magnetic field sensor (non-contact type), and the like. Hereinafter, for convenience of description, a FET will be described as an example of the PWM control switch element 1133, and a shunt resistor will be described as an example of the load sensor 1134.

The motor assembly 1100 may have a reverse motor structure in which the positions of the impeller 1120 and the PCB 1130 are reversed. In the reverse motor structure, the PCB 1130 may be located at a lower level than the suction motor 1110 and the impeller 1120 may be located at an upper level than the suction motor 1110, with respect to the air flow direction. Accordingly, the impeller 1120 may be closer to the filter unit 1300 than the PCB 1130.

The first processor 1131 may obtain data related to a state of the suction motor 1110 (hereinafter, referred to as state data) and transmit the state data of the suction motor 1110 to the main processor 1800. In addition, the first processor 1131 may control an operation of the first switch element 1132 (e.g., turning the first switch element 1132 on or off) connected to the signal line, to transmit a signal (hereinafter, referred to as a first signal) to the brush device through the signal line. The first switch element 1132 is an element capable of causing the state of the signal line to be ‘Low’. For example, the first switch element 1132 is an element capable of causing the voltage of the signal line to be 0 V. The first signal may include data representing at least one of a target number of revolutions per minute (RPM) (hereinafter, also referred to as a target drum RPM) of a rotating brush of a brush device 2000, a target trip level of the brush device, or the power consumption of the suction motor 1110, but is not limited thereto. For example, the first signal may include data for controlling a lighting device included in the brush device. The first signal may be implemented with a preset number of bits. For example, the first signal may be implemented with 5 bits or 8 bits, and may have a transmission period of 10 ms per bit, but is not limited thereto.

The first processor 1131 may detect a signal (hereinafter, referred to as a second signal) transmitted from the brush device through the signal line. The second signal may include data representing a current state of the brush device 2000, but is not limited thereto. For example, the second signal may include data regarding a current operating condition (e.g., a current drum RPM, a current trip level, or a current lighting device setting value). In addition, the second signal may further include data representing the type of the brush device. The first processor 1131 may transmit data representing the current state of the brush device or data representing the type of the brush device included in the second signal to the main processor 1800.

The motor assembly 1100 may be located inside the dust collection container (dust container) 1200. The dust collection container 1200 may be configured to filter out and collect dust or dirt in air flowing thereinto through the brush device. The dust collection container 1200 may be provided to be separable from the cleaner main body 1000.

The dust collection container 1200 may collect foreign substances through a cyclone method of separating foreign substances by using a centrifugal force. The air from which the foreign substances are removed through the cyclone method may be discharged to the outside of the cleaner main body 1000, and the foreign substances may be stored in the dust collection container 1200. A multicyclone may be arranged inside the dust collection container 1200. The dust collection container 1200 may be provided to collect foreign substances in the lower side of the multicyclone. The dust collection container 1200 may include a dust container door (also referred to as a cover of the dust container 1200) to open the dust container 1200 when connected to a station. The dust collection container 1200 may include a first dust collector for primarily collecting relatively large foreign substances, and a second dust collector for collecting relatively small foreign substances by using a multicyclone. Both the first dust collector and the second dust collector may be arranged to be opened to the outside when the dust collection container door is opened.

The filter unit 1300 may filter out ultrafine dust that is not filtered out by the dust collection container 1200. The filter unit 1300 may include an outlet for allowing air that has passed through the filter 197, to be discharged to the outside of the cleaner. The filter unit 1300 may include a motor filter, a HEPA filter, and the like, but is not limited thereto.

The pressure sensor 1400 may measure the pressure inside a flow path (hereinafter, also referred to as a flow path pressure). The pressure sensor 1400 provided at a suction end (e.g., suction duct 40) may measure a change in flow rate at the corresponding position by measuring a static pressure. The pressure sensor 1400 may be an absolute pressure sensor or a relative pressure sensor. In a case in which the pressure sensor 1400 is an absolute pressure sensor, the main processor 1800 may use the pressure sensor 1400 to sense a first pressure value before operating the suction motor 1110. In addition, the main processor 1800 may sense a second pressure value after driving the suction motor 1110 at the target RPM, and use the difference between the first pressure value and the second pressure value as the pressure value inside the flow path. Here, the first pressure value may be a pressure value due to internal/external influences such as weather, altitude, condition of the cleaner, or amount of introduced dust, the second pressure value may be a pressure value due to internal/external influences such as altitude, condition of the vacuum cleaner, or amount of introduced dust, and a pressure value due to driving of the suction motor 1110, and the difference between the first pressure value and the second pressure value may be a pressure value due to driving of the suction motor 1110. Thus, by using the difference between the first pressure value and the second pressure value as the pressure value inside the flow path, internal/external influences other than those of the suction motor 1110 may be minimized.

The flow path pressure measured by the pressure sensor 1400 may be used to identify a current state of a usage environment of the brush device (e.g., the state of the surface to be cleaned (e.g., a floor, a carpet, a mat, or a corner), or a state in which the surface to be cleaned has come off the floor), and may also be used to measure a suction force that changes depending on the degree of contamination of the dust collection container 1200 or the degree of dust collection.

The pressure sensor 1400 may be located at the suction end (e.g., the suction duct 40). The suction duct 40 may be a structure that connects the dust collection container 1200 to an extension pipe 3000 or connects the dust collection container 1200 to the brush device to allow fluid containing foreign substances to move to the dust collection container 1200. The pressure sensor 1400 may be located at an end of a straight section (or an inflection point between a straight section and a curved section) of the suction duct 40, considering contamination by foreign substances/dust, but is not limited thereto. The pressure sensor 1400 may be located in a middle of the straight section of the suction duct 40. Meanwhile, in a case in which the pressure sensor 1400 is located at the suction duct 40, the pressure sensor 1400 is located in front of the suction motor 1110 configured to generate a suction force, and thus, the pressure sensor 1400 may be implemented as a negative pressure sensor.

In the disclosure, an example is described in which the pressure sensor 1400 is located at the suction duct 40, but the disclosure is not limited thereto. The pressure sensor 1400 may be located at a discharge end (e.g., inside the motor assembly 1100). In a case in which the pressure sensor 1400 is located at the discharge end, the pressure sensor 1400 is located in rear of the suction motor 1110 and thus may be implemented as a positive pressure sensor. In addition, a plurality of pressure sensors 1000 may be provided in the cleaner.

The battery module 1500 may be separably mounted on the cleaner main body 1000. The battery module 1500 may be electrically connected to a charging terminal provided in the station. The battery module 1500 may be charged by receiving power from the charging terminal. According to an embodiment of the disclosure, the battery module 1500 may include a processor (e.g., a MICOM) for controlling a voltage supplied to the cleaner main body 1000 and communicating with the main processor 1800 of the control module 180. The battery module 1500 may perform data communication with the main processor 1800 included in the control module 180. The battery module 1500 may periodically transmit information about a battery charge state, an output voltage, and the like to the main processor 1800.

The battery module 1500 may include a light-emitting diode (LED) display 1501 configured to indicate charging, discharging, a state, or the like of a battery. For example, the LED display 1501 may display red, orange, or yellow depending on the charging rate, and then display green when charging is completed.

The control module 180 is used to control the operation of the cleaner, and is separable from the cleaner main body 1000. The control module 180 may include, but is not limited to, the communication interface 1600, the user interface 1700, the main processor 1800, and the memory 1900.

The communication interface 1600 may include a module for performing communication with an external device. For example, the cleaner main body 1000 may perform communication with a station or a server device through the communication interface 1600. The communication interface 1600 may include a short-range communication unit and a long-range communication unit. The short-range wireless communication unit may include, but is not limited to, a Bluetooth communication unit, a BLE communication unit, a near-field communication (NFC) unit, a wireless local area network (WLAN) (e.g., Wi-Fi) communication unit, a Zigbee communication unit, an Infrared Data Association (IrDA) communication unit, a Wi-Fi Direct (WFD) communication unit, an ultra-wideband (UWB) communication unit, an Ant+ communication unit, and the like. The long-range communication unit may be used to enable the cleaner main body 1000 to remotely communicate with a server device. The long-range communication unit may include the Internet, a computer network (e.g., a LAN or a wide area network (WAN), and a mobile communication unit. The mobile communication unit may include, but is not limited to, a 3G module, a 4G module, a 5G module, an LTE module, a narrowband Internet-of-things (NB-IoT) module, an LTE-for-Machines (LTE-M) module, and the like. The user interface 1700 may be provided on a handle. The user interface 1700 may include an input interface (e.g., the manipulation unit 181 of FIG. 1) and an output interface (e.g., the indication unit 182 of FIG. 1). The cleaner main body 1000 may receive a user input related to the operation of the cleaner through the user interface 1700, and output information related to the operation of the cleaner. The cleaner main body 1000 may output information about an operation state, information about a state of charge of the battery, information about a docking state, information about a state of the dust container 1200, a state of a dust bag, and the like, through the user interface 1700.

The input interface may include, but is not limited to, at least one of a motion input unit, a voice input unit (e.g., a microphone), or a manipulation input unit (e.g., a power button, a suction force adjustment button). The output interface may include, but is not limited to, an LED display, a liquid-crystal display (LCD), a touch screen, a speaker, and the like.

The cleaner main body 1000 may include at least one processor. The cleaner main body 1000 may include one processor or may include a plurality of processors. For example, the cleaner main body 1000 may include the main processor 1800 connected to the user interface 1700, and a first processor 1131 connected to the suction motor 1110. The at least one processor may control the overall operation of the cleaner. For example, the at least one processor may determine the power consumption (e.g., a suction force level) of the suction motor 1110, the drum RPM of the brush device, the trip level of the brush device, and the like.

The at least one processor according to the disclosure may include at least one of a central processing unit (CPU), a graphics processing unit (GPU), an accelerated processing unit (APU), a many-integrated core (MIC) processor, a digital signal processor (DSP), or a neural processing unit (NPU). The at least one processor may be implemented in the form of an integrated system on a chip (SoC) including one or more electronic components. Each of the at least one processor may be implemented as separate hardware (H/W). The at least one processor may be referred to as a MICOM (micro-computer, microprocessor computer, or microprocessor controller), a microprocessor unit (MPU), or a microcontroller unit (MCU).

At least one processor according to the disclosure may be implemented as a single-core processor or a multi-core processor.

The memory 1900 may store a program for the at least one processor to perform processing and control, and may also store input/output data. For example, the memory 1900 may store a pre-trained artificial intelligence (AI) model (e.g., a support vector machine (SVM) algorithm), state data of the suction motor 1110, a measurement of the pressure sensor 1400, state data of the battery module 1500, state data of the brush device, error occurrence data (e.g., failure history data), a power consumption of the suction motor 1110 corresponding to an operating condition, RPM of a drum to which a rotating brush is attached, a trip level, an operation sequence of the suction motor 1110 corresponding to a suction force generation pattern, a type of brush device corresponding to a voltage value input through a signal line, a PWM frequency for each type of brush device, an average input voltage for each type of brush device, and a high-load reference value (or a low-load reference value) for each type of brush device, information about predefined motion patterns (e.g., user gestures) corresponding to a plurality of control commands, a reference of a battery supply voltage for determining separation of the control module 180, and the like. The information about the predefined motion patterns (e.g., user gestures) corresponding to the plurality of control commands may be stored in advance in the memory 1900 when the cleaner is released. Alternatively, the cleaner may receive, from the server device, the information about the predefined motion patterns (e.g., user gestures) corresponding to the plurality of control commands, and store the information in the memory 1900.

The memory 1900 may include an external memory and an internal memory. The memory 1900 may include at least one of a flash memory-type storage medium, a hard disk-type storage medium, a multimedia card micro-type storage medium, a card-type memory (e.g., SD or XD memory), random-access memory (RAM), static RAM (SRAM), read-only memory (ROM), electrically erasable programmable ROM (EEPROM), programmable ROM (PROM), magnetic memory, a magnetic disk, or an optical disc. Programs stored in the memory 1900 may be classified into a plurality of modules according to their functions.

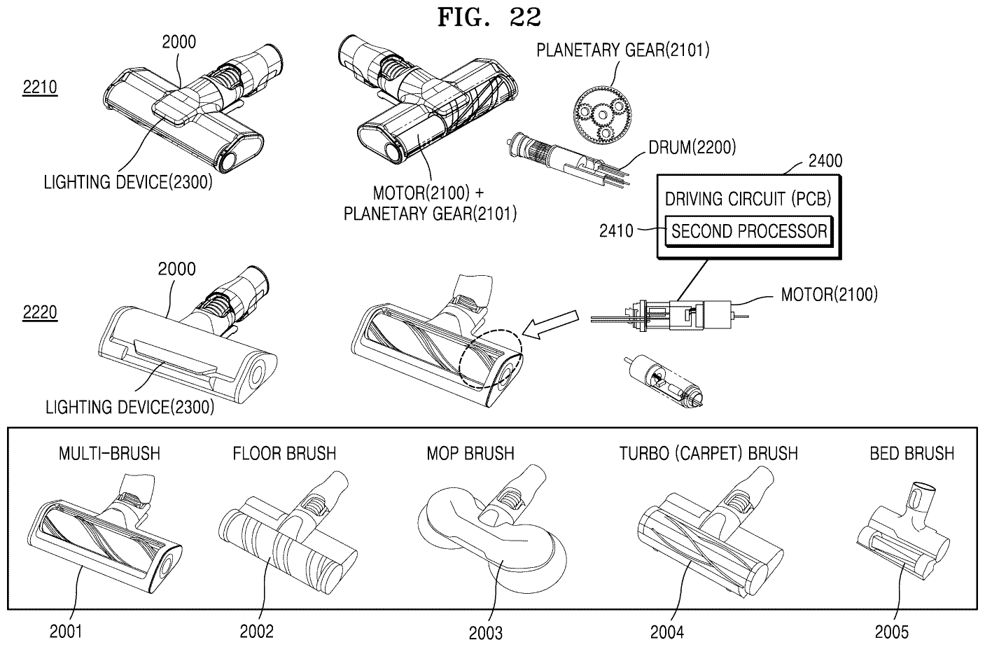

Hereinafter, a brush device that may be coupled to the cleaner main body 1000 will be described with reference to FIG. 22.

FIG. 22 is a diagram for describing the brush device 2000 according to an embodiment of the disclosure.

The brush device 2000 is a device to be brought into close contact with a surface to be cleaned and suck in air and foreign substances from the surface to be cleaned. The brush device 2000 may also be referred to as a cleaner head or suction nozzle. The brush device 2000 may be rotatably coupled to an extension pipe.

Referring to FIG. 22, the brush device 2000 may include a motor 2100, a drum 2200 having a rotating brush attached thereto, a lighting device 2300, and the like, but is not limited thereto. The motor 2100 of the brush device 2000 may be provided inside the drum 2200 or may be provided outside the drum 2200. In a case in which the motor 2100 is provided outside the drum 2200, the drum 2200 may receive power from the motor 2100 through a belt.

Referring to 2210 of FIG. 22, the motor 2100 may be a planetary geared motor. The planetary geared motor may be a combination of a direct-current (DC) motor and a planetary gear 2101. The planetary gear 2101 is used to adjust the RPM of the drum 2200 according to the gear ratio. For the planetary geared motor, the RPM of the motor 2100 and the RPM of the drum 2200 may have a constant ratio. Referring to 2220 of FIG. 22, the motor 2100 may be a BLDC motor, but is not limited thereto. In a case in which the motor 2100 is a BLDC motor, the RPM of the motor 2100 and the RPM of the drum 2200 may be equal to each other.

The lighting device 2300 is used to illuminate a dark surface to be cleaned, to facilitate identification of dust or a foreign substance on a surface to be cleaned, or to indicate a state of the brush device 2000, and may be provided on the front surface or the upper end of the brush device 2000. The lighting device 2300 may include, but is not limited to, an LED display. For example, the lighting device 2300 may be a laser. The lighting device 2300 may operate automatically as the motor 2100 is driven, or may operate under control of a second processor 2410. According to an embodiment of the disclosure, the lighting device 2300 may change its color or brightness under control of the second processor 2410.

Referring to 2220 of FIG. 22, the brush device 2000 may further include a PCB 2400. The PCB 2400 may include a circuit for communication with the cleaner main body 1000 through a signal line. For example, the PCB 2400 may include, but is not limited to, the second processor 2410, a switch element (hereinafter, also referred to as a second switch element) (not shown) connected to the signal line, an identification resistor (not shown) indicating the type of the brush device 2000, and the like.

Meanwhile, various types of brush devices 2000 may be provided. For example, the brush device 2000 may include, but is not limited to, a multi-brush 2001, a floor brush 2002, a mop brush 2003, a turbo (carpet) brush 2004, a bed brush 2005, a bristle brush (not shown), a gap brush (not shown), a pet brush (not shown) and the like.

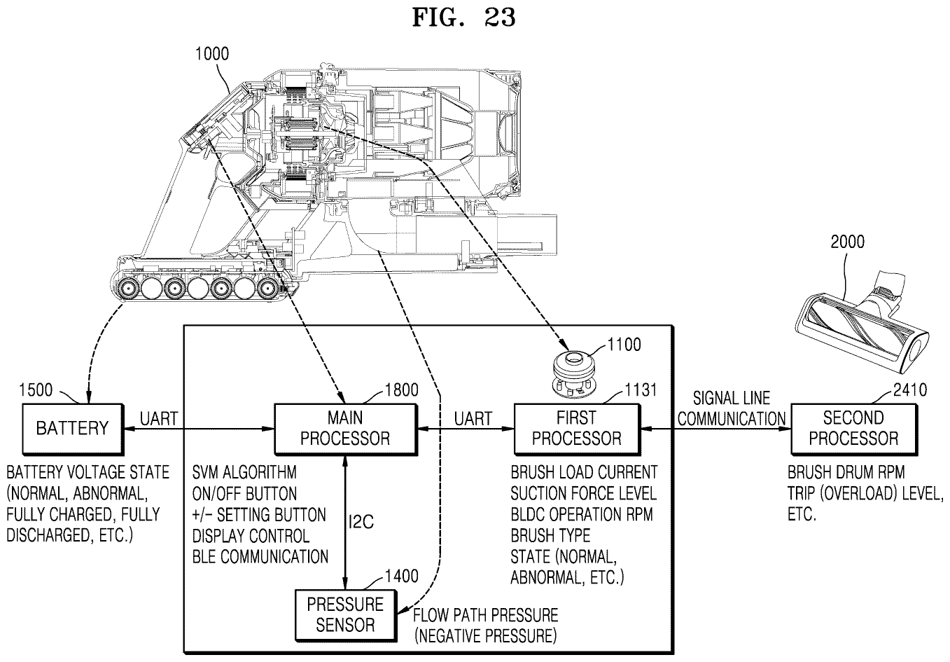

Hereinafter, operations of processors of a cleaner will be described in detail with reference to FIG. 23.

FIG. 23 is a diagram for describing operations of processors of a cleaner, according to an embodiment of the disclosure.

Referring to FIG. 23, the main processor 1800 of the control module 180 may identify states of parts within the cleaner by communicating with the battery module 1500, the pressure sensor 1400, a motion sensor (not shown) (e.g., a gyro sensor or an acceleration sensor), and the first processor 1131 within the motor assembly 1100. Here, the main processor 1800 may periodically communicate with each part by using UART communication or I2C communication, but is not limited thereto. For example, the main processor 1800 may obtain data regarding a voltage state of the battery (e.g., ‘normal’, ‘abnormal’, ‘fully charged’, or ‘fully discharged’) from the battery module 1500 by using UART. The main processor 1800 may obtain data regarding a flow path pressure from the pressure sensor 1400 by using I2C communication. The main processor 1800 may obtain angular velocity data from a gyro sensor (not shown) through UART communication, and may also obtain acceleration data from an acceleration sensor (not shown) through I2C communication. The main processor 1800 may determine whether the control module 180 is separated from the cleaner main body 1000, according to whether a communication connection with each part is interrupted. For example, when a communication connection with the battery module 1500 is interrupted for more than a preset time period, the main processor 1800 may identify that the control module 180 has been separated from the cleaner main body 1000.

In addition, the main processor 1800 may obtain data regarding a suction force level, the RPM of the suction motor 1110, and a state of the suction motor 1110 (e.g., ‘normal’ or ‘abnormal), from the first processor 1131 connected to the suction motor 1110, by using UART communication. The suction force refers to an electric force consumed to operate a cordless cleaner 100, and may be referred to as power consumption. The main processor 1800 may obtain data related to the load of the brush device 2000 and data related to the type of the brush device 2000, from the first processor 1131.

In addition, the first processor 1131 may obtain state data of the brush device 2000 (e.g., a drum RPM, a trip level, ‘normal’, or ‘abnormal’) from the brush device 2000 through signal line communication with the second processor 2410 of the brush device 2000. Here, the first processor 1131 may transmit the state data of the brush device 2000 to the main processor 1800 through UART communication. According to an embodiment of the disclosure, the first processor 1131 may transmit state data of the suction motor 1110 and state data of the brush device 2000 to the main processor 1800 at different cycles. For example, the first processor 1131 may transmit the state data of the suction motor 1110 to the main processor 1800 every 0.02 seconds, and transmit the state data of the brush device 2000 to the main processor 1800 every 0.2 seconds, but is not limited thereto.

The main processor 1800 may determine whether an error has occurred based on states of parts within the cordless cleaner 100, a state of the suction motor 1110, and a state of the brush device 2000, and periodically transmit data related to an error occurrence to a station device through short-range wireless communication (e.g., BLE communication).

When the first processor 1131 of the cleaner main body 1000 and the second processor 2410 of the brush device 2000 are connected to each other through UART communication or I2C communication, there may be issues including high-impedance effects due to internal lines of an extension tube or the like, damage to circuit elements due to electrostatic discharge (ESD) and/or an overvoltage (e.g., exceeding a maximum voltage of a MICOM AD port), and the like. Thus, according to an embodiment of the disclosure, the first processor 1131 of the cleaner main body 1000 and the second processor 2410 of the brush device 2000 may communicate with each other through signal line communication instead of UART communication or I2C communication. Here, a circuit for signal line communication may include a voltage divider circuit (hereinafter, also referred to as a voltage divider) for preventing damage to circuit elements due to an overvoltage, power noise, a surge, ESD, or electrical overstress (ESO). However, communication between the first processor 1131 of the cleaner main body 1000 and the second processor 2410 of the brush device 2000 is not limited to the signal line communication.

According to an embodiment of the disclosure, in a case in which a noise reduction circuit is applied to the cleaner main body 1000 and the brush device 2000, the first processor 1131 of the cleaner main body 1000 and the second processor 2410 of the brush device 2000 may communicate with each other by using UART communication or I2C communication. The noise reduction circuit may include at least one of a low-pass filter, a high-pass filter, a band-pass filter, a damping resistor, or a divider resistor, but is not limited thereto. According to an embodiment of the disclosure, in a case in which a level shifter circuit is applied to the cleaner main body 1000 or the brush device 2000, the first processor 1131 of the cleaner main body 1000 and the second processor 2410 of the brush device 2000 may communicate with each other by using UART communication or I2C communication. Hereinafter, for convenience of description, an example will be mainly described in which the cleaner main body 1000 and the brush device 2000 communicate with each other through signal line communication.

Meanwhile, the main processor 1800 may receive a user input to a setting button (e.g., an ON/OFF button, a +/−setting button) included in the user interface 1700, and may control output of the LCD. The main processor 1800 may use a pre-trained AI model (e.g., an SVM algorithm) to identify a usage environment state of the brush device 2000 (e.g., the state of a surface to be cleaned (e.g., a floor, a carpet, a mat, or a corner) or a state in which the surface to be cleaned has come off the floor), and determine operation information of the cordless cleaner 100 that matches the usage environment state of the brush device 2000 (e.g., the power consumption of the suction motor 1110, a drum RPM, or a trip level). Here, the main processor 1800 may transmit the operation information of the cordless cleaner 100 that matches the usage environment state of the brush device 2000, to the first processor 1131. The first processor 1131 may adjust the suction force level (the power consumption or RPM) of the suction motor 1110 according to the operation information of the cordless cleaner 100, and transmit the operation information of the cordless cleaner 100 that matches the usage environment state of the brush device 2000, to the second processor 2410 through signal line communication. In this case, the second processor 2410 may adjust the drum RPM, the trip level, the lighting device (e.g., an LED display), and the like according to the operation information of the cordless cleaner 100.

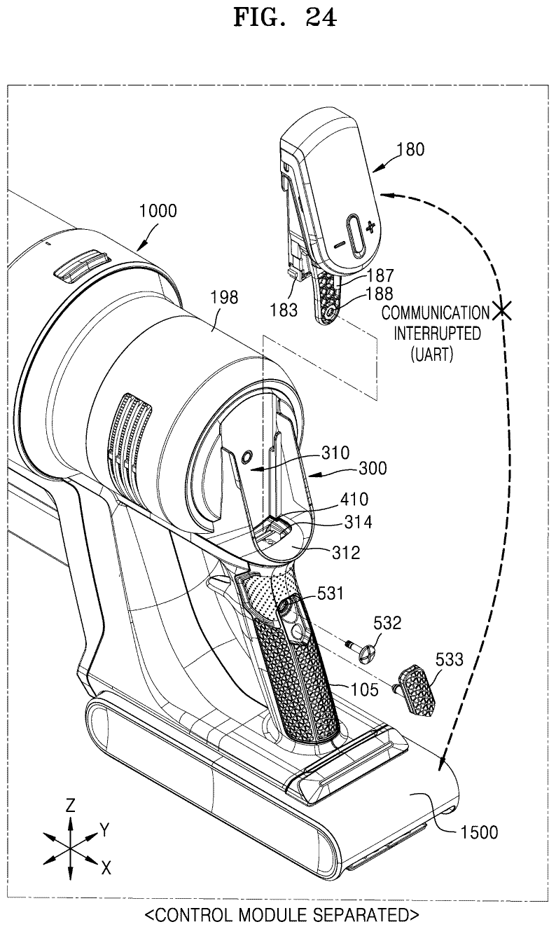

Meanwhile, when the communication connection with the battery module 1500 or the first processor 1131 of the motor assembly 1100 is interrupted, the main processor 1800 may determine that the control module 180 has been separated from the cleaner main body 1000. On the other hand, when the communication connection with the main processor 1800 is interrupted, the motor assembly 1100 or the first processor 1131 of the battery module 1500 may determine that the control module 180 has been separated from the cleaner main body 1000. In addition, each of the main processor 1800, the battery module 1500, and the motor assembly 1100 may operate in a safe mode (a protection mode) for safety. Hereinafter, a method, performed by each of the main processor 1800, the battery module 1500, and the motor assembly 1100, of identifying whether the control module 180 is separated, and operating in a safe mode will be described in detail with reference to FIGS. 24 to 27.

FIG. 24 is a diagram for describing a communication operation between the battery module 1500 and the control module 180, according to an embodiment of the disclosure. FIG. 24 illustrates an example in which the control module 180 has a screw fastening structure, but the disclosure is not limited thereto.

Referring to FIG. 24, when the control module 180 is mounted on the cleaner main body 1000, the control module 180 may communicate with the battery module 1500 coupled to the cleaner main body 1000. For example, the main processor 1800 of the control module 180 may periodically perform UART communication with a processor of the battery module 1500. The main processor 1800 of the control module 180 and the processor of the battery module 1500 may transmit and receive data to and from each other every 20 ms, but are not limited thereto.

According to an embodiment of the disclosure, the main processor 1800 of the control module 180 may receive data including a state of the battery (e.g., ‘charging’ or ‘charging completed’), a state of charge of the battery (e.g., 50%), a supply voltage of the battery (e.g. 25 V), and the like from the battery module 1500. The control module 180 may transmit a response signal to the battery module 1500.

Referring to FIG. 24, the control module 180 may be separated from the cleaner main body 1000. For example, the user may separate the cover 533 from the handle 105, loosen the screw 532, and then slide the controller 180 upward to separate it from the socket 300. Alternatively, the control module 180 may be separated from the cleaner main body 1000 due to physical impact. When the control module 180 is separated from the cleaner main body 1000, the control module 180 and the battery module 1500 connected to the cleaner main body 1000 cannot perform UART communication with each other. Thus, when the communication connection between the control module 180 and the battery module 1500 is interrupted for more than a preset time period, each of the control module 180 and the battery module 1500 may identify that the controller 180 has been separated from the cleaner main body 1000.

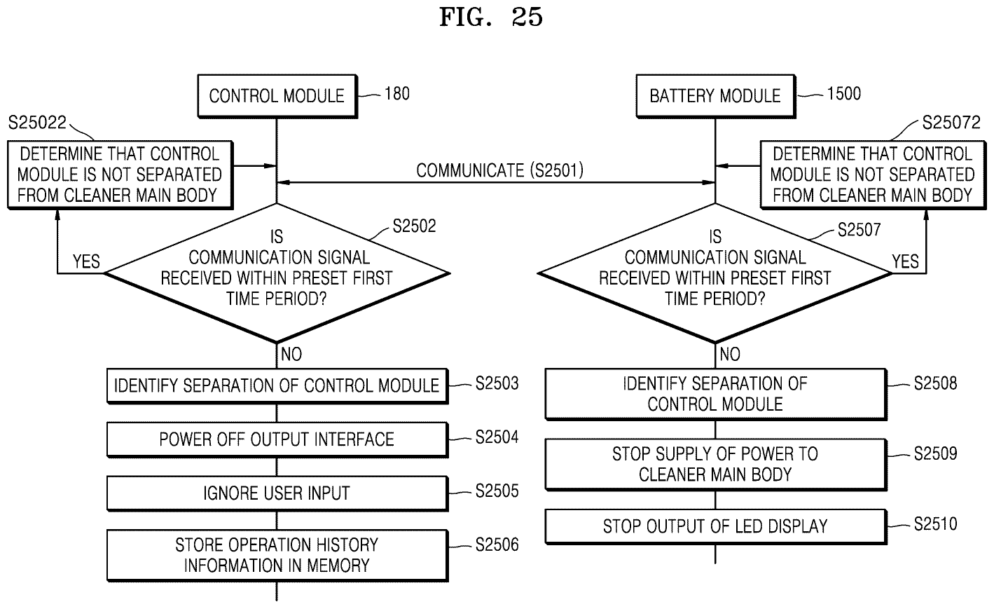

When the cleaner continues to operate even though the control module 180 is separated from the cleaner main body 1000, a safety issue may arise. Thus, each of the control module 180 and the battery module 1500 may operate in a safe mode when the control module 180 is separated from the cleaner main body 1000. A method, performed by the control module 180 and the battery module 1500, of operating in a safe mode will be described in detail with reference to FIG. 25.

FIG. 25 is a flowchart for describing a method, performed by each of the battery module 1500 and the control module 180, of operating in a safe mode, according to an embodiment of the disclosure.

In operation S2501, the control module 180 and the battery module 1500 according to an embodiment of the disclosure may periodically perform communication with each other. For example, when the control module 180 is stably mounted on the cleaner main body 1000, the control module 180 may transmit and receive data to and from the battery module 1500 coupled to the cleaner main body 1000, through UART communication.

In operation S2502, the control module 180 according to an embodiment of the disclosure may determine whether a communication signal is received from the battery module 1500 within a preset first time period.

The preset first time period may be for determining separation of the control module 180 from the cleaner main body 1000. The first time period may be preset considering a communication cycle between the control module 180 and the battery module 1500. For example, when the control module 180 and the battery module 1500 communicate with each other at a cycle of 20 ms, the preset first time period may be 2 seconds, but is not limited thereto.

When the cleaner hits a wall or the like during cleaning due to its nature, communication between the control module 180 and the battery module 1500 may be temporarily interrupted even when the control module 180 is not separated from the cleaner main body 1000. Thus, when the control module 180 receives a communication signal from the battery module 1500 again within the preset first time period (i.e., ‘Yes’ in S2502), the control module 180 may determine that the control module 180 is not separated from the cleaner main body 1000 in operation S25022. Then, the control module 180 may continue to communicate with the battery module 1500.

In operation S2503, when the control module 180 according to an embodiment of the disclosure does not receive a communication signal from the battery module 1500 for the preset first time period or longer (i.e., ‘No’ in S2502), the control module 180 may identify that the control module 180 has been separated from the cleaner main body 1000. For example, when the control module 180 does not receive a communication signal (e.g., a response signal) from the battery module 1500 for 2 seconds or longer, the control module 180 may identify that the control module 180 has been separated from the cleaner main body 1000.

In operations S2504 to S2506, based on identifying that the control module 180 has been separated from the cleaner main body 1000, the control module 180 may operate in the safe mode. Even when the control module 180 is separated from the cleaner main body 1000, the control module 180 has a voltage to use for a while, the control module 180 may switch to the safe mode and perform necessary operations.

In operation S2504, the control module 180 according to an embodiment of the disclosure may power off an output interface (e.g., the indication unit 182). For example, based on identifying that the control module 180 has been separated from the cleaner main body 1000, the control module 180 may immediately power off the output interface to notify the user that the control module 180 cannot be manipulated. Alternatively, the control module 180 may power off the output interface after outputting a notification message. For example, the control module 180 may output a notification message stating “The control module 180 has been separated from the cleaner main body 1000, and thus cannot be manipulated”, and then power off the output interface.

In operation S2505, based on identifying that the control module 180 according to an embodiment of the disclosure has been separated from the cleaner main body 1000, the control module 180 may ignore a user input received through an input interface (e.g., the manipulation unit 181). For example, the control module 180 may ignore an input such as pressing the power button, the +button, or the −button, without responding to it.

In operation S2506, the control module 180 according to an embodiment of the disclosure may store, in the memory 1900, operation history information corresponding to a time point of identifying that the control module 180 has been separated from the cleaner main body 1000. For example, the control module 180 may record, in the memory 1900, information about an operating mode, a usage condition, an interruption situation, and the like at the time point when the control module 180 is separated from the cleaner main body 1000.

Some of operations S2504 to S2506 may be omitted, and the order of some of operations S2504 to S2506 may be changed.

In operation S2507, the battery module 1500 according to an embodiment of the disclosure may determine whether a communication signal is received within the preset first time period. The preset first time period may be for the battery module 1500 to determine separation of the control module 180 from the cleaner main body 1000. For example, the preset first time period may be 2 seconds.

When the cleaner hits a wall or the like during cleaning due to its nature, communication between the control module 180 and the battery module 1500 may be temporarily interrupted even when the control module 180 is not separated from the cleaner main body 1000. Thus, when the battery module 1500 receives a communication signal from the control module 180 again within the preset first time period (i.e., ‘Yes’ in S2507), the battery module 1500 may determine that the control module 180 is not separated from the cleaner main body 1000 in operation 25072. Then, the battery module 1500 may continue to communicate with the control module 180. For example, the battery module 1500 may transmit data including a supply voltage of the battery, a state of charge of the battery, and the like, to the control module 180. The supply voltage of the battery is a voltage supplied from the battery module 1500 to the cleaner main body 1000, and as the state of charge of the battery decreases, the supply voltage of the battery may gradually decrease.

In operation S2508, when the battery module 1500 according to an embodiment of the disclosure does not receive a communication signal from the control module 180 for the preset first time period or longer (i.e., ‘No’ in S2507), the battery module 1500 may identify that the control module 180 has been separated from the cleaner main body 1000. For example, when the battery module 1500 does not receive a communication signal (e.g., a response signal) from the control module 180 for 2 seconds or longer, the battery module 1500 may identify that the control module 180 has been separated from the cleaner main body 1000.

In operations S2509 to S2510, based on identifying that the control module 180 has been separated from the cleaner main body 1000, the battery module 1500 may operate in the safe mode.

In operation S2509, based on identifying that the control module 180 has been separated from the cleaner main body 1000, the battery module 1500 according to an embodiment of the disclosure may stop a supply of power to the cleaner main body 1000. When the control module 180 is separated from the cleaner main body 1000 and the cleaner continues to operate, a dangerous situation may occur. Thus, the battery module 1500 may block all or part of the power supplied to the cleaner main body 1000 for safety. When the battery module 1500 stops the supply of the power to the cleaner main body 1000, operations of the suction motor 1110 and the brush device 2000 may be stopped.

In operation S2510, based on identifying that the control module 180 has been separated from the cleaner main body 1000, the battery module 1500 according to an embodiment of the disclosure may stop output of the LED display 1501 included in the battery module 1500. The battery module 1500 may stop the output of the LED display 1501 to notify that the supply of the power to the cleaner main body 1000 has been stopped.

According to an embodiment of the disclosure, each of the control module 180 and the battery module 1500 may increase the stability of the cleaner by operating in the safe mode when the control module 180 is separated from the cleaner main body 1000.

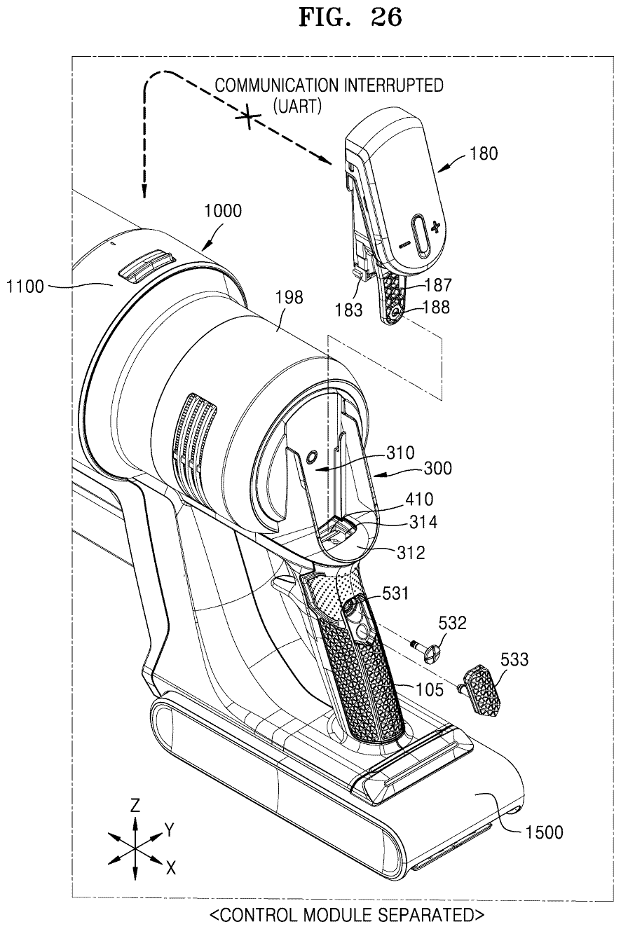

FIG. 26 is a diagram for describing a communication operation between the motor assembly 1100 and the control module 180, according to an embodiment of the disclosure. FIG. 26 illustrates an example in which the control module 180 has a screw fastening structure, but the disclosure is not limited thereto.

Referring to FIG. 26, when the control module 180 is mounted on the cleaner main body 1000, the control module 180 may communicate with the first processor 1131 of the motor assembly 1100 provided in the cleaner main body 1000. For example, the main processor 1800 of the control module 180 may periodically perform UART communication with the first processor 1131 connected to the suction motor 1110. The main processor 1800 and the first processor 1131 of the control module 180 may transmit and receive data to and from each other every 20 ms, but are not limited thereto.

According to an embodiment of the disclosure, the main processor 1800 of the control module 180 may receive data regarding the state of the suction motor 1110 and the state of the brush device 2000, from the first processor 1131 of the motor assembly 1100. In addition, the main processor 1800 of the control module 180 may transmit, to the first processor 1131, a signal for controlling the power consumption of the suction motor 1110, the RPM of the brush device 2000, and the like.

Referring to FIG. 26, the control module 180 may be separated from the cleaner main body 1000. For example, the user may separate the cover 533 from the handle 105, loosen the screw 532, and then slide the controller 180 upward to separate it from the socket 300. Alternatively, the control module 180 may be separated from the cleaner main body 1000 due to physical impact. When the control module 180 is separated from the cleaner main body 1000, the control module 180 and the motor assembly 1100 included in the cleaner main body 1000 cannot perform UART communication. Thus, when the communication connection between the control module 180 and the motor assembly 1100 is interrupted for more than a preset time period, each of the control module 180 and the motor assembly 1100 may identify that the controller 180 has been separated from the cleaner main body 1000.

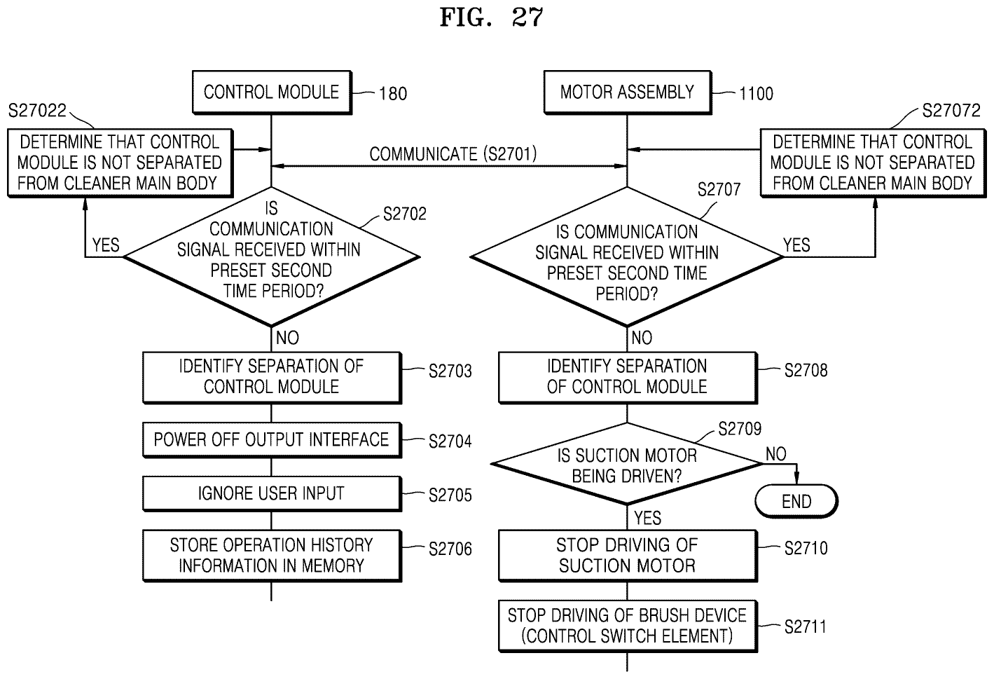

When the cleaner continues to operate even though the control module 180 is separated from the cleaner main body 1000, a safety issue may arise. Thus, each of the control module 180 and the motor assembly 1100 may operate in a safe mode when the control module 180 is separated from the cleaner main body 1000. A method, performed by the control module 180 and the motor assembly 1100, of operating in a safe mode will be described in detail with reference to FIG. 27.

FIG. 27 is a flowchart for describing a method, performed by each of the motor assembly 1100 and the control module 180, of operating in a safe mode, according to an embodiment of the disclosure.

In operation S2701, the control module 180 and the motor assembly 1100 according to an embodiment of the disclosure may periodically perform communication with each other. For example, when the control module 180 is stably mounted on the cleaner main body 1000, the control module 180 may transmit and receive data to and from the motor assembly 1100 included in the cleaner main body 1000, through UART communication.

In operation S2702, the control module 180 according to an embodiment of the disclosure may determine whether a communication signal is received within a preset second time period.

The preset second time period may be for the control module 180 and the motor assembly 1100 to determine separation of the control module 180 from the cleaner main body 1000. The second time period may be preset considering a communication cycle between the control module 180 and the motor assembly 1100. For example, when the control module 180 and the motor assembly 1100 communicate with each other at a cycle of 20 ms, the preset second time period may be 5 seconds, but is not limited thereto.

According to an embodiment of the disclosure, the second time period for the motor assembly 1100 to determine separation of the control module 180 from the cleaner main body 1000 may be equal to the first time period for the battery module 1500 to determine separation of the control module 180 from the cleaner main body 1000. For example, both the first time period and the second time period may be 2 seconds. Alternatively, the first time period and the second time period may be different from each other. For example, for safety purposes, it is efficient to cut off the battery supply power, and thus, the first time period may be shorter than the second time period such that the battery module 1500 detects separation of the control module 180 from the cleaner main body 1000 earlier than the motor assembly 1100 does. Hereinafter, an example will be described in which the first time period is 2 seconds and the second time period is 5 seconds, but the disclosure is not limited thereto.

When the cleaner hits a wall or the like during cleaning due to its nature, communication between the control module 180 and the motor assembly 1100 may be temporarily interrupted even when the control module 180 is not separated from the cleaner main body 1000. Thus, when the control module 180 receives a communication signal from the motor assembly 1100 again within the preset second time period (i.e., ‘Yes’ in S2702), the control module 180 may determine that the control module 180 is not separated from the cleaner main body 1000 in operation S27022. Then, the control module 180 may continue to communicate with the motor assembly 1100.

In operation S2703, when the control module 180 according to an embodiment of the disclosure does not receive a communication signal from the motor assembly 1100 for the preset second time period or longer (i.e., ‘No’ in S2702), the control module 180 may identify that the control module 180 has been separated from the cleaner main body 1000. For example, when the control module 180 does not receive a communication signal (e.g., a response signal) from the motor assembly 1100 for 5 seconds or longer, the control module 180 may identify that the control module 180 has been separated from the cleaner main body 1000.

In operations S2704 to S2706, based on identifying that the control module 180 has been separated from the cleaner main body 1000, the control module 180 may operate in the safe mode. For example, in operation S2704, based on identifying that the control module 180 according to an embodiment of the disclosure has been separated from the cleaner main body 1000, the control module 180 may power off an output interface (e.g., the indication unit 182). In operation S2705, based on identifying that the control module 180 according to an embodiment of the disclosure has been separated from the cleaner main body 1000, the control module 180 may ignore a user input received through an input interface (e.g., the manipulation unit 181). In operation S2706, the control module 180 according to an embodiment of the disclosure may store, in the memory 1900, operation history information (e.g., an operation mode, a usage condition, an interruption situation) corresponding to a time point identifying that the control module 180 has been separated from the cleaner main body 1000. Operations S2704 to S2706 correspond to operations S2504 to S2506 of FIG. 25, respectively, and thus, detailed descriptions thereof will be omitted.

In operation S2707, the motor assembly 1100 according to an embodiment of the disclosure may determine whether a communication signal is received within the preset second time period. The preset second time period may be for the motor assembly 1100 to determine separation of the control module 180 from the cleaner main body 1000. For example, the preset second time period may be 5 seconds.

When the cleaner hits a wall or the like during cleaning due to its nature, communication between the control module 180 and the motor assembly 1100 may be temporarily interrupted even when the control module 180 is not separated from the cleaner main body 1000. Thus, when the motor assembly 1100 receives a communication signal from the control module 180 again within the preset second time period (i.e., ‘Yes’ in S2707), the motor assembly 1100 may determine that the control module 180 is not separated from the cleaner main body 1000 in operation S27072. Then, the motor assembly 1100 may continue to communicate with the control module 180. For example, the motor assembly 1100 may transmit, to the control module 180, data including a state of the suction motor 1110 (e.g., power consumption or a suction force mode), a state of the brush device 2000 (e.g., a drum RPM or a trip level), and the like.

In operation S2708, when the motor assembly 1100 according to an embodiment of the disclosure does not receive a communication signal from the control module 180 for the preset second time period or longer (i.e., ‘No’ in S2707), the motor assembly 1100 may identify that the control module 180 has been separated from the cleaner main body 1000. For example, when the motor assembly 1100 does not receive a communication signal (e.g., a response signal) from the control module 180 for 5 seconds or longer, the motor assembly 1100 may identify that the control module 180 has been separated from the cleaner main body 1000.

In operations S2709 to S2711, based on identifying that the control module 180 has been separated from the cleaner main body 1000, the motor assembly 1100 may operate in the safe mode.

In operation S2709, based on identifying that the control module 180 has been separated from the cleaner main body 1000, the motor assembly 1100 according to an embodiment of the disclosure may determine whether the suction motor 1110 is being driven.

According to an embodiment of the disclosure, even when the battery module 1500 stops supplying power to the cleaner main body 1000, the power supplied to the suction motor 1110 may not be accurately or completely blocked due to a failure of a switch element (e.g., a FET). In this case, the suction motor 1110 may be continuously driven.

In operation S2710, when the suction motor 1110 is being driven even though the control module 180 is separated from the cleaner main body 1000 (i.e., ‘Yes’ in S2709), the motor assembly 1100 according to an embodiment of the disclosure may stop the driving of the suction motor 1110 for safety.

In operation S2711, the motor assembly 1100 according to an embodiment of the disclosure may stop driving of the brush device 2000. For example, based on identifying that the control module 180 has been separated from the cleaner main body 1000, the first processor 1131 of the motor assembly 1100 stop the driving of the brush device 2000 by controlling the switch element 1133 used to supply power to the brush device 2000 connected to the cleaner main body 1000.

The cleaner main body 1000 may include the switch element 1133 (hereinafter, also referred to as a PWM control switch element) for PWM control in order to keep the drum RPM of the brush device 2000 constant. The PWM control may refer to a control method of allowing average power per unit time to be input to the brush device 2000 by repeating a power supply section (ON section) and a power cutoff section (OFF section) at regular intervals. Here, the average power per unit time input to the brush device 2000 may vary depending on a duty value. The duty value refers to a duty cycle (or a duty ratio) of a pulse width when the cycle is constant, and in particular, may refer to a proportion of a power transmission section (hereinafter, also referred to as an on-duty section) within a single cycle. As the duty value increases, a total time period during which a current flows through the motor 2100 of the brush device 2000 increases, and thus, the average power supplied to the brush device 2000 may increase.

Based on identifying that the control module 180 has been separated from the cleaner main body 1000, the first processor 1131 of the motor assembly 1100 according to an embodiment of the disclosure may cut off power supplied from the battery module 1500 to the brush device 2000 by turning off the PWM control switch element 1133.

According to an embodiment of the disclosure, each of the control module 180 and the motor assembly 1100 may increase the stability of the cleaner by operating in the safe mode when the control module 180 is separated from the cleaner main body 1000.

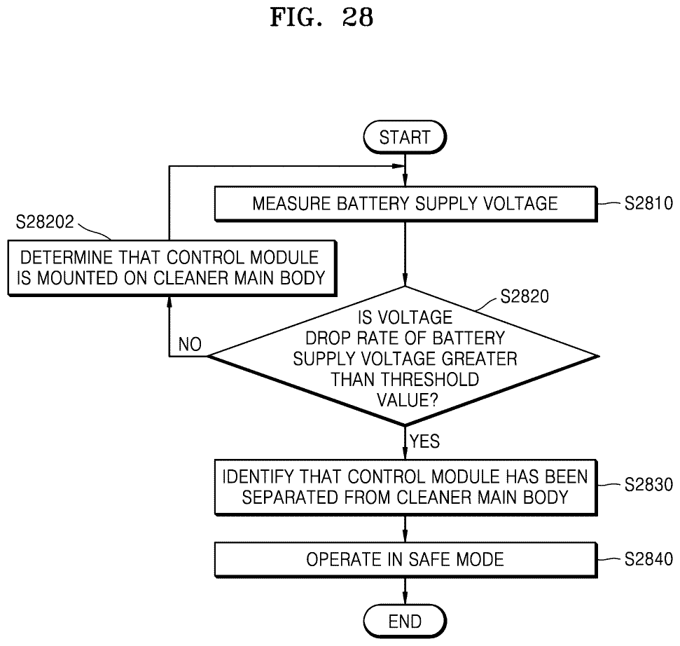

In addition, the control module 180 may also detect separation of the control module 180 from the cleaner main body 1000 based on a battery supply voltage in addition to interruption of communication with the battery module 1500 or the motor assembly 1100. Hereinafter, a method, performed by the control module 180, of determining whether the control module 180 is separated from the cleaner main body 1000, based on a battery supply voltage will be described with reference to FIG. 28.

FIG. 28 is a flowchart for describing a method of determining whether the control module 180 is separated from the cleaner main body 1000, based on a battery supply voltage, according to an embodiment of the disclosure.

In operation S2810, the control module 180 according to an embodiment of the disclosure may measure a battery supply voltage applied to the control module 180 from the battery module 1500.

For example, the main processor 1800 of the control module 180 may measure the battery supply voltage through a voltage divider circuit. The battery supply voltage input to the control module 180 may be rated at 25.2 V (30 V to 18 V), which is a voltage level that the main processor 1800 cannot directly receive. Thus, an input port of the main processor 1800 may receive a result of converting the battery supply voltage to 3.3 V (or 5 V) or less through the voltage divider circuit. The voltage divider circuit may convert the maximum value (30 V) of the battery supply voltage to 3.3 V or less, or 5 V or less. For example, in a case in which the battery supply voltage is 25.2 V and the voltage divider circuit includes a first resistor of 1.5 KΩ and a second resistor of 20 KΩ, the voltage value input to the input port of the main processor 1800 may be battery supply voltage 25.2 V*1.5 KΩ/(1.5 KΩ+20 KΩ)=1.7581. Here, the main processor 1800 may inversely convert the voltage value (e.g., 1.7581 V) input to the input port through the voltage divider circuit to confirm that the battery supply voltage is 25.2 V.

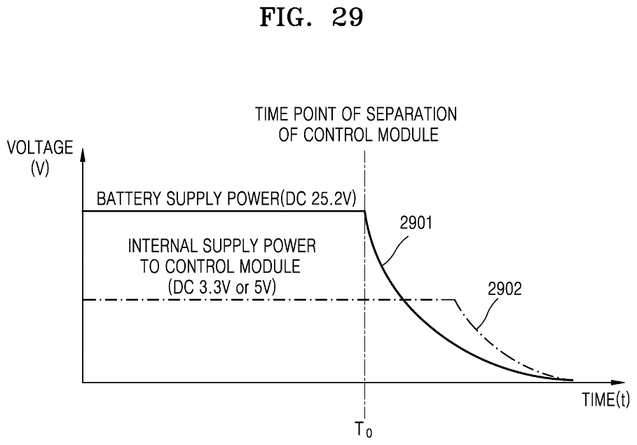

According to an embodiment of the disclosure, as the battery module 1500 is gradually discharged, the battery supply voltage measured by the main processor 1800 may gradually decrease. Meanwhile, when the control module 180 is separated from the cleaner main body 1000, the battery supply voltage may rapidly decrease. Referring to a first graph 2901 of FIG. 29, it may be seen that a battery supply voltage rapidly decreases from a time point T₀ of control module separation. In addition, referring to a second graph 2902 of FIG. 29, it may be seen that an internal supply voltage supplied to internal parts (e.g., an LCD display) of the control module 180 also rapidly decreases shortly after the time point T₀ of control module separation. Thus, the control module 180 according to an embodiment of the disclosure may determine whether the control module 180 is separated from the cleaner main body 1000, based on the measured battery supply voltage.

In operation S2820, the control module 180 according to an embodiment of the disclosure may determine whether a voltage drop rate of the battery supply voltage is greater than a threshold value. The threshold value may be about 10 V/50 ms to 10 V/10 ms, but is not limited thereto.

When the control module 180 is mounted on the cleaner main body 1000, the battery supply voltage input to the control module 180 may gradually decrease, whereas when the control module 180 is separated from the cleaner main body 1000, the battery supply voltage input to the control module 180 may rapidly decrease. Thus, that the voltage drop rate of the battery supply voltage is less than or equal to the threshold value (‘No’ in S2820) means that the control module 180 is determined to be mounted on the cleaner main body 1000 in operation S28202, and thus, the control module 180 may continuously monitor the battery supply voltage input to the control module 180. For example, when the battery supply voltage decreases to 10 V or less for 10 ms to 50 ms, the control module 180 may determine that the control module 180 is mounted on the cleaner main body 1000.

In operation S2830, when the measured voltage drop rate of the battery supply voltage is greater than the threshold value, the control module 180 according to an embodiment of the disclosure may identify that the control module 180 has been separated from the cleaner main body 1000.

For example, when the battery supply voltage decreases by more than 10 V for 10 ms to 50 ms, the control module 180 may identify that the control module 180 has been separated from the cleaner main body 1000.

In operation S2840, based on identifying that the control module 180 has been separated from the cleaner main body 1000, the control module 180 according to an embodiment of the disclosure may operate in the safe mode.

For example, based on identifying that the control module 180 has been separated from the cleaner main body 1000, the control module 180 may power off an output interface (e.g., the indication unit 182), and ignore a user input received through an input interface (e.g., the manipulation unit 181). In addition, the control module 180 may store, in the memory 1900, operation history information corresponding to a time point of identifying that the control module 180 has been separated from the cleaner main body 1000. For example, the control module 180 may record, in the memory 1900, information about an operating mode, a usage condition, an interruption situation, and the like at the time point when the control module 180 is separated from the cleaner main body 1000.

Meanwhile, an embodiment of the disclosure in which the control module 180 identifies separation of the control module 180 from the cleaner main body 1000 based on the battery supply voltage is described above with reference to FIG. 28, but the disclosure is not limited thereto. The control module 180 may also identify separation of the control module 180 from the cleaner main body 1000 based on the internal supply power (e.g., 3.3 V or less, or 5 V or less) supplied to the internal parts.

According to an embodiment of the disclosure, the control module 180 may include a DC/DC converter and/or regulator. Thus, when a battery supply voltage is applied to the DC/DC converter, the DC/DC converter outputs a voltage of 5 V or less, and the voltage output from the DC/DC converter may be input to the regulator. Here, the regulator may output a voltage of 3.3 V or less. The voltage output from the regulator may be supplied to the internal parts of the control module 180.

When the control module 180 is separated from the cleaner main body 1000, the output voltage of the DC/DC converter or the output voltage of the regulator also decreases rapidly (see 2902 of FIG. 29), and thus, the main processor 1800 of the control module 180 may determine whether the control module 180 is separated from the cleaner main body 1000, by monitoring the output voltage of the DC/DC converter or the output voltage of the regulator.

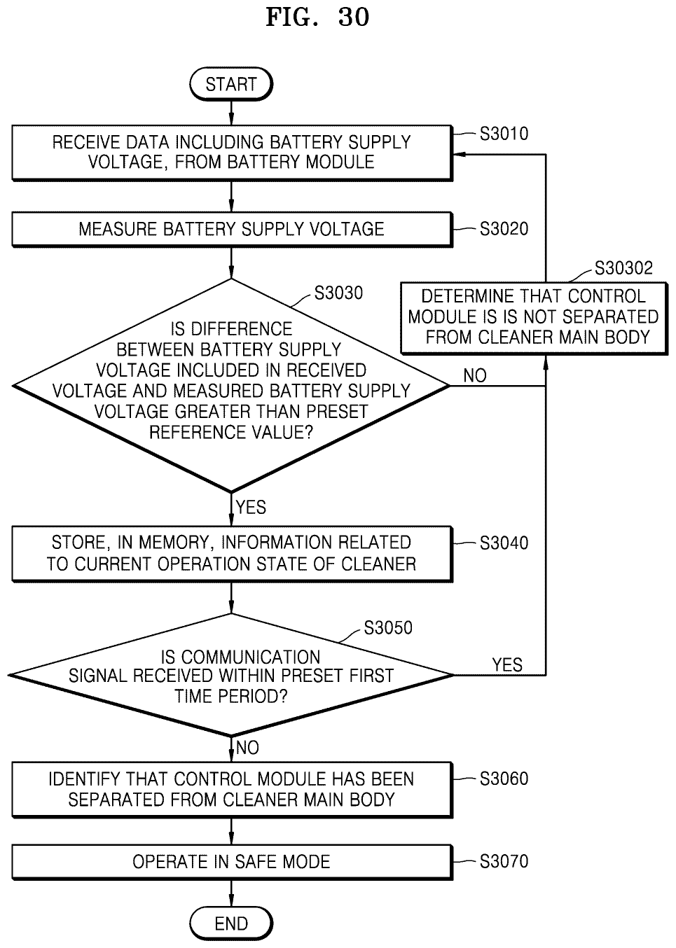

Meanwhile, according to an embodiment of the disclosure, the control module 180 may perform a preliminary operation in preparation for the control module 180 being separated from the cleaner main body 1000. Hereinafter, a method, performed by the control module 180, of performing a preliminary operation will be described in detail with reference to FIG. 30.

FIG. 30 is a flowchart for describing a method, performed by the control module 180, of performing a preliminary operation based on a difference between a battery supply voltage included in data received from the battery module 1500, and a battery supply voltage measured by the control module 180, according to an embodiment of the disclosure.

In operation S3010, the control module 180 according to an embodiment of the disclosure may receive data including a battery supply voltage, from the battery module 1500.

According to an embodiment of the disclosure, when the control module 180 is mounted on the cleaner main body 1000, the control module 180 may periodically receive data including a battery supply voltage, from the battery module 1500. For example, the control module 180 may receive data including a battery supply voltage every 20 ms through UART communication.

In operation S3020, the control module 180 according to an embodiment of the disclosure may measure a battery supply voltage applied to the control module 180.

For example, the main processor 1800 of the control module 180 may measure the battery supply voltage through a voltage divider circuit. The battery supply voltage input to the control module 180 may be rated at 25.2 V (30 V to 18 V), which is a voltage level that the main processor 1800 cannot directly receive. Thus, an input port of the main processor 1800 may receive a result of converting the battery supply voltage to 3.3 V (or 5 V) or less through the voltage divider circuit. The voltage divider circuit may convert the maximum value (30 V) of the battery supply voltage to 3.3 V or less, or 5 V or less. For example, in a case in which the battery supply voltage is 25.2 V and the voltage divider circuit includes a first resistor of 1.5 KΩ and a second resistor of 20 KΩ, the voltage value input to the input port of the main processor 1800 may be battery supply voltage 25.2 V*1.5 KΩ/(1.5 KΩ+20 KΩ)=1.7581. Here, the main processor 1800 may inversely convert the voltage value (e.g., 1.7581 V) input to the input port through the voltage divider circuit to confirm that the battery supply voltage is 25.2 V.

In operation S3030, the control module 180 according to an embodiment of the disclosure may determine whether a difference between the battery supply voltage included in the received data and the measured battery supply voltage is greater than a preset reference value.

When the control module 180 is stably mounted on the cleaner main body 1000, the difference between the battery supply voltage included in the data received from the battery module 1500 and the battery supply voltage measured by the control module 180 may be within an error tolerance. Thus, when the difference between the battery supply voltage included in the received data and the measured battery supply voltage is less than or equal to the preset reference value (i.e., ‘No’ in S3030), the control module 180 may determine that the control module 180 is mounted on the cleaner main body 1000 in operation S30302. Then, the control module 180 may continuously monitor a difference between a battery supply voltage included in data received from the battery module 1500 and a battery supply voltage measured by the control module 180.

In operation S3040, when the difference between the battery supply voltage included in the received data and the measured battery supply voltage is greater than the preset reference value (i.e., ‘Yes’ in S3030), the control module 180 according to an embodiment of the disclosure may store, in the memory 1900, information related to a current operation state of the cleaner.

When the control module 180 is separated from the cleaner main body 1000, the battery supply voltage measured by the control module 180 may rapidly decrease. On the other hand, when the control module 180 is separated from the cleaner main body 1000, communication between the control module 180 and the battery module 1500 is interrupted, and thus, the battery supply voltage included in the received data may be constant as the battery supply voltage just before the control module 180 is separated from the cleaner main body 1000. Thus, when the control module 180 is separated from the cleaner main body 1000, the difference between the battery supply voltage included in the received data and the measured battery supply voltage may gradually increase.

According to an embodiment of the disclosure, when the difference between the battery supply voltage included in the received data and the measured battery supply voltage reaches the reference value (e.g., 2 V), the control module 180 is likely to have been separated from the cleaner main body 1000, and thus, the control module 180 may, as a preliminary operation, record information related to the current operation state of the cleaner, in the memory 1900. For example, the control module 180 may record, in the memory 1900, an operating mode of the vacuum cleaner (e.g., a suction mode or an AI mode), a condition of use (e.g., the type of the brush device 2000 coupled to the cleaner main body 1000, a condition of the surface to be cleaned (e.g., a floor, a floor, a mat, or a state in which the surface to be cleaned has come off the floor), an interruption situation (e.g., impact occurrence, screw separation detection, failure history), and the like.

In operation S3050, the control module 180 according to an embodiment of the disclosure may determine whether a communication signal is received from the battery module 1500 within a preset first time period.

The preset first time period may be for determining separation of the control module 180 from the cleaner main body 1000. The first time period may be preset considering a communication cycle between the control module 180 and the battery module 1500. For example, when the control module 180 and the battery module 1500 communicate with each other at a cycle of 20 ms, the preset first time period may be 2 seconds, but is not limited thereto.

When the cleaner hits a wall or the like during cleaning due to its nature, the difference between the battery supply voltage included in the received data and the measured battery supply voltage may be temporarily greater than the preset reference value even when the control module 180 is not separated from the cleaner main body 1000. Thus, when the control module 180 receives a communication signal from the battery module 1500 within the preset first time period (i.e., ‘Yes’ in S3050), the control module 180 may determine that the control module 180 is not separated from the cleaner main body 1000 in operation S30302. Then, the control module 180 may monitor the difference between a battery supply voltage included in received data and a measured battery supply voltage while continuously communicating with the battery module 1500.

In operation S3060, when the control module 180 according to an embodiment of the disclosure does not receive a communication signal from the battery module 1500 for the preset first time period or longer (i.e., ‘No’ in S3050), the control module 180 may identify that the control module 180 has been separated from the cleaner main body 1000. For example, when the control module 180 does not receive a communication signal (e.g., a response signal) from the battery module 1500 for 2 seconds or longer, the control module 180 may identify that the control module 180 has been separated from the cleaner main body 1000.

In operation S3070, based on identifying that the control module 180 has been separated from the cleaner main body 1000, the control module 180 according to an embodiment of the disclosure may operate in the safe mode.

For example, based on identifying that the control module 180 has been separated from the cleaner main body 1000, the control module 180 may immediately power off the output interface to notify the user that the control module 180 cannot be manipulated. Alternatively, the control module 180 may power off the output interface after outputting an notification message. For example, the control module 180 may output a notification message stating “The control module 180 has been separated from the cleaner main body 1000, and thus cannot be manipulated”, and then power off the output interface.

According to an embodiment of the disclosure, based on identifying that the control module 180 according to an embodiment of the disclosure has been separated from the cleaner main body 1000, the control module 180 may ignore a user input received through an input interface (e.g., the manipulation unit 181). For example, the control module 180 may ignore an input such as pressing the power button, the +button, or the −button, without responding to it.

According to an embodiment of the disclosure, even before the first time period elapses after the control module 180 is separated from the cleaner main body 1000 (i.e., before the first time period elapses after communication with the battery module 1500 is interrupted), the control module 180 may preemptively record important data in the memory 1900 based on the difference between the battery supply voltage included in the received data and the measured battery supply voltage.

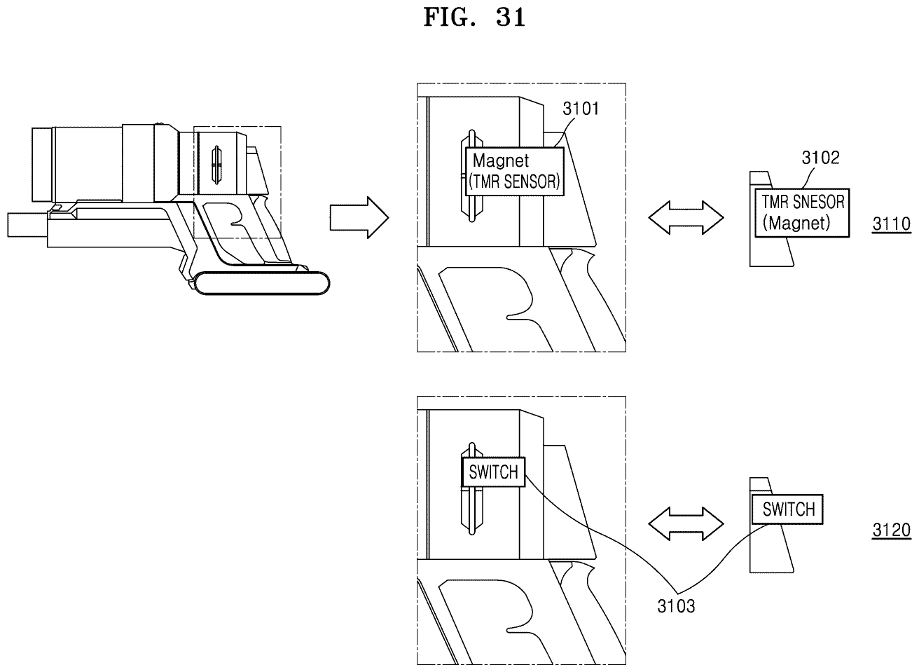

In addition, the control module 180 may also detect separation of the control module 180 from the cleaner main body 1000 by using a TMR sensor or a microswitch in addition to interruption of communication with the battery module 1500 or the motor assembly 1100. Hereinafter, a method, performed by the control module 180, of determining separation of the control module 180 from the cleaner main body 1000, by using a TMR sensor or a microswitch will be described with reference to FIG. 31.

FIG. 31 is a diagram for describing an operation of detecting a separation of the control module 180 from the cleaner main body 1000 by using a TMR sensor 3102 or a microswitch 3103, according to an embodiment of the disclosure.

Referring to 3110 of FIG. 31, the control module 180 may include the TMR sensor 3102, and the cleaner main body 1000 may include a magnetic body 3101. The magnetic body 3101 may be provided close to a surface where the cleaner main body 1000 and the control module 180 are coupled to each other. For example, the magnetic body 3101 may be provided in the socket 300 by which the control module 180 is separably supported. When the control module 180 is mounted on the cleaner main body 1000, the magnetic body 3101 and the TMR sensor 3102 may be aligned with each other.

When the control module 180 is mounted on the cleaner main body 1000, the distance between the magnetic body 3101 attached to the cleaner main body 1000 and the TMR sensor 3102 decreases, and the TMR sensor 3102 of the control module 180 may detect the magnetic body 3101. When the TMR sensor 3102 detects the magnetic body 3101, the control module 180 may identify that the control module 180 is mounted on the cleaner main body 1000.

On the other hand, when the control module 180 is separated from the cleaner main body 1000, the distance between the magnetic body 3101 attached to the cleaner main body 1000 and the TMR sensor 3102 increases, and the TMR sensor 3102 of the control module 180 cannot detect the magnetic body 3101. When the TMR sensor 3102 cannot detect the magnetic body 3101, the control module 180 may identify that the control module 180 has been separated from the cleaner main body 1000.

Meanwhile, an example in which the control module 180 includes the TMR sensor 3102 and the cleaner main body 1000 includes the magnetic body 3101 is described above with reference to 3110 of FIG. 31, but the disclosure is not limited thereto. The control module 180 may include the magnetic body 3101, and the cleaner main body 1000 may include the TMR sensor 3102. In this case, when the TMR sensor 3102 detects the magnetic body 3101, at least one processor of the cleaner main body 1000 may determine that the control module 180 is mounted on the cleaner main body 1000. On the other hand, when the TMR sensor 3102 cannot detect the magnetic body 3101, the at least one processor of the cleaner main body 1000 may determine that the control module 180 has been separated from the cleaner main body 1000.

Referring to 3120 of FIG. 31, the cleaner main body 1000 or the control module 180 may include the microswitch 3103. In this case, the at least one processor of the cleaner main body 1000 or the main processor 1800 of the control module 180 may identify whether the control module 180 has been separated from the cleaner main body 1000 according to a change in the state of the microswitch 3103 (e.g., short→open or open→short).

For example, the control module 180 may include the microswitch 3103, and the cleaner main body 1000 may include a protrusion to be aligned with the microswitch 3103. In this case, when the control module 180 is mounted on the cleaner main body 1000, the microswitch 3103 may be shorted, and when the control module 180 is separated from the cleaner main body 1000, the microswitch 3103 may be open. Thus, when the microswitch 3103 changes from a shorted state to an open state, the control module 180 may identify that the control module 180 has been separated from the cleaner main body 1000.

Alternatively, the cleaner main body 1000 may include the microswitch 3103, and the control module 180 may include a protrusion to be aligned with the microswitch 3103. In this case, when the control module 180 is mounted on the cleaner main body 1000, the microswitch 3103 may be shorted, and when the control module 180 is separated from the cleaner main body 1000, the microswitch 3103 may be open. Thus, when the microswitch 3103 changes from a shorted state to an open state, the at least one processor of the cleaner main body 1000 may identify that the control module 180 has been separated from the cleaner main body 1000.

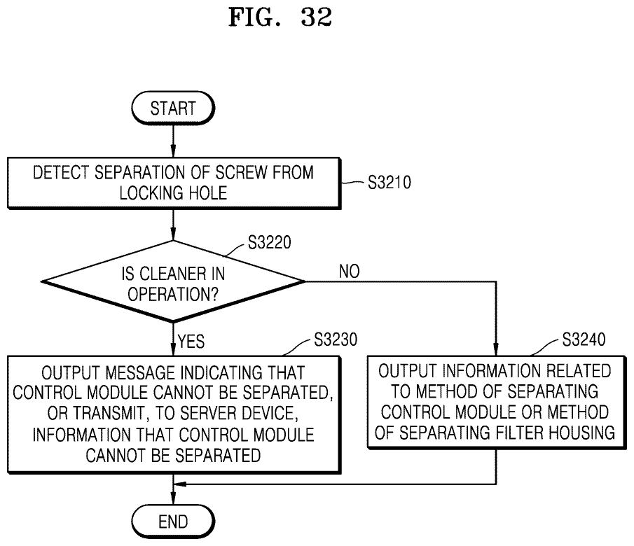

Meanwhile, the control module 180 according to an embodiment of the disclosure may detect an attempt to separate the control module 180, through the magnetic body 3101 and the TMR sensor 3102, or through the microswitch 3103. In this case, one or more TMR sensors 3102 or one or more microswitches 3103 may be applied. In addition, the TMR sensor 3102 and the microswitch 3103 may be applied in combination (e.g., one TMR sensor 3102 and one microswitch 3103). The control module 180 may output an appropriate notification message according to the operation state of the cleaner when the attempt to separate the control module 180 is detected. Hereinafter, an operation, performed by the control module 180, of outputting a notification message when a separation attempt is detected will be described in detail with reference to FIG. 32.

Although FIG. 31 relates to the use of TMR sensor 3102 and microswitch 3103, it is to be understood that other embodiments are available. These include, but are not limited to optical sensors or switches, analog sensors or switches and/or other types of electronic sensors or switches.

FIG. 32 is a flowchart for describing an operation method performed by the control module 180 when detecting separation of the screw 532 from the locking hole 188, according to an embodiment of the disclosure. An example in which the control module 180 has a screw fastening structure (see FIG. 6) will be described with reference to FIG. 32.

In operation S3210, the control module 180 according to an embodiment of the disclosure may detect separation of the screw 532 from the locking hole 188.

According to an embodiment of the disclosure, the control module 180 may detect separation of the screw 532 from the locking hole 188 through a TMR sensor. For example, the TMR sensor may be provided in the locking hole 188 and a magnetic body may be attached to an end of the screw 532. Alternatively, the magnetic body may be attached to the locking hole 188 and the TMR sensor may be provided at an end of the screw 532. In this case, when the user rotates the screw 532 to remove the screw 532 from the locking hole 188, the distance between the TMR sensor and the magnetic body increases, and thus, the TMR sensor cannot detect the magnetic body. Thus, when the TMR sensor cannot detect the magnetic body, the control module 180 may identify that the screw 532 has been separated from the locking hole 188.

According to an embodiment of the disclosure, the control module 180 may detect separation of the screw 532 from the locking hole 188 through a microswitch. For example, the microswitch may be provided in the locking hole 188 or the screw 532. In this case, when the user rotates the screw 532 to remove the screw 532 from the locking hole 188, the microswitch may change from a shorted state to an open state. Thus, when the state of the microswitch changes from the short state to the open state, the control module 180 may identify that the screw 532 has been separated from the locking hole 188.

In operation S3220, based on detecting separation of the screw 532 from the locking hole 188, the control module 180 according to an embodiment of the disclosure may determine whether the cleaner is in operation. For example, the control module 180 may determine whether the suction motor 1110 or the brush device 2000 is being driven.

Based on the cleaner being in operation when separation of the screw 532 from the locking hole 188 is detected, the control module 180 may determine that an abnormal separation attempt has occurred. In addition, based on the cleaner not being in operation when separation of the screw 532 from the locking hole 188 is detected, the control module 180 may determine that a normal separation attempt has occurred.

In operation S3230, based on the cleaner being in operation when separation of the screw 532 from the locking hole 188 is detected (i.e., ‘Yes’ in S3220), the control module 180 according to an embodiment of the disclosure may output a message indicating that the control module 180 cannot be separated, or transmit, to a server device, information that the control module 180 cannot be separated.

According to an embodiment of the disclosure, when the control module 180 is separated from the cleaner main body 1000 while the cleaner is in operation, a safety issue may arise. Thus, when separation of the screw 532 from the locking hole 188 is detected while the cleaner is in operation, the control module 180 may determine that an abnormal separation attempt has occurred. Then, before the control module 180 is separated from the cleaner main body 1000, the control module 180 may output, through an output interface, a notification message that the control module 180 cannot be separated from the cleaner main body 1000. For example, the control module 180 may display, on a display, a message indicating that the control module 180 cannot be separated during a cleaning operation, or a message for requesting that the cleaner be powered off before separating the control module 180, or output a voice of such a message through a speaker.

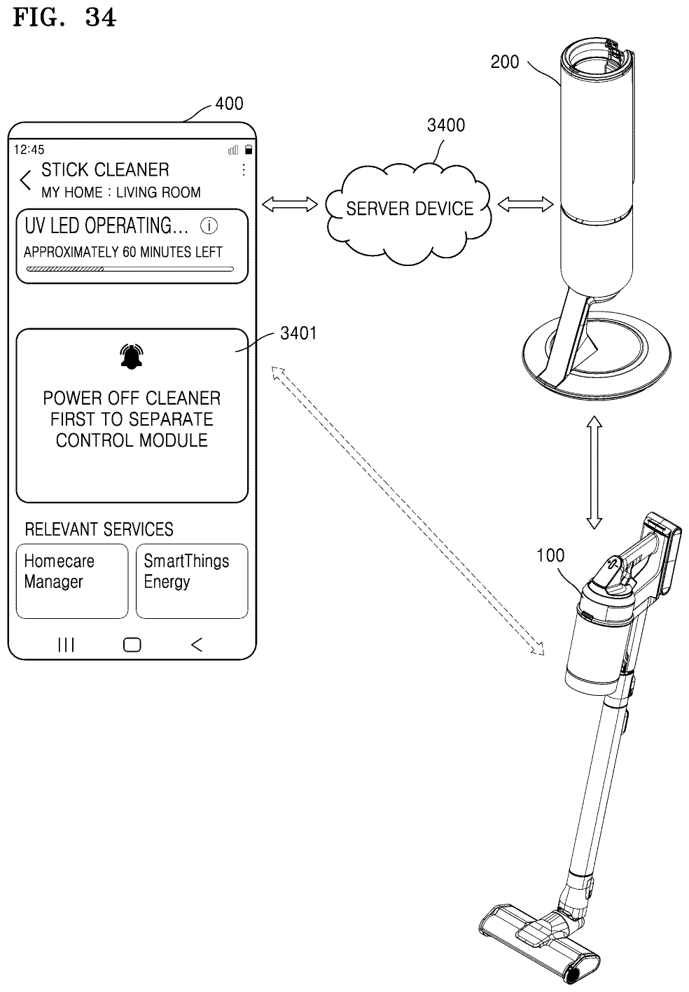

According to an embodiment of the disclosure, based on detecting separation of the screw 532 from the locking hole 188 while the cleaner is in operation, the control module 180 may transmit information that the control module 180 cannot be separated from the cleaner main body 1000, to a server device connected to the user's mobile terminal (hereinafter, also referred to as a user terminal). In this case, the server device may transmit, to the user's mobile terminal, information that the control module 180 cannot be separated from the cleaner main body 1000, and the user's mobile terminal may output a notification message that the control module 180 cannot be separated during a cleaning operation, or a notification message for requesting that the vacuum cleaner be powered off before separating the control module 180. An operation, performed by the user's mobile terminal, of outputting a notification message will be described in detail below with reference to FIG. 34.

In operation S3240, based on detecting separation of the screw 532 from the locking hole 188 while the operation of the cleaner is stopped (i.e., ‘No’ in S3220), the control module 180 may output, through the output interface, information related to a method of separating the control module 180 or a method of separating the filter housing 198.

For example, based on detecting separation of the screw 532 from the locking hole 188 while the operation of the cleaner is stopped, the control module 180 may determine that a normal separation attempt has occurred. After separating the screw 532 from the locking hole 188, the user is highly likely to separate the control module 180 from the cleaner main body 1000 or separate the filter housing 198 to replace a filter, and thus, the control module 180 may display, on the display, a text or an image for instructing the user to separate the control module 180 or the filter housing 198. Alternatively, the control module 180 may output, through the speaker, a voice for instructing the user to separate the control module 180 or the filter housing 198.

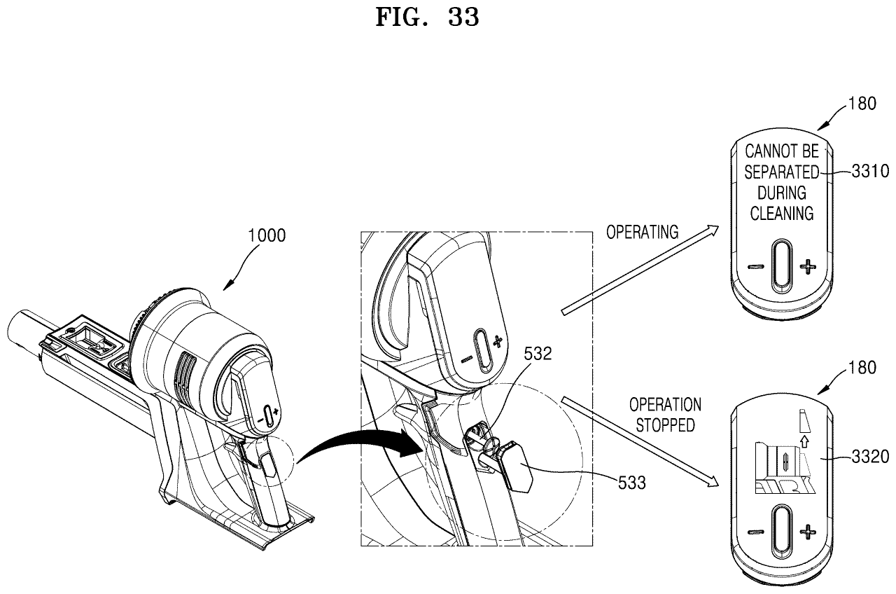

Hereinafter, an operation, performed by the control module 180, of outputting information through an output interface when detecting separation of the screw 532 from the locking hole 188 will be described in more detail with reference to FIG. 33.

FIG. 33 is a diagram illustrating an operation, performed by the control module 180, of outputting information through an output interface when detecting separation of the screw 532 from the locking hole 188, according to an embodiment of the disclosure.

Referring to FIG. 33, the control module 180 may be separated from the main body 1000 by separating the cover 533 from the handle 105, loosening the screw 532, and then sliding the control module 180 upward to separate it from the socket 300. Thus, separating the cover 533 from the handle 105 and loosening the screw 532 may be preparatory operations for separating the control module 180 from the main body 1000.

Based on detecting separation of the screw 532 from the locking hole 188 through a TMR sensor or a microswitch as discussed above with reference to FIG. 31 for example, the control module 180 may determine whether the cleaner is currently operating. When the cleaner is in operation, the control module 180 may output a notice 3310 that the control module 180 cannot be separated during a cleaning operation (e.g., ‘Cannot be separated during cleaning’).

On the contrary, when the operation of the cleaner has been terminated, the control module 180 may output a notification image 3320 showing that the control module 180 may be separated from the socket 300 by sliding the control module 180 upward. The user may easily separate the control module 180 from the cleaner main body 1000 through the notification image 3320. In addition, the control module 180 may display at least one image for instructing the user to replace a filter.

According to an embodiment of the disclosure, based on detecting separation of the screw 532 from the locking hole 188 while the cleaner is in operation, the control module 180 may output, through a user terminal, a notification that the control module 180 cannot be separated during a cleaning operation. Hereinafter, an operation, performed by a user terminal, of outputting a notification will be described in detail with reference to FIG. 34.

FIG. 34 is a diagram for describing a notification message output through a user terminal 400 when separation of the screw 532 from the locking hole 188 is detected, according to an embodiment of the disclosure.

Referring to FIG. 34, a cleaning system according to an embodiment of the disclosure may include the cordless cleaner 100, a station device 200, a server device 3400, and the user terminal 400. Each device will be described below.

The cordless cleaner 100 may refer to a vacuum cleaner that has a built-in rechargeable battery and does not need to connect a power cord to an outlet during a cleaning operation. The cordless cleaner 100 may include a communication interface for communicating with the station device 200. For example, the control module 180 of the cordless cleaner 100 may transmit and receive data to and from the station device 200 through a short-range wireless network (e.g., a wireless personal area network (WPAN)).

The station device 200 may refer to a device for discharging dust from the cordless cleaner 100, charging a battery of the cordless cleaner 100, or storing the cordless cleaner 100. The station device 200 may also be referred to as a cleaning station or a charging station. According to an embodiment of the disclosure, the station device 200 may communicate with the cordless cleaner 100 or the server device 3400 through a network. For example, the station device 200 may transmit and receive data to and from the cordless cleaner 100 through a short-range wireless network (e.g., a WPAN) without an access point (AP). The station device 200 may also transmit and receive data to and from the server device 3400 through an AP that connects a LAN to which the station device 200 is connected, to a WAN to which the server device 3400 is connected. For example, the station device 200 may be connected to the cordless cleaner 100 through BLE communication, and may be connected to the server device 3400 through Wi-Fi™ (IEEE 802.11) communication, but is not limited thereto.

The server device 3400 according to an embodiment of the disclosure may be a device for managing the station device 200 and the cordless cleaner 100. For example, the server device 3400 may be a home appliance management server. The server device 3400 may manage user account information and information about home appliances connected to the user account. For example, the user may access the server device 3400 through the user terminal 400 to create a user account. The user account may be identified by an identifier (ID) and a password both set by the user. The server device 3400 may register the station device 200 and the cordless cleaner 100 to the user account according to a set procedure. For example, the server device 3400 may register the station device 200 and the cordless cleaner 100 by linking identification information (e.g., a serial number or a medium access control (MAC) address) of the station device 200 and identification information of the cordless cleaner 100 to the user account. When the station device 200 and the cordless cleaner 100 are registered in the server device 3400, the server device 3400 may manage a state of the station device 200 or a state of the cordless cleaner 100 by periodically receiving state information of the station device 200 or state information of the cordless cleaner 100, from the station device 200.

The user terminal 400 may be a device registered in the server device 3400 with the same account as the station device 200 or the cordless cleaner 100. The user terminal 400 may be a smart phone, a laptop computer, a tablet personal computer (PC), digital camera, an electronic book terminal, a digital broadcasting terminal, a personal digital assistant (PDA), a portable multimedia player (PMP), a wearable device, a device including a display, or the like, but is not limited thereto. Hereinafter, for convenience of description, an example will be described in which the user terminal 400 is a smart phone.

According to an embodiment of the disclosure, the user terminal 400 may communicate with at least one of the server device 3400, the station device 200, or the cordless cleaner 100. The user terminal 400 may communicate directly with the station device 200 or the cordless cleaner 100 through short-range wireless communication, or may communicate indirectly with the station device 200 or the cordless cleaner 100 through the server device 3400.

According to an embodiment of the disclosure, the user terminal 400 may execute, based on a user input, a particular application (e.g., a home appliance management application) provided by the server device 3400. In this case, the user may check the state of the cordless cleaner 100 or the state of the station device 200 through an execution window of the application. For example, the user terminal 400 may provide, through the execution window of the application, information related to an operation of an ultraviolet (UV) irradiation unit (e.g., ‘UV LED is operating’), and information related to dust discharge in the station device 200 (e.g., ‘The dust container was emptied 1 minute ago’), but is not limited thereto.

Meanwhile, when separation of the screw 532 from the locking hole 188 is detected while the cleaner is in operation, a notification that the control module 180 cannot be separated during a cleaning operation or a notification to power off the cleaner may be output through the user terminal 400. For example, when the control module 180 detects separation of the screw 532 from the locking hole 188 while the cleaner is in operation, the control module 180 may transmit information that the separation of the screw 532 from the locking hole 188 has been detected during a cleaning operation, to the server device 3400 through the station device 200. In this case, the server device 3400 may output a notification message 3401 to power off the cleaner (e.g., ‘Power off the cleaner first to separate the control module’), through an application installed in the user terminal 400 registered with the same account as the cordless cleaner 100.

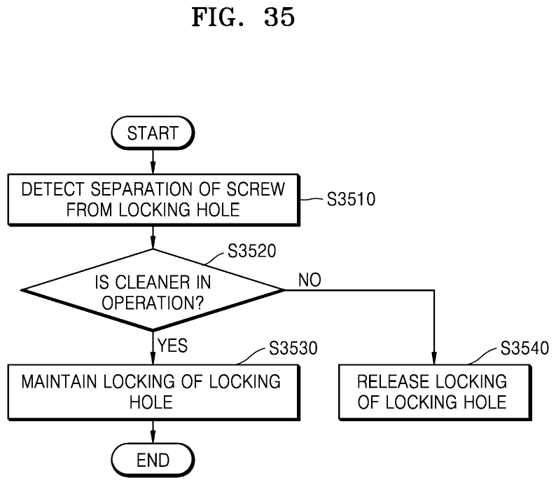

FIG. 35 is a flowchart for describing a method, performed by the control module 180, of determining whether to maintain or release locking of the locking unit 187, according to an embodiment of the disclosure. An example in which the control module 180 has a screw fastening structure (see FIG. 6) will be described with reference to FIG. 35.

In operation S3510, the control module 180 according to an embodiment of the disclosure may detect separation of the screw 532 from the locking hole 188. For example, the control module 180 may detect separation of the screw 532 from the locking hole 188, through a TMR sensor or a microswitch.

Operation S3510 corresponds to operation S3210 of FIG. 32, and thus, redundant descriptions thereof will be omitted.

In operation S3520, based on detecting separation of the screw 532 from the locking hole 188, the control module 180 according to an embodiment of the disclosure may determine whether the cleaner is in operation. For example, the control module 180 may determine whether the suction motor 1110 or the brush device 2000 is being driven.

In operation S3530, based on the cleaner being in operation when the separation of the screw 532 from the locking hole 188 is detected (i.e., ‘Yes’ in S3520), the control module 180 according to an embodiment of the disclosure may maintain locking of the locking unit 187.

According to an embodiment of the disclosure, when the control module 180 is separated from the cleaner main body 1000 while the cleaner is in operation, a safety issue may arise. Thus, when separation of the screw 532 from the locking hole 188 is detected while the cleaner is in operation, the control module 180 may determine that an abnormal separation attempt has occurred. Then, the control module 180 may maintain movement locking of the locking unit 187 in order to prevent the control module 180 from being separated from the cleaner main body 1000.

For example, when the control module 180 is mounted on the cleaner main body 1000, the locking unit 187 may be automatically caught on a hook such that the locking unit 187 cannot move. Based on the cleaner being in operation when the separation of the screw 532 from the locking hole 188 is detected, the control module 180 may maintain the state in which the locking unit 187 is caught on the hook, to prevent the control module 180 from being slid upward.

In operation S3540, based on detecting separation of the screw 532 from the locking hole 188 while the operation of the cleaner is stopped (i.e., ‘No’ in S3520), the control module 180 according to an embodiment of the disclosure may release the locking of the locking unit 187.

For example, based on detecting separation of the screw 532 from the locking hole 188 while the operation of the cleaner is stopped, the control module 180 may determine that a normal separation attempt has occurred. After separating the screw 532 from the locking hole 188, the user is highly likely to separate the control module 180 from the cleaner main body 1000 or separate the filter housing 198 to replace a filter, and thus, the control module 180 may release the locking of the locking unit 187 to facilitate separation of the control module 180 from the cleaner main body 1000. For example, based on the operation of the cleaner being stopped when separation of the screw 532 from the locking hole 188 is detected, the control module 180 may release the hook from the locking unit 187, to allow the user to slide the control module 180 upward.

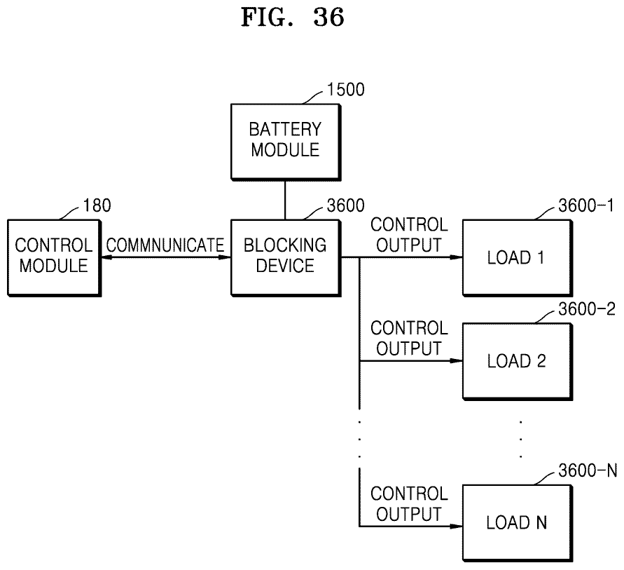

FIG. 36 is a diagram for describing a blocking device 3600 according to an embodiment of the disclosure.

According to an embodiment of the disclosure, the cleaner main body 1000 may further include the blocking device 3600 connected to a plurality of loads including the suction motor 1110. The blocking device 3600 may be electrically connected to the battery module 1500 and a plurality of loads 3600-1, 3600-2, . . . , 3600-N. The plurality of loads may include, but are not limited to, the suction motor 1110, the motor 2100 of the brush device 2000, the pressure sensor 1400, and the like.

According to an embodiment of the disclosure, the blocking device 3600 may periodically communicate with the control module 180. For example, the blocking device 3600 may periodically communicate with the control module 180 through UART communication or I2C communication. When a communication signal is not received from the control module 180 for a preset first time period (e.g., 2 seconds) or longer, the blocking device 3600 may identify that the control module 180 has been separated from the cleaner main body 1000. It is dangerous for the cleaner to operate while the control module 180 is separated from the cleaner main body 1000, and thus, based on identifying that the control module 180 has been separated from the cleaner main body 1000, the blocking device 3600 may selectively block power supply from the battery module 1500 to at least one of the plurality of loads 3600-1, 3600-2, . . . , 3600-N. For example, based on identifying that the control module 180 has been separated from the cleaner main body 1000, the blocking device 3600 may selectively block the power supply to the suction motor 1110.

According to an embodiment of the disclosure, based on identifying that the control module 180 has been separated from the cleaner main body 1000, the blocking device 3600 may block the power supply to all of the loads 3600-1, 3600-2, . . . , 3600-N at once.

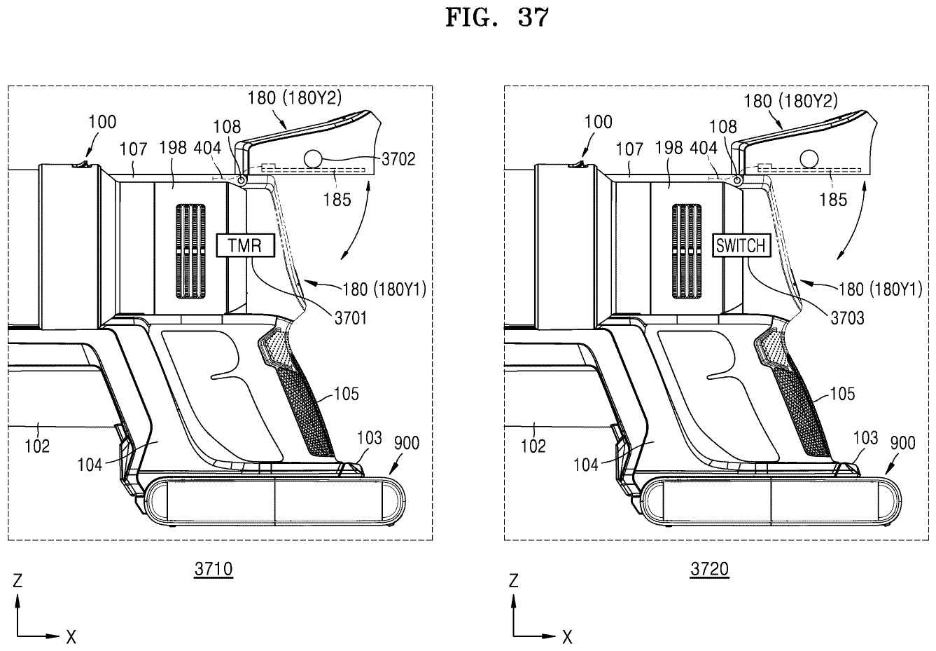

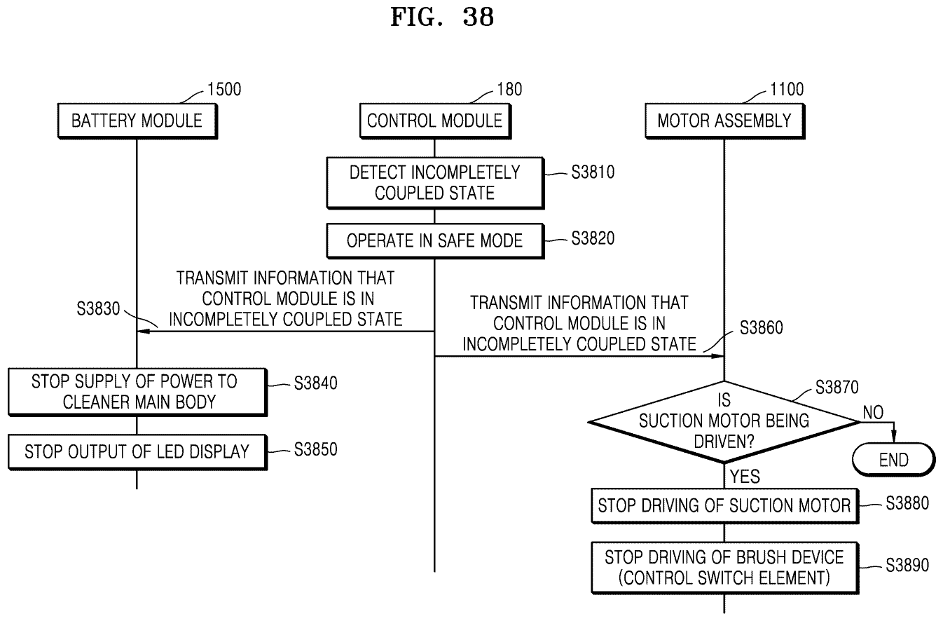

Meanwhile, the control module 180 may have a structure that is completely separated from the cleaner main body 1000 (e.g., FIGS. 6 and 8 to 13), or may have a structure that is incompletely separated from the cleaner main body 1000 with some contact points (e.g., FIGS. 14A and 15 to 20). Hereinafter, an operation of the control module 180 having the structure that is incompletely separated from the cleaner main body 1000 will be described with reference to FIGS. 37 and 38.

FIG. 37 is a diagram for describing an operation of detecting that the control module 180 switches from the use position 180Y1 to the retreat position 180Y2, according to an embodiment of the disclosure.

Referring to 3710 of FIG. 37, the cleaner main body 1000 may include a TMR sensor 3701, and the control module 180 may include a magnetic body 3702. The TMR sensor 3701 may be provided close to a surface where the cleaner main body 1000 and the control module 180 are coupled to each other. When the control module 180 is located at the use position 180Y1, the TMR sensor 3701 and the magnetic body 3702 may be aligned with each other. Hereinafter, a state in which the control module 180 is located at the use position 180Y1 will be defined as a completely coupled state of the control module 180 to the cleaner main body 1000. In addition, hereinafter, a state in which the control module 180 is located at the retreat position 180Y2 will be defined as an incompletely coupled state of the control module 180 to the cleaner main body 1000.

When the control module 180 is located at the use position 180Y1 (i.e., the completely coupled state), the distance between the magnetic body 3702 attached to the control module 180 and the TMR sensor 3701 provided in the cleaner main body 1000 decreases, and thus, the TMR sensor 3701 may detect the magnetic body 3702. When the TMR sensor 3701 detects the magnetic body 3702, the control module 180 may identify that the control module 180 is in the completely coupled state in which the control module 180 is located at the use position 180Y1.

On the contrary, when the control module 180 rotates from the use position 180Y1 to the retreat position 180Y2 (i.e., the incompletely coupled state), the distance between the magnetic body 3702 attached to the control module 180 and the TMR sensor 3701 provided in the cleaner main body 1000 increases, and thus, the TMR sensor 3701 cannot detect the magnetic body 3702. When the TMR sensor 3701 cannot detect the magnetic body 3702, the control module 180 may identify that the control module 180 is in the incompletely coupled state in which the control module 180 is located at the retreat position 180Y2.

Meanwhile, an example in which the control module 180 includes the magnetic body 3702 and the cleaner main body 1000 includes the TMR sensor 3701 is described above with reference to 3710 of FIG. 37, but the disclosure is not limited thereto. The control module 180 may include the TMR sensor 3701, and the cleaner main body 1000 may include the magnetic body 3702.

Referring to 3720 of FIG. 37, the cleaner main body 1000 or the control module 180 may include a microswitch 3703. In this case, the main processor 1800 of the control module 180 may identify a coupling state of the control module 180 to the cleaner main body 1000 (e.g., the completely coupled state or the incompletely coupled state) according to a change in the state of the microswitch 3703 (e.g., short→open or open→short).

For example, the cleaner main body 1000 may include the microswitch 3703, and the control module 180 may include a protrusion to be aligned with the microswitch 3703. In this case, when the control module 180 is located at the use position 180Y1 (i.e., the completely coupled state), the microswitch 3703 may be shorted, and when the control module 180 rotates from the use position 180Y1 to the retreat position 180Y2 (i.e., the incompletely coupled state), the microswitch 3703 may be open. Thus, when the microswitch 3703 changes from the shorted state to the open state, the main processor 1800 of the control module 180 may identify that the control module 180 is in the incompletely coupled state in which the control module 180 is located at the retreat position 180Y2.

On the contrary, the control module 180 may include the microswitch 3703, and the cleaner main body 1000 may include a protrusion to be aligned with the microswitch 3703. In this case, when the control module 180 is located at the use position 180Y1 (i.e., the completely coupled state), the microswitch 3703 may be shorted, and when the control module 180 rotates from the use position 180Y1 to the retreat position 180Y2 (i.e., the incompletely coupled state), the microswitch 3703 may be open. Thus, when the microswitch 3703 changes from the shorted state to the open state, the control module 180 may identify that the control module 180 is in the incompletely coupled state in which the control module 180 is located at the retreat position 180Y2.

Meanwhile, when the cleaner is in operation when the control module 180 rotates from the use position 180Y1 to the retreat position 180Y2, a safety issue may arise. Thus, when the control module 180 rotates from the use position 180Y1 to the retreat position 180Y2 (i.e., when the incompletely coupled state is identified), the control module 180 may operate in a safe mode. Hereinafter, a method, performed by the control module 180, of operating in a safe mode will be described in detail with reference to FIG. 38.

FIG. 38 is a flowchart for describing a method, performed by each of the battery module 1500, the control module 180, and the motor assembly 1100, of operating in a safe mode as the control module 180 switches from the use position 180Y1 to the retreat position 180Y2, according to an embodiment of the disclosure.

In operation S3810, the control module 180 according to an embodiment of the disclosure may detect the incompletely coupled state in which the control module 180 is located at the retreat position 180Y2. For example, the control module 180 may detect the incompletely coupled state through the TMR sensor 3701, the magnetic body 3702, or the microswitch 3703.

The operation, performed by the control module 180, of detecting the incompletely coupled state is described in detail above with reference to FIG. 37, and thus, redundant descriptions will be omitted.

In operation S3820, when the control module 180 according to an embodiment of the disclosure is in the incompletely coupled state to the cleaner main body 1000, the control module 180 may operate in the safe mode.

For example, based on detecting the incompletely coupled state in which the control module 180 is located at the retreat position 180Y2, the control module 180 may power off an output interface (e.g., the indication unit 182), and ignore a user input received through an input interface (e.g., the manipulation unit 181). In addition, the control module 180 may store, in the memory 1900, operation history information corresponding to a time point at which the control module 180 rotates from the use position 180Y1 to the retreat position 180Y2. For example, the control module 180 may record, in the memory 1900, information about an operating mode, a usage condition, an interruption situation, and the like at the time point at which the control module 180 rotates from the use position 180Y1 to the retreat position 180Y2.

In operation S3830, the control module 180 according to an embodiment of the disclosure may transmit, to the battery module 1500, information that the control module 180 is in the incompletely coupled state. Even when the control module 180 rotates the use position 180Y1 to the retreat position 180Y2, the control module 180 may be electrically connected to the battery module 1500. Thus, the control module 180 may receive power supplied from the battery module 1500, and transmit and receive data to and from the battery module 1500 through UART communication.

In operations S3840 to S3850, based on receiving the information that the control module 180 is in the incompletely coupled state from the control module 180, the battery module 1500 may operate in the safe mode.

In operation S3840, based on receiving the information that the control module 180 is in the incompletely coupled state from the control module 180, the battery module 1500 according to an embodiment of the disclosure may stop supply of power to the cleaner main body 1000. When the cleaner continuously operate in a state in which the control module 180 is not completely coupled to the cleaner main body 1000, a dangerous situation may occur. Thus, the battery module 1500 may block all power supplied to the cleaner main body 1000 for safety. When the battery module 1500 stops the supply of the power to the cleaner main body 1000, operations of the suction motor 1110 and the brush device 2000 may be stopped.

In operation S3850, based on receiving the information that the control module 180 is in the incompletely coupled state from the control module 180, the battery module 1500 according to an embodiment of the disclosure may stop output of the LED display 1501 included in the battery module 1500. The battery module 1500 may stop the output of the LED display 1501 to notify that the supply of the power to the cleaner main body 1000 has been stopped.

In operation S3860, the control module 180 according to an embodiment of the disclosure may transmit, to the motor assembly 1100, information that the control module 180 is in the incompletely coupled state. Even when the control module 180 rotates the use position 180Y1 to the retreat position 180Y2, the control module 180 may be electrically connected to the motor assembly 1100. Thus, even at the retreat position 180Y2, the control module 180 may periodically transmit and receive data to and from the motor assembly 1100 through UART communication.

In operations S3870 to S3890, based on receiving the information that the control module 180 is in the incompletely coupled state from the control module 180, the motor assembly 1100 may operate in the safe mode.

In operation S3870, based on receiving the information that the control module 180 is in the incompletely coupled state from the control module 180, the motor assembly 1100 according to an embodiment of the disclosure may determine whether the suction motor 1110 is being driven.

According to an embodiment of the disclosure, even when the battery module 1500 stops supplying power to the cleaner main body 1000, the power supplied to the suction motor 1110 may not be accurately blocked due to a failure of a switch element (e.g., a FET). In this case, the suction motor 1110 may be continuously driven.

In operation S3880, when the suction motor 1110 is being driven even though the control module 180 is in the incompletely coupled state (i.e., ‘Yes’ in S3870), the motor assembly 1100 according to an embodiment of the disclosure may stop the driving of the suction motor 1110 for safety.

In operation S3890, the motor assembly 1100 according to an embodiment of the disclosure may stop driving of the brush device 2000. For example, based on receiving the information that the control module 180 is in the incompletely coupled state from the control module 180, the first processor 1131 of the motor assembly 1100 stop the driving of the brush device 2000 by controlling the switch element 1133 used to supply power to the brush device 2000 connected to the cleaner main body 1000.

According to an embodiment of the disclosure, each of the control module 180, the battery module 1500, and the motor assembly 1100 may increase the stability of the cleaner by operating in the safe mode when the control module 180 is in the incompletely coupled state (i.e., is at the retreat position 180Y2).

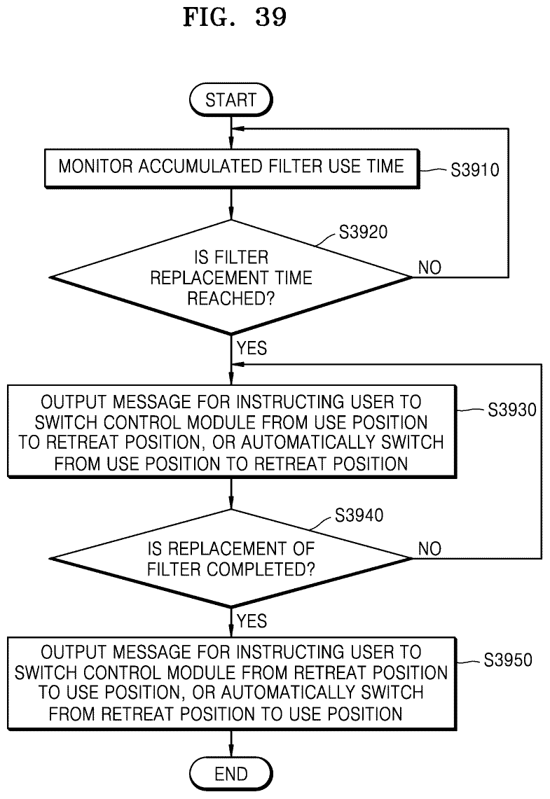

FIG. 39 is a flowchart for describing a method of outputting a message related to replacement of the filter 197, according to an embodiment of the disclosure.

In operation S3910, the control module 180 according to an embodiment of the disclosure may monitor an accumulated filter use time. For example, the control module 180 may monitor a time period from a time point at which the filter 197 is newly mounted in the filter housing 198.

In operation S3920, the control module 180 according to an embodiment of the disclosure may determine whether the accumulated filter use time has reached a filter replacement time. The filter replacement time may be set by a system administrator or a user.

For example, when a filter replacement cycle is 6 months, the control module 180 may determine whether 6 months have elapsed after the filter 197 was newly mounted in the filter housing 198.

According to an embodiment of the disclosure, when the accumulated filter use time has not reached the filter replacement time (i.e., ‘No’ in S3920), the control module 180 may continue to monitor the accumulated filter use time.

In operation S3930, when the accumulated filter use time has reached the filter replacement time (i.e., ‘Yes’ in S3920), the control module 180 according to an embodiment of the disclosure may output a message for instructing the user to switch the control module 180 from the use position 180Y1 to the retreat position 180Y2, or may automatically switch from the use position 180Y1 to the retreat position 180Y2.

For example, in order to notify the user that the filter replacement cycle has been reached, the control module 180 may visually or audibly output a notification message stating “The filter can be replaced. Remove the control module, rotate the filter 180 degrees counterclockwise, and then replace the filter”. Alternatively, the control module 180 may cause the user terminal 400 to output the notification message, through a wireless network.

In addition, the control module 180 may automatically switch from the use position 180Y1 to the retreat position 180Y2 to enable separation of the filter housing 198. For example, the control module 180 may automatically rotate from the use position 180Y1 at the rear of the filter housing 198, to the retreat position 180Y2 in which the control module 180 does not interfere with the filter housing 198 being separated from the cleaner in the backward direction. When the control module 180 automatically switches from the use position 180Y1 to the retreat position 180Y2, the user may recognize that the filter replacement cycle has been reached.

In operation S3940, the control module 180 according to an embodiment of the disclosure may determine whether replacement of the filter 197 is completed.

When the control module 180 switches from the use position 180Y1 to the retreat position 180Y2, the user may separate the filter housing 198 from the cleaner main body 1000, and then replace the filter 197. Thereafter, the user may mount the filter housing 198 on the cleaner main body 1000 again. The control module 180 may detect that the filter housing 198 is mounted on the cleaner main body 1000, through a TMR sensor or a microswitch.

Based on detecting that the filter housing 198 is mounted on the cleaner main body 1000, the control module 180 may output a message for inquiring whether filter replacement has been completed. For example, the control module 180 may output a message stating “If filter replacement is completed, please press the +button”. The user may input a response indicating that the filter replacement has been completed, through the input interface. For example, the user may select the +button.

In S3950, when replacement of the filter 197 is completed (i.e., ‘Yes’ in S3940), the control module 180 according to an embodiment of the disclosure may output a message for instructing the user to switch the control module 180 from the retreat position 180Y2 to the use position 180Y1, or may automatically switch from the retreat position 180Y2 to the use position 180Y1.

For example, the control module 180 may visually or audibly output a notification message stating “Filter replacement has been completed. Please rotate the control module 180 degrees clockwise”. In addition, because the replacement of the filter 197 has been completed and the filter housing 198 has been mounted on the cleaner main body 1000, the control module 180 may automatically switch from the retreat position 180Y2 to the use position 180Y1.

According to an embodiment of the disclosure, because the filter 197 has been replaced, the control module 180 may monitor an accumulated use time of the new filter 197.

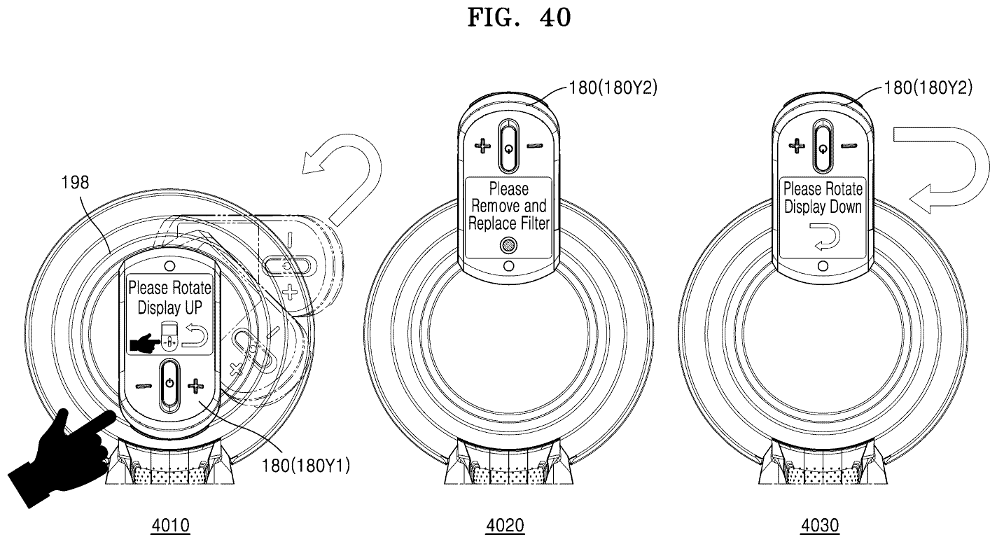

FIG. 40 is a diagram for describing an operation of outputting a message related to replacement of the filter 197, according to an embodiment of the disclosure.

Referring to 4010 in FIG. 40, when the accumulated use time of the filter 197 reaches the filter replacement cycle, the control module 180 may output a notification message for instructing the user to switch the control module 180 to the retreat position 180Y2 in order to replace the filter 197 (e.g., “Please rotate display up”). Here, the control module 180 may display an image for instructing the user to switch the control module 180 to the retreat position 180Y2. The user may rotate the control module 180 180 degrees counterclockwise by referring to the message or image displayed on the display.

Referring to 4020 of FIG. 40, the control module 180 may be located at the retreat position 180Y2 to enable backward separation of the filter housing 198. The control module 180 may detect the rotation angle through a TMR sensor, a microswitch, or a geomagnetic sensor. The control module 180 may identify that the current position of the control module 180 has reached the retreat position 180Y2, through the TMR sensor, microswitch, or geomagnetic sensor.

At the retreat position 180Y2, the control module 180 may output a message (e.g., “Please remove and replace filter”) or an image for instructing the user to replace the filter 197. Here, because the control module 180 has been rotated 180 degrees, the control module 180 may display the message or image that is rotated 180 degrees with respect to the X axis such that the user may easily check it.

Referring to 4030 in FIG. 40, when the replacement of the filter 197 is completed, the control module 180 may output a notification message for instructing the user to switch the control module 180 to the use position 180Y1 (e.g., “Please rotate display down”). Here, the control module 180 may also display an image for instructing the user to switch the control module 180 to the use position 180Y1. The user may rotate the control module 180 180 degrees clockwise by referring to the message or image displayed on the display.

Meanwhile, an example in which the control module 180 has a structure that is incompletely separated from the cleaner main body 1000 with some contact points (e.g., FIGS. 14A and 15 to 20) is described above with reference to FIGS. 39 and 40, but the disclosure is not limited thereto. The control module 180 having a structure that is completely separated from the cleaner main body 1000 (e.g., FIGS. 6 and 8 to 13) may also output a message or an image for instructing the user to separate the control module 180 to replace the filter 197, when the filter replacement cycle has been reached.

An embodiment of the disclosure relates to a method of increasing the safety of a cleaner wherein, when the control module 180 is separated from the cleaner main body 1000, at least one of the battery module 1500, the control module 180, or the motor assembly 1100 operates in a safe mode.

A cleaner according to an embodiment of the disclosure may include the suction motor 1110, the control module 180 that is configured to control an operation of the cleaner, is separable from the cleaner main body 1000, and includes the main processor 1800 configured to communicate with the battery module 900 or 1500 at a preset period in a state in which the control module 180 is mounted on the cleaner main body 1000, and the battery module 900 or 1500 configured to identify that the control module 180 has been separated from the cleaner main body 1000 and to stop supply of power to the cleaner main body 1000 based on not receiving a communication signal from the control module 180 for a preset first time period or longer.

The battery module 1500 according to an embodiment of the disclosure may stop output of the LED display 1501 provided in the battery module 1500 based on identifying that the control module 180 has been separated from the cleaner main body.

The first processor 1131 for controlling the suction motor 1110 according to an embodiment of the disclosure may identify that the control module 180 has been separated from the cleaner main body 1000 based on not receiving a communication signal from the control module 180 for a preset second time period or longer. The first processor 1131 may stop driving of the suction motor 1110.

According to an embodiment of the disclosure, the preset second time period may be longer than the preset first time period.

The first processor 1131 according to an embodiment of the disclosure may stop driving of the brush device 2000 connected to the cleaner main body 1000 by controlling the switch element 1133 that is used to supply power to the brush device 2000 based on identifying that the control module 180 has been separated from the cleaner main body.

The control module 180 according to an embodiment of the disclosure may further include an output interface configured to output information related to a state of the cleaner, an input interface configured to receive an input for manipulating the cleaner, the main processor 1800 for controlling the cleaner, and the memory 1900 storing information related to an operation of the cleaner. The main processor 1800 according to an embodiment of the disclosure may identify that the control module 180 has been separated from the cleaner main body 1000 based on not receiving a communication signal from the battery module 1500 for the first preset time period or longer.

The main processor 1800 according to an embodiment of the disclosure may power off the output interface based on identifying that the control module 180 has been separated from the cleaner main body 1000. The main processor 1800 may ignore a user input received through the input interface.

The main processor 1800 according to an embodiment of the disclosure may store operation history information corresponding to a time point of identifying that the control module 180 has been separated from the cleaner main body 1000 in the memory 1900.

The cleaner according to an embodiment of the disclosure may further include the blocking device 3600 that is connected to a plurality of loads including the suction motor 1110. The blocking device 3600 according to an embodiment of the disclosure may selectively block supply of power from the battery module 1500 to at least one of the plurality of loads based on identifying that the control module 180 has been separated from the cleaner main body 1000.

The control module 180 according to an embodiment of the disclosure may measure a battery supply voltage applied from the battery module 1500 to the control module 180. The control module 180 may determine whether the control module 180 has been separated from the cleaner main body 1000 based on the measured battery supply voltage.

The control module 180 according to an embodiment of the disclosure may identify that the control module 180 has been separated from the cleaner main body 1000 based on a voltage drop rate of the measured battery supply voltage being greater than a threshold value.

The control module 180 according to an embodiment of the disclosure may receive data including a battery supply voltage from the battery module 1500. Based on a difference between the battery supply voltage included in the received data and the measured battery supply voltage being greater than a preset reference value, the control module 180 may store information related to a current operation state of the cleaner in the memory 1900.

According to an embodiment of the disclosure, the socket 300 by which the control module 180 is separably supported is provided in the cleaner main body 1000, and the control module 180 may be attached to and separated from the socket 300 by being slid in an upward direction and a downward direction, respectively.

The cleaner main body 1000 according to an embodiment of the disclosure may further include the handle 105 to be held by a user. The control module 180 may be located above the handle 105 and at the rear of the filter housing 198.

The filter housing 198 according to an embodiment of the disclosure may be separable from the cleaner main body 1000 in a backward direction.

The control module 180 according to an embodiment of the disclosure may further include the locking unit 187 that is inserted into the handle 105 when the control module 180 is mounted on the cleaner main body 1000, and includes the locking hole 188. The screw fastening hole 531 to be aligned with the locking hole 188 may be provided in the handle 105. The control module 180 may be fixed to the cleaner main body 1000 by tightening the screw 532 into the locking hole 188 through the screw fastening hole 531.

The control module 180 according to an embodiment of the disclosure may detect separation of the screw 532 from the locking hole 188 through a TMR sensor or a microswitch provided in the locking unit 187.

The control module 180 according to an embodiment of the disclosure may output a notification message that the control module 180 is unable to be separated from the cleaner main body 1000 through the output interface based on detecting separation of the screw 532 from the locking hole 188 while the cleaner is in operation.

The control module 180 according to an embodiment of the disclosure may transmit information that the control module 180 is unable to be separated from the cleaner main body 1000 to the server device 3400 connected to a mobile terminal of the user based on detecting separation of the screw 532 from the locking hole 188 while the cleaner is in operation.

The control module 180 according to an embodiment of the disclosure may output information related to a method of separating the control module 180 or a method of separating the filter housing 198 through the output interface based on detecting separation of the screw 532 from the locking hole 188 while an operation of the cleaner is stopped.

According to an embodiment of the disclosure, a cleaner may include a cleaner main body comprising a suction motor, a battery module, and control module configured to control cleaner operations and being mountable on and separable from the cleaner main body and comprising a main processor. The main processor may communicate with the battery module when the control module is mounted on the cleaner main body. The battery module may be receptive of a control signal from the cleaner main body and identify that the control module is separated from the cleaner main body in an event the communication signal is not received for at least a first period to stop a supply of power to the cleaner main body.

According to an embodiment of the disclosure, a cleaner may include a main body comprising a motor, a battery module, a control module configured to control cleaner operations and being mountable on and separable from the main body and comprising a main processor, a first processor. The main processor may be communicative with the battery module at a first period when the control module is mounted on the main body. The battery module may identify that the control module is separated from the main body and stop a supply of power to the main body based on a first signal from the control module not being received for at least the first period. The first processor may identify that the control module is separated from the main body and stop a driving of the motor based on a second signal from the control module not being received for a second period.

According to an embodiment of the disclosure, a method of operating a cleaner may include executing communications between a control module and a battery module, determining whether a signal from the battery module is received by the control module, determining whether a communication signal is received by the battery module, and identifying that the control module is mounted to or separated from a cleaner main body based on each determining result and operating the control module in a safe mode in the latter case.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the non-transitory storage medium may include a buffer in which data is temporarily stored.

According to an embodiment of the disclosure, methods according to various embodiments disclosed herein may be included in a computer program product and then provided. The computer program product may be traded as commodities between sellers and buyers. The computer program product may be distributed in the form of a machine-readable storage medium (e.g., a compact disc ROM (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

1. A cleaner comprising:
a cleaner main body comprising a suction motor;
a battery module; and
a control module configured to control an operation of the cleaner, the control module being mountable on and separable from the cleaner main body and comprising a main processor configured to communicate with the battery module at a preset interval in a state in which the control module is mounted on the cleaner main body,
the battery module being configured to identify that the control module is separated from the cleaner main body based on not receiving a communication signal from the control module for a preset first time period or longer and to stop a supply of power to the cleaner main body.

2. The cleaner of claim 1, wherein the battery module is further configured to stop output of a light-emitting diode (LED) display provided in the battery module based on identifying that the control module is separated from the cleaner main body.

3. The cleaner of claim 1, further comprising a first processor configured to control the suction motor and to identify that the control module is separated from the cleaner main body and to stop a driving of the suction motor based on not receiving a communication signal from the control module for a preset second time period or longer.

4. The cleaner of claim 3, wherein the preset second time period is longer than the preset first time period.

5. The method of claim 4, wherein the first processor is further configured to stop a driving of a brush device connected to the cleaner main body by controlling a switch element used to supply power to the brush device based on identifying that the control module is separated from the cleaner main body.

6. The cleaner of claim 1, wherein the control module further comprises:
an output interface configured to output information related to a state of the cleaner;
an input interface configured to receive an input for manipulating the cleaner; and
a memory storing information related to the operation of the cleaner,
wherein the main processor is further configured to identify that the control module is separated from the cleaner main body based on not receiving a communication signal from the battery module for the first preset time period or longer.

7. The cleaner of claim 6, wherein the main processor is further configured to:
power off the output interface and ignore a user input received through the input interface based on identifying that the control module is separated from the cleaner main body.

8. The cleaner of claim 6, wherein the main processor is further configured to store operation history information corresponding to a time point of identifying that the control module is separated from the cleaner main body in the memory.

9. The cleaner of claim 1, further comprising a blocking device connected to a plurality of loads including the suction motor, the blocking device being configured to selectively block a supply of power from the battery module to at least one of the plurality of loads based on identifying that the control module is separated from the cleaner main body.

10. The cleaner of claim 1, wherein the control module is further configured to measure a measured battery supply voltage applied from the battery module to the control module and to determine whether the control module is separated from the cleaner main body based on the measured battery supply voltage.

11. The cleaner of claim 10, wherein the control module is further configured to identify that the control module is separated from the cleaner main body based on a voltage drop rate of the measured battery supply voltage being greater than a threshold value.

12. The cleaner of claim 11, wherein the control module is further configured to receive data comprising a battery supply voltage from the battery module and to store information related to a current operation state of the cleaner in a memory based on a difference between the battery supply voltage included in the data and the measured battery supply voltage being greater than a preset reference value.

13. The cleaner of claim 1, further comprising a socket arranged in the cleaner main body and by which the control module is supportable,
wherein the control module is attachable to and separable from the socket by being slid in an upward direction and a downward direction, respectively.

14. The cleaner of claim 13, wherein:
the cleaner main body further comprises a handle to be held by a user, and
the control module is located above the handle and at a rear of a filter housing.

15. The cleaner of claim 14, wherein the filter housing is separable from the cleaner main body in a backward direction.

16. The cleaner of claim 15, wherein the control module further comprises a locking unit that is inserted into the handle when the control module is mounted on the cleaner main body,
wherein:
the locking unit comprises a locking hole,
a screw fastening hole to be aligned with the locking hole is arranged in the handle, and
the control module is fixable to the cleaner main body by a tightening of a screw into the locking hole through the screw fastening hole.

17. The cleaner of claim 16, wherein the control module is further configured to detect a separation of the screw from the locking hole through one of a tunnel magnetoresistance (TMR) sensor and a microswitch arranged in the locking unit.

18. The cleaner of claim 17, wherein the control module is further configured to output a notification message that the control module is unable to be separated from the cleaner main body through an output interface based on a detection of a separation of the screw from the locking hole while the cleaner is in operation.

19. The cleaner of claim 17, wherein the control module is further configured to transmit information that the control module is unable to be separated from the cleaner main body to a server device connected to a mobile terminal of the user based on a detection of a separation of the screw from the locking hole while the cleaner is in operation

20. The cleaner of claim 18, wherein the control module is further configured to output information related to a method of separating the control module or a method of separating the filter housing through an output interface based on a detection of a separation of the screw from the locking hole while an operation of the cleaner is stopped.
